(19) United States
(12) Patent Application Publication
(10) Pub. No.: US 2025/0067483 A1
(43) Pub. Date: Feb. 27, 2025

(54) NON-FLAMMABLE REFRIGERANTS WITH LOW GWP AND SECONDARY REFRIGERANT SYSTEMS INCLUDING SUCH REFRIGERANTS

(71) Applicant: HONEYWELL INTERNATIONAL INC., Charlotte, NC (US)

(72) Inventors: Ankit Sethi, Clarence, NY (US); Henna Tangri, East Amherst, NY (US); Samuel Yana Motta, East Amherst, NY (US)

(73) Assignee: HONEYWELL INTERNATIONAL INC., Charlotte, NC (US)

(21) Appl. No.: 18/814,488

(22) Filed: Aug. 24, 2024

Related U.S. Application Data
(60) Provisional application No. 63/536,848, filed on Sep. 6, 2023.
(60) Provisional application No. 63/534,526, filed on Aug. 24, 2023.

(51) Int. Cl. F25B 9/00; C09K 5/04; F25B 41/30

(52) U.S. Cl. CPC F25B 9/002; C09K 5/045; F25B 41/30; C09K 2205/126; C09K 2205/22

(57) ABSTRACT

Non-flammable refrigerants with low GWP and secondary refrigerant systems including such refrigerants are provided. The refrigeration system may contain a high temperature refrigerant circuit with a first refrigerant and a low temperature refrigerant circuit with a second refrigerant, wherein the second refrigerant comprises a blend of R1234ze(Z), R1234ze(E), R1336mzz(E) and optionally R227ea, or a blend of R1234ze(Z) R1234ze(E) R1224yd(Z), and optionally R(227ea). The refrigerant fluids may have one of the following characteristics: (i) a global warming potential (GWP) of less than 150; (ii) an evaporator glide of less than 5.5° C.; (iii) non-flammability according to ASHRAE Standard 34; and/or (iv) a boiling point of less than 6° C.

### CROSS REFERENCE TO RELATED APPLICATIONS

The present application is related to and claims priority from each of U.S. Provisional Application 63/534,526, filed Aug. 24, 2023 and U.S. Provisional Application 63/536,848, filed Sep. 6, 2023, each of which is incorporated herein by reference as if fully set forth below.

### FIELD OF THE DISCLOSURE

The present disclosure relates to non-flammable, low-global warming potential (“low GWP”) refrigerant fluids and secondary refrigeration systems and methods that are safe and effective.

### BACKGROUND

In typical air conditioning and refrigerant systems, a compressor is used to compress a heat transfer vapor from a lower to a higher pressure, which in turn adds heat to the vapor. This added heat is typically rejected in a heat exchanger, commonly referred to as a condenser. In the condenser the vapor, at least in major proportion, is condensed to produce a liquid heat transfer fluid at a relatively high pressure. Typically, the condenser uses a fluid available in large quantities in the ambient environment, such as ambient outside air, as the heat sink. Once it has been condensed, the high-pressure heat transfer fluid undergoes a substantially isenthalpic expansion, such as in by passing through an expansion device or valve, where it is expanded to a lower pressure, which in turn results in the fluid undergoing a decrease in temperature. The lower pressure, lower temperature heat transfer fluid from the expansion operation then is typically routed to an evaporator, where it absorbs heat and in so doing evaporates. This evaporation process in turn results in cooling of the fluid or body that it is intended to cool. In typical air conditioning applications, the cooled fluid is the indoor air of the dwelling being air conditioned. In refrigeration systems, the cooling may involve cooling the air inside of a cold box or storage unit. After the heat transfer fluid is evaporated at low pressure in the evaporator, it is returned to the compressor where the cycle begins once again. A complex and interrelated combination of factors and requirements is associated with forming efficient, effective and safe air conditioning and refrigeration systems that are at the same time environmentally friendly, that is, have both low GWP impact and low ozone depletion (“ODP”) impact. With respect to efficiency and effectiveness, it is important for the heat transfer fluid to operate in air conditioning systems and refrigeration systems with high levels of efficiency and high capacity. At the same time, since it is possible that the heat transfer fluid may escape over time into the atmosphere, it is important for the fluid to have low values for both GWP and ODP.

While certain fluids are able to achieve high levels of both efficiency and effectiveness and at the same time low levels of both GWP and ODP, applicants have come to appreciate that many fluids which satisfy this combination of requirements nevertheless suffer from the disadvantage of having deficiencies in connection with safety. For example, fluids which might otherwise be acceptable may be disfavored for use because of flammability properties and/or toxicity concerns. Applicants have come to appreciate that the use of fluids having such properties is especially undesirable in typical air conditioning systems, and in some refrigeration systems, since such flammable and/or toxic fluids may inadvertently be released into the dwelling which is being cooled (or being heated in the case of heat-pump applications) or into a human occupied space (such as on the floor of a supermarket), thus exposing or potentially exposing the occupants thereof to dangerous conditions.

### SUMMARY

The present invention provides fluid refrigerant compositions having low GWP and multi-stage refrigeration systems which employ such refrigerant compositions. Advantageously, preferred refrigerant compositions have one or more of a global warming potential (GWP) of not greater than 150, an evaporator glide of not greater than 5.6° C., non-flammability according to ASHRAE Standard 34 2022, and/or a normal boiling point of not greater than 6.3° C., and preferably all of these.

The present invention includes refrigeration systems comprising a high temperature refrigerant circuit comprising a first refrigerant; and a low temperature refrigerant circuit comprising a second refrigerant, wherein the second refrigerant comprises: (a) a first component comprising one or more of cis-1,3,3,3-tetrafluoropropene (R1234ze(Z)) and trans-1,3,3,3-tetrafluoropropene (R1234ze(E)); (b) a second component comprising one or more of trans-1,1,1,4,4,4-hexafluoro-2-butene (R1336mzz(E)), R1224yd(Z), and R1233zd(E); and (c) optionally a third component comprising at least one of R134a, R245fa and R227ea, wherein said secondary refrigerant has: (i) a global warming potential (GWP) of not greater than 150; (ii) full evaporator glide of not greater than about 5.5° C.; (iii) non-flammability according to ASHRAE Standard 34 2022; and (iv) a normal boiling point of not greater than about 6° C. Refrigerant systems according to this paragraph are sometimes referred to herein for convenience as Refrigerant System 1A.

The present invention includes refrigeration systems comprising a high temperature refrigerant circuit comprising a first refrigerant and a low temperature refrigerant circuit comprising a second refrigerant, wherein the second refrigerant comprises: (a) a first component comprising cis-1,3,3,3-tetrafluoropropene (R1234ze(Z)) and trans-1,3,3,3-tetrafluoropropene (R1234ze(E)); second component comprising R1233zd(E); and (c) a third component comprising R245fa, wherein said second refrigerant has: (i) a global warming potential (GWP) of not greater than 150; (ii) an evaporator glide of not greater than 5.6° C.; (iii) non-flammability according to ASHRAE Standard 34; and (iv) a normal boiling point of not greater than 6.3° C. Refrigerant systems according to this paragraph are sometimes referred to herein for convenience as Refrigerant System 1B.

The present invention includes refrigeration systems comprising a high temperature refrigerant circuit comprising a first refrigerant and a low temperature refrigerant circuit comprising a second refrigerant, wherein the second refrigerant comprises: (a) a first component comprising cis-1,3,3,3-tetrafluoropropene (R1234ze(Z)) and trans-1,3,3,3-tetrafluoropropene (R1234ze(E)); and (b) a second component comprising R1336mzz(E), wherein said second refrigerant has: (i) a global warming potential (GWP) of not greater than 150; (ii) an evaporator glide of not greater than 5.6° C.; (iii) non-flammability according to ASHRAE Standard 34; and (iv) a normal boiling point of not greater than 6.3° C. Refrigerant systems according to this paragraph are sometimes referred to herein for convenience as Refrigerant System 1C.

The present invention includes refrigeration systems comprising a high temperature refrigerant circuit comprising a first refrigerant and a low temperature refrigerant circuit comprising a second refrigerant, wherein the second refrigerant comprises: (a) a first component comprising cis-1,3,3,3-tetrafluoropropene (R1234ze(Z)) and trans-1,3,3,3-tetrafluoropropene (R1234ze(E)); (b) a second component comprising cis-1-chloro-2,3,3,3-tetrafluoropropene (R1224yd(Z)), wherein said second refrigerant has: (i) a global warming potential (GWP) of not greater than 150; (ii) an evaporator glide of not greater than 5.6° C.; (iii) non-flammability according to ASHRAE Standard 34; and (iv) a normal boiling point of not greater than 6.3° C. Refrigerant systems according to this paragraph are sometimes referred to herein for convenience as Refrigerant System 1D.

The present invention also includes refrigerant compositions comprising:
(a) cis-1,3,3,3-tetrafluoropropene (R1234ze(Z));
(b) trans-1,3,3,3-tetrafluoropropene (R1234ze(E));
(c) R1233zd(E); and
(d) R245fa,
   wherein said refrigerant composition has: (i) a global warming potential (GWP) of not greater than 150; (ii) an evaporator glide of not greater than 5.6° C.; (iii) non-flammability according to ASHRAE Standard 34; and (iv) a normal boiling point of not greater than 6.3° C. Refrigerant compositions according to this paragraph are sometimes referred to herein for convenience as Refrigerant A.

The present invention also includes refrigerant compositions comprising:
(a) from about 20% to about 70% by weight of R1234ze(Z);
(b) from about 7% to about 15% by weight of R1234ze(E));
(c) from about 9% to about 52% by weight of R1233zd(E); and
(d) from about 3% to about 5% by weight of R245fa,
   wherein said components (a) through (d) together comprise at least about 95% by weight of the composition. Refrigerant compositions according to this paragraph are sometimes referred to herein for convenience as Refrigerant B.

The present invention also includes refrigerant compositions comprising:
(a) from about 20% to about 70% by weight of R1234ze(Z);
(b) from about 7% to about 15% by weight of R1234ze(E));
(c) from about 9% to about 52% by weight of R1233zd(E); and
(d) from about 3% to about 5% by weight of R245fa,
   wherein said components (a) through (d) together comprise at least about 95% by weight of the composition and wherein said refrigerant has: (i) a global warming potential (GWP) of not greater than 150; (ii) an evaporator glide of not greater than 5.6° C.; (iii) non-flammability according to ASHRAE Standard 34; and (iv) a normal boiling point of not greater than 6.3° C. Refrigerant compositions according to this paragraph are sometimes referred to herein for convenience as Refrigerant C.

### BRIEF DESCRIPTION OF THE DRAWINGS

FIG. 1 is a generalized process flow diagram of an air conditioning system according to the present disclosure.

FIG. 2 is a generalized process flow diagram of an air conditioning system according to the present disclosure.

FIG. 3 is a generalized process flow diagram of an air conditioning system according to the present disclosure.

FIG. 4 is a schematic representation of heat exchanger according to the present disclosure.

FIG. 5 is a generalized process flow diagram of a reversible heat pump system which can operate in both a cooling and a heating according to the present disclosure.

FIG. 6 is a generalized process flow diagram of an R410A air conditioning system.

### DETAILED DESCRIPTION

The present disclosure includes refrigerant compositions and refrigerant systems and method. In particularly preferred cases, the refrigerants are used in, and the systems and methods comprise, air conditioning methods and systems and methods and systems for cooling items located within a dwelling occupied by humans or other animals.

The present disclosure includes refrigerant systems for conditioning air and/or for cooling items located within a dwelling occupied by humans or other animals. Preferred embodiments of such systems include at least a first heat transfer circuit, which preferably comprises a first heat transfer fluid in a vapor/compression circulation loop, located substantially outside of the dwelling or other occupied structure. This first circuit is sometimes referred to herein by way of convenience as the “outdoor loop.” The outdoor loop preferably comprises a compressor, a heat exchanger which serves to condense the heat transfer fluid in the outdoor loop, preferably by heat exchange with outdoor ambient air, and an expansion device. The preferred system also includes at least a second heat transfer circuit, which contains a second heat transfer fluid, which is different than said first heat transfer fluid, located substantially inside of the dwelling or other occupied structure. This second circuit is sometimes referred to herein by way of convenience as the “indoor loop.”

The indoor loop preferably comprises an evaporator heat exchanger which serves to evaporate the second heat transfer fluid in the indoor loop, preferably by heat exchange with indoor air. In preferred embodiments, the second heat transfer circuit does not include a vapor compressor but does include a liquid pump for the second heat transfer fluid when in the liquid phase.

The preferred systems preferably include at least one intermediate heat exchanger which permits exchange of heat between the first heat transfer fluid and the second heat transfer fluid such that heat is transferred to the first heat transfer fluid, preferably thereby evaporating the first heat transfer fluid, and from the second heat transfer fluid, thereby condensing the second heat transfer fluid. Preferably, the intermediate heat exchanger is located outside the dwelling or other occupied structure or outside the area in which the air is being conditioned.

### I. Definitions

The phrase “Global Warming Potential” (hereinafter “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovemmental Panel on Climate Change (IPCC) as the reference gas and its GWP is taken as 1. The larger GWP, the more that a given gas warms the Earth compared to CO₂ over that time period. As used herein, the term GWP means the value of GWP as measured in accordance with IPCC Fifth Assessment Report, 2014¹, referred to and abbreviated herein as AR5. ¹Myre, G., D. Shindell, F.-M. Bréon. W. Coins. J. Fuglestvedt, J. Huang, D. Koch, J.-F. Lamarque, D. Lee, B. Mendoza, T. Nakajima, A. Robock, G. Stephens. T. Takemura and H. Zhang, 2013: Anthropogenic and Natural Radiative Forcing. In: Climate Change 2013: The Physical Science Basis. Contribution of Working Group I to the Fifth Assessment Report of the Intergovernmental Panel on Climate Change [Stocker, T. F., D. Qin. G.-K. Plattner, M. Tignor, S. K. Allen, J. Boschung, A. Nauels, Y. Xia, V. Bex and P. M. Midgley (eds.)]. Cambridge University Press, Cambridge. United Kingdom and New York, NY, USA. http://www.ipcc.ch/pdf/asessmentreport/ar5/wg1/WG1AR5_Chapter08_FINAL.pdf (p. 73-79)

The term “non-flammable” refers to compounds or compositions which are determined to be nonflammable as determined in accordance with ASTM Standard E-681-2009 Standard Test Method for Concentration Limits of Flammability of Chemicals (Vapors and Gases) at conditions described in ASHRAE Standard 34-2022 Designation and Safety Classification of Refrigerants and described in Appendix B1 to ASHRAE Standard 34-2022 (as each standard exists as of the filing date of this application), which are incorporated herein by reference in its entirety (“Non-Flammability Test”). Flammability is defined as the ability of a composition to ignite and/or propagate a flame. Under this test, flammability is determined by measuring flame angles. A non-flammable substance would be classified as class “1” by ASHRAE Standard 34-2022 Designation and Safety Classification of Refrigerants (as each standard exists as of the filing date of this application).

As used herein, the term “full evaporator glide” means the difference between the bubble point of the refrigerant and the dew point of the refrigerant at the average pressure of the evaporator assuming the pressure at the evaporator exit is the same as the pressure at the inlet.

The phrase “no or low toxicity” as used herein means the composition is classified as class “A” by ASHRAE Standard 34-2022 Designation and Safety Classification of Refrigerants and described in Appendix B1 to ASHRAE Standard 34-2022 (as each standard exists as of the filing date of this application). A substance which is non-flammable and low toxicity would be classified as “A1” by ASHRAE Standard 34-2022 Designation and Safety Classification of Refrigerants and described in Appendix B1 to ASHRAE Standard 34-2022 (as each standard exists as of the filing date of this application).

As used herein, the term “about” in relation to the amount expressed in weight percent means the amount of the identified component can vary by an amount of +/−10% relative percent by weight. By way of example, if an amount is specified as about 10%, then it covers 10% plus 1% (i.e., 11%) and 10% minus 1% (i.e., 9%), and if an amount is specified as about 20%, then it covers 20% plus 2% (i.e., 22%) and 20% minus 2% (i.e., 18%). Unless otherwise indicated or understood from the context, reference to an amount by “percent” or “%” references to percentage by weight.

For the purposes of this invention, the term “about” in relation to temperatures in degrees centigrade (° C.) for temperatures less than 10° C. means that the stated temperature can vary by an amount of +/−1° C. In preferred embodiments, temperature specified as being about is preferably +/−0.5° C. of the identified temperature.

As used herein, the term “cis-1,3,3,3-tetrafluoropropene” refers to the cis isomer of HFO-1234ze and is abbreviated as HFO-1234ze(Z) or R1234ze(Z).

As used herein, the term “trans-1,3,3,3-tetrafluoropropene” refers to the trans isomer of HFO-1234ze and is abbreviated as HFO-1234ze(E) or R1234ze(E).

As used herein, the term “trans-1,1,1,4,4,4-hexafluoro-2-butene” refers to the trans isomer of HFO-1336mzz and is abbreviated as HFO-1336mzz(E) or R1336mzz(E).

As used herein, the term “1,1,1,2,3,3,3-heptafluoropropane” refers to HFC-227ea which is abbreviated as R-227ea.

As used herein, the term “cis-1-chloro-2,3,3,3-tetrafluoropropene” refers to the cis isomer of HCFO-1224yd and is abbreviated as R1224yd(Z).

As used herein, the term “trans-1-chloro-3,3,3-tetrafluoropropene” refers to the trans isomer of HCFO-1233zd and is abbreviated as R1233zd(E).

As used herein, the term “1,1,1,2-tetrafluoroethane” refers to HFC-134a which is abbreviated as R-134a.

As used herein, the term “1,1,1,3,3-pentafluoropropane” refers to HFC-245fa which is abbreviated as R-245fa.

As used herein, the term “fluoroethane” refers to HFC-161 which is abbreviated as R-161.

As used herein, the term “2,3,3,3-tetrafluoropropene” refers to HFO-1234yf which is abbreviated as R-1234yf.

As used herein, the term “difluoromethane” refers to HFC-32 which is abbreviated as R-32.

As used herein, the term “propane” refers to HC-290 which is abbreviated as R-290.

As used herein, the term “R471A” means the refrigerant designated by ASHRAE as 471A and which consists of 78.7%+0.4/−1.5% of HFC-1234ze(E), 17%+1.5/−0.4% of HFC-1336mzz(E) and 4.3%+1.5/−0.4% of HFC-227ea.

As used herein, the term “R476A” means the refrigerant designated by ASHRAE as 476A and which consists of 78.7%+/−0.5/−2% of HFC-1234ze(E), 12%+2/−0.5% of HFC-1336mzz(E) and 10%+2/−0.51% of HFC-134a.

As used herein, the term “R482A” means the refrigerant designated by ASHRAE as 482A and which consists of about 10% of HFC-134a, about 83.5% of HFC-1234ze(E), and about 6.5% of HFO-1224yd(Z).

As used herein, the term “residential air conditioning” refers to a refrigeration system that operates with a heat exchanger that absorbs heat from or adds heat to the indoor air in a structure in which humans reside.

As used herein, the term “split direct expansion air conditioning system” refers to an air conditioning system that operates with an indoor unit that is located inside the residence and contains a heat exchanger that absorbs heat from or adds heat to the indoor air in a structure in which humans reside and with an outdoor unit that includes a heat exchanger located outside the residence that rejects heat to or absorbs heat from outdoor air.

As used herein, the term “secondary loop air conditioning system” refers to an air conditioning system having an inside refrigeration circuit using an indoor (or secondary) refrigerant to heat and/or cool the inside air and an outside refrigeration circuit that uses an outdoor (or primary) refrigerant that is different than the indoor refrigerant and that rejects heat to or absorbs heat from the outside air.

As used herein, the term “suction line” used in connection with a secondary loop air conditioning system refers to refrigerant flow path from the outlet of the intermediate heat exchanger to the inlet of the compressor.

As used herein, the term “liquid line” used in connection with a secondary loop air conditioning system refers to refrigerant flow path from the outlet of the condenser to the inlet of the intermediate heat exchanger.

As used herein, the term “refrigerant” is used to describe a specialized fluid which may be used in systems to facilitate heating or cooling processes.

As used herein, the term “heat transfer composition” refers to a specialized fluid which comprises a refrigerant and optionally a lubricant and/or optionally other additive components.

### II. Refrigerant and Heat Transfer Compositions

The present invention includes refrigerants which are useful generally in heat transfer applications without limitation, including each of Refrigerants A, B and C. In addition, the table below defines a series of refrigerants according to the present invention which include the indicated components and the indicated amounts, with each such refrigerant being defined as a Refrigerant and abbreviated in the table by the letter R followed by a number in column 1 of the table below, it being understood that all values are understood to be preceded by the word “about” unless otherwise indicated in the table. In the Table R below it is also understood that unless a “Refrigerant Component” is specifically indicated in the table in the second column (under the heading Transition Phrase) to be “comprising” (using the abbreviation “COMP”), “consisting essentially of” (using the abbreviation CEO) or “consisting of,” (using the abbreviation CO), then refrigerant comprises the refrigerant component as indicated. The designation “NR” is understood to mean that the component is not required (but may be present within the scope of the transition phrase).

TABLE R
Refrigerant Compositions

| | | REFRIGERANT COMPONENT | | | | | | |
|---|---|---|---|---|---|---|---|---|
| | | R1234ze | R1234ze | 1336mzz | 1224yd | 1233zd | | |
| | Trans. | (Z) | (E) | (E) | (Z) | (E) | 227 | 245 |
| Refrig. | Phrase | (wt. %) | (wt. %) | (wt. %) | wt. % | wt % | ea | fa |
| R1A | COMP | 49-64 | 3-11 | 33-44 | NR | NR | NR | NR |
| R1B | CEO | 49-64 | 3-11 | 33-44 | NR | NR | NR | NR |
| R1C | CO | 49-64 | 3-11 | 33-44 | NR | NR | NR | NR |
| R1D | COMP | 49-64 | 3-11 | 33-44 | NR | NR | 3-4.4 | NR |
| R1E | CEO | 49-64 | 3-11 | 33-44 | NR | NR | 3-4.4 | NR |
| R1F | CO | 49-64 | 3-11 | 33-44 | NR | NR | 3-4.4 | NR |
| R2A | COMP | 49-63 | 1-9 | 32-37 | NR | NR | NR | NR |
| R2B | CEO | 49-63 | 1-9 | 32-37 | NR | NR | NR | NR |
| R2C | CO | 49-63 | 1-9 | 32-37 | NR | NR | NR | NR |
| R2D | COMP | 49-63 | 1-9 | 32-37 | NR | NR | 4-5 | NR |
| R2E | CEO | 49-63 | 1-9 | 32-37 | NR | NR | 4-5 | NR |
| R2F | CO | 49-63 | 1-9 | 32-37 | NR | NR | 4-5 | NR |
| R3A | COMP | 63-77 | 7-15 | NR | 16-22 | NR | NR | NR |
| R3B | CEO | 63-77 | 7-15 | NR | 16-22 | NR | NR | NR |
| R3C | CO | 63-77 | 7-15 | NR | 16-22 | NR | NR | NR |
| R3D | COMP | 63-77 | 7-15 | NR | 16-22 | NR | 4-5 | NR |
| R3E | CEO | 63-77 | 7-15 | NR | 16-22 | NR | 4-5 | NR |
| R3F | CO | 63-77 | 7-15 | NR | 16-22 | NR | 4-5 | NR |
| R4A | COMP | 65-80 | 4-13 | NR | 12-17 | NR | NR | NR |
| R4B | CEO | 65-80 | 4-13 | NR | 12-17 | NR | NR | NR |
| R4C | CO | 65-80 | 4-13 | NR | 12-17 | NR | NR | NR |
| R4D | COMP | 65-80 | 4-13 | NR | 12-17 | NR | 4-5 | NR |
| R4E | CEO | 65-80 | 4-13 | NR | 12-17 | NR | 4-5 | NR |
| R4F | CO | 65-80 | 4-13 | NR | 12-17 | NR | 4-5 | NR |
| R5A | COMP | 62 | 5 | 33 | NR | NR | NR | NR |
| | | +0.3/−0.3 | +0.3/−0.3 | +2.0/−0.5 | | | | |
| R5B | CEO | 62 | 5 | 33 | NR | NR | NR | NR |
| | | +0.3/−0.3 | +0.3/−0.3 | +2.0/−0.5 | | | | |
| R5C | CO | 62 | 5 | 33 | NR | NR | NR | NR |
| | | +0.3/−0.3 | +0.3/−0.3 | +2.0/−0.5 | | | | |
| R6A | COMP | 60.6 | 3 | 32 | NR | NR | NR | NR |
| | | +0.3/−0.3 | +0.3/−0.3 | +2.0/−0.5 | | | | |
| R6B | CEO | 60.6 | 3 | 32 | NR | NR | NR | NR |
| | | +0.3/−0.3 | +0.3/−0.3 | +2.0/−0.5 | | | | |
| R6C | CO | 60.6 | 3 | 32 | NR | NR | NR | NR |
| | | +0.3/−0.3 | +0.3/−0.3 | +2.0/−0.5 | | | | |
| R6D | COMP | 60.6 | 3 | 32 | NR | NR | 4.4 +/− 1.0 | NR |
| | | +0.3/−0.3 | +0.3/−0.3 | +2.0/−0.5 | | | | |
| R6E | CEO | 60.6 | 3 | 32 | NR | NR | 4.4 +/− 1.0 | NR |
| | | +0.3/−0.3 | +0.3/−0.3 | +2.0/−0.5 | | | | |
| R6F | CO | 60.6 | 3 | 32 | NR | NR | 4.4 +/− 1.0 | NR |
| | | +0.3/−0.3 | +0.3/−0.3 | +2.0/−0.5 | | | | |
| R7A | COMP | 75 | 9 | NR | 16 | NR | NR | NR |
| | | +0.3/−0.3 | +0.3/−0.3 | | +2.0/−0.5 | | | |
| R7B | CEO | 75 | 9 | NR | 16 | NR | NR | NR |
| | | +0.3/−0.3 | +0.3/−0.3 | | +2.0/−0.5 | | | |
| R7C | CO | 75 | 9 | NR | 16 | NR | NR | NR |
| | | +0.3/−0.3 | +0.3/−0.3 | | +2.0/−0.5 | | | |
| R8A | COMP | 77.6 | 6 | NR | 12 | NR | NR | NR |
| | | +0.3/−0.3 | +0.3/−0.3 | | +2.0/−0.5 | | | |
| R8B | CEO | 77.6 | 6 | NR | 12 | NR | NR | NR |
| | | +0.3/−0.3 | +0.3/−0.3 | | +2.0/−0.5 | | | |
| R8C | CO | 77.6 | 6 | NR | 12 | NR | NR | NR |
| | | +0.3/−0.3 | +0.3/−0.3 | | +2.0/−0.5 | | | |
| R8D | COMP | 77.6 | 6 | NR | 12 | NR | 4.4 +/− 1.0 | NR |
| | | +0.3/−0.3 | +0.3/−0.3 | | +2.0/−0.5 | | | |
| R8E | CEO | 77.6 | 6 | NR | 12 | NR | 4.4 +/− 1.0 | NR |
| | | +0.3/−0.3 | +0.3/−0.3 | | +2.0/−0.5 | | | |
| R8F | CO | 77.6 | 6 | NR | 12 | NR | 4.4 +/− 1.0 | NR |
| | | +0.3/−0.3 | +0.3/−0.3 | | +2.0/−0.5 | | | |
| R9A | COMP | 22.8-69 | 7.5-14.5 | NR | NR | 9-52 | NR | NR |
| R9B | CEO | 22.8-69 | 7.5-14.5 | NR | NR | 9-52 | NR | NR |
| R9C | CO | 22.8-69 | 7.5-14.5 | NR | NR | 9-52 | NR | NR |
| R9D | COMP | 22.8-69 | 7.5-14.5 | NR | NR | 9-52 | NR | 5-14.5 |
| R9E | CEO | 22.8-69 | 7.5-14.5 | NR | NR | 9-52 | NR | 5-14.5 |
| R9F | CO | 22.8-69 | 7.5-14.5 | NR | NR | 9-52 | NR | 5-14.5 |
| R10A | COMP | 30-40 | 10-12 | NR | NR | 48-52 | NR | NR |
| R10B | CEO | 30-40 | 10-12 | NR | NR | 48-52 | NR | NR |
| R10C | CO | 30-40 | 10-12 | NR | NR | 48-52 | NR | NR |
| R10D | COMP | 30-40 | 10-12 | NR | NR | 48-52 | NR | 5-6 |
| R10E | CEO | 30-40 | 10-12 | NR | NR | 48-52 | NR | 5-6 |
| R10F | CO | 30-40 | 10-12 | NR | NR | 48-52 | NR | 5-6 |
| R10G | COMP | 34 | 11 | NR | NR | 50 | NR | 5 +/− 1.0 |
| | | +0.3/−0.3 | +0.3/−0.3 | | | +1.0/−1.0 | | |
| R10H | CEO | 34 | 11 | NR | NR | 50 | NR | 5 +/− 1.0 |
| | | +0.3/−0.3 | +0.3/−0.3 | | | +1.0/−1.0 | | |
| R10I | CO | 34 | 11 | NR | NR | 50 | NR | 5 +/− 1.0 |
| | | +0.3/−0.3 | +0.3/−0.3 | | | +1.0/−1.0 | | |
| R11A | COMP | 35-45 | 8-12 | NR | NR | 40-50 | NR | NR |
| R11B | CEO | 35-45 | 8-12 | NR | NR | 40-50 | NR | NR |
| R11C | CO | 35-45 | 8-12 | NR | NR | 40-50 | NR | NR |
| R11D | COMP | 35-45 | 8-12 | NR | NR | 40-50 | NR | 5-6 |
| R11E | CEO | 35-45 | 8-12 | NR | NR | 40-50 | NR | 5-6 |
| R11F | CO | 35-45 | 8-12 | NR | NR | 40-50 | NR | 5-6 |
| R11G | COMP | 40 | 10 | NR | NR | 45 | NR | 5 +/− 1.0 |
| | | +0.3/−0.3 | +0.3/−0.3 | | | +1.0/−1.0 | | |
| R11H | CEO | 40 | 10 | NR | NR | 45 | NR | 5 +/− 1.0 |
| | | +0.3/−0.3 | +0.3/−0.3 | | | +1.0/−1.0 | | |
| R11I | CO | 40 | 10 | NR | NR | 45 | NR | 5 +/− 1.0 |
| | | +0.3/−0.3 | +0.3/−0.3 | | | +1.0/−1.0 | | |
| R12A | COMP | 40-45 | 10-15 | NR | NR | 30-40 | NR | NR |
| R12B | CEO | 40-45 | 10-15 | NR | NR | 30-40 | NR | NR |
| R12C | CO | 40-45 | 10-15 | NR | NR | 30-40 | NR | NR |
| R12D | COMP | 40-45 | 10-15 | NR | NR | 30-40 | NR | 8-12 |
| R12E | CEO | 40-45 | 10-15 | NR | NR | 30-40 | NR | 8-12 |
| R12F | CO | 40-45 | 10-15 | NR | NR | 30-40 | NR | 8-12 |
| R12G | COMP | 42 | 13 | NR | NR | 35 | NR | 10 +/− 1.0 |
| | | +0.3/−0.3 | +0.3/−0.3 | | | +1.0/−1.0 | | |
| R12H | CEO | 42 | 13 | NR | NR | 35 | NR | 10 +/− 1.0 |
| | | +0.3/−0.3 | +0.3/−0.3 | | | +1.0/−1.0 | | |
| R12I | CO | 42 | 13 | NR | NR | 35 | NR | 10 +/− 1.0 |
| | | +0.3/−0.3 | +0.3/−0.3 | | | +1.0/−1.0 | | |
| R13A | COMP | 50-55 | 8-12 | NR | NR | 25-30 | NR | NR |
| R13B | CEO | 50-55 | 8-12 | NR | NR | 25-30 | NR | NR |
| R13C | CO | 50-55 | 8-12 | NR | NR | 25-30 | NR | NR |
| R13D | COMP | 50-55 | 8-12 | NR | NR | 25-30 | NR | 8-12 |
| R13E | CEO | 50-55 | 8-12 | NR | NR | 25-30 | NR | 8-12 |
| R13F | CO | 50-55 | 8-12 | NR | NR | 25-30 | NR | 8-12 |
| R13G | COMP | 53 | 10 | NR | NR | 27 | NR | 10 +/− 1.0 |
| | | +0.3/−0.3 | +0.3/−0.3 | | | +1.0/−1.0 | | |
| R13H | CEO | 53 | 10 | NR | NR | 27 | NR | 10 +/− 1.0 |
| | | +0.3/−0.3 | +0.3/−0.3 | | | +1.0/−1.0 | | |
| R13I | CO | 53 | 10 | NR | NR | 27 | NR | 10 +/− 1.0 |
| | | +0.3/−0.3 | +0.3/−0.3 | | | +1.0/−1.0 | | |
| R14A | COMP | 55-65 | 8-12 | NR | NR | 10-20 | NR | NR |
| R14B | CEO | 55-65 | 8-12 | NR | NR | 10-20 | NR | NR |
| R14C | CO | 55-65 | 8-12 | NR | NR | 10-20 | NR | NR |
| R14D | COMP | 55-65 | 8-12 | NR | NR | 10-20 | NR | 14-15 |
| R14E | CEO | 55-65 | 8-12 | NR | NR | 10-20 | NR | 14-15 |
| R14F | CO | 55-65 | 8-12 | NR | NR | 10-20 | NR | 14-15 |
| R14G | COMP | 60 | 10.5 | NR | NR | 15 | NR | 14.5 +/− 1.0 |
| | | +0.3/−0.3 | +0.3/−0.3 | | | +1.0/−1.0 | | |
| R14H | CEO | 60 | 10.5 | NR | NR | 15 | NR | 14.5 +/− 1.0 |
| | | +0.3/−0.3 | +0.3/−0.3 | | | +1.0/−1.0 | | |
| R14I | CO | 60 | 10.5 | NR | NR | 15 | NR | 14.5 +/− 1.0 |
| | | +0.3/−0.3 | +0.3/−0.3 | | | +1.0/−1.0 | | |

The refrigerants of the present invention, including each of Refrigerants A, B and C and refrigerants R1 through R14 as defined in the table above, preferably have a global warming potential (GWP) of not greater than 150.

The refrigerants of the present invention, including each of Refrigerants A, B and C and refrigerants R1 through R14 as defined in the table above, preferably has an evaporator glide of not greater than 5.6° C.

The refrigerants of the present invention, including each of Refrigerants A, B and C and refrigerants R1 through R14 as defined in the table above, preferably is non-flammability according to ASHRAE Standard 34.

The refrigerants of the present invention, including each of Refrigerants A, B and C and refrigerants R1 through R14 as defined in the table above, preferably has a normal boiling point of not greater than 6.3° C.

The refrigerants of the present invention, including each of Refrigerants A, B and C and refrigerants R1 through R14 as defined in the table above, preferably has two more of the following properties: (i) a global warming potential (GWP) of not greater than 150; (ii) an evaporator glide of not greater than 5.6° C.; (iii) non-flammability according to ASHRAE Standard 34; and (iv) a normal boiling point of not greater than 6.3° C.

The refrigerants of the present invention, including each of Refrigerants A, B and C and refrigerants R1 through R14 as defined in the table above, preferably has three or more of the following properties: (i) a global warming potential (GWP) of not greater than 150; (ii) an evaporator glide of not greater than 5.6° C.; (iii) non-flammability according to ASHRAE Standard 34; and (iv) a normal boiling point of not greater than 6.3° C.

The refrigerants of the present invention, including each of Refrigerants A, B and C and refrigerants R1 through R14 as defined in the table above, preferably have each of the following properties: (i) a global warming potential (GWP) of not greater than 150; (ii) an evaporator glide of not greater than 5.6° C.; (iii) non-flammability according to ASHRAE Standard 34; and (iv) a normal boiling point of not greater than 6.3° C.

The refrigerants of the present invention, including each of Refrigerants A, B and C and refrigerants R1 through R14 as defined in the table above, preferably have each of the following properties: (i) a global warming potential (GWP) of not greater than 150; (ii) an evaporator glide of not greater than 5.5° C.; (iii) non-flammability according to ASHRAE Standard 34; and (iv) a normal boiling point of not greater than 6° C.

The present invention also includes cascade systems and methods which utilize a first heat transfer composition comprising a first refrigerant and optionally a lubricant for the compressor in a primary refrigeration circuit, and a second heat transfer composition comprising a second refrigerant in a secondary refrigeration circuit coupled for heat transfer with the first circuit.

### A. Primary Refrigerant Compositions and Heat Transfer Compositions

In preferred embodiments the first refrigerant (also sometimes referred to herein as the “primary refrigerant”) may comprise one or more components that would make the refrigerant substantially less desirable from a toxicity and/or flammability standard than the second refrigerant, and all such first refrigerants are included within the broad scope of the present disclosure.

For example, the first refrigerant may include one or more of blends comprising one or more of difluoromethane (HFC-32 or R32), 2,3,3,3-tetrafluoropropene (HFO-1234yf or R1234yf), fluoroethane (R161), carbon dioxide (CO₂), and propane. The second heat transfer compositions of the present disclosure, in contrast to the first heat transfer composition, generally does not include in preferred embodiments a lubricant since the second heat transfer composition or fluid does pass through a compressor.

The table below defines a series of primary refrigerants of the present disclosure which include the indicated components and the amounts, with each such refrigerant being defined as a Primary Refrigerant and abbreviated in the table by the PR number in column 1 of the table below, it being understood that all values are understood to be preceded by the word “about” unless otherwise indicated in the table. In the table below it is also understood that unless a “Refrigerant Component” is specifically indicated in the table in the second column (under the heading Transition Phrase) to be “comprising” (using the abbreviation COMP), “consisting essentially of” (using the abbreviation CEO) or “consisting of,” (using the abbreviation CO), then the refrigerant contains the refrigerant component as indicated. The designation “NR” is understood to mean that the component is not required (but may be present).

TABLE 1
Primary Refrigerant Compositions

| | | Refrigerant Components | | | | |
|---|---|---|---|---|---|---|
| Primary | Transition | R32 | R1234yf | R161 | CO₂ | Propane |
| Fluid | Phrase | (wt. %) | (wt. %) | (wt. %) | (wt. %) | (wt. %) |
| PR1A | COMP | 10-30 | 70-90 | NR | NR | NR |
| PR1B | CEO | 10-30 | 70-90 | NR | NR | NR |
| PR1C | CO | 10-30 | 70-90 | NR | NR | NR |
| PR2A | COMP | 10-30 | 70-90 | >0-10 | NR | NR |
| PR2B | CEO | 10-30 | 70-90 | >0-10 | NR | NR |
| PR2C | CO | 10-30 | 70-90 | >0-10 | NR | NR |
| PR3A | COMP | 10-30 | 70-90 | NR | >0-5 | NR |
| PR3B | CEO | 10-30 | 70-90 | NR | >0-5 | NR |
| PR3C | CO | 10-30 | 70-90 | NR | >0-5 | NR |
| | | | | | 2-4 | |
| PR4 | COMP | 21.5 +/− 2.0 | 78.5 +/− 2.0 | NR | NR | NR |
| (R454C) | | | | | | |
| PR5 | COMP | 21.5 +/− 2.0 | 72.5 +/− 2.0 | 6 +/− 0.5 | NR | NR |
| (HDR159) | | | | | | |
| PR6 | COMP | 21.5+/− | 75.5 +/− 2.0 | NR | 3 + 2.0 | NR |
| (R455A) | | | | | | |
| PR7 | COMP | NR | NR | NR | NR | 100 |
| (Propane) | | | | | | |

The present disclosure also provides first (or “primary”) heat transfer compositions which comprise a primary refrigerant within the broad scope of this disclosure, including the specific primary refrigerant compositions described in Section A and in Table 1 above.

The first heat transfer compositions generally comprise a primary refrigerant and a lubricant. In preferred embodiments, the heat transfer composition comprises a lubricant in an amount as low as 0.1 wt. %, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, 15 wt. %, 20 wt. %, 25 wt. %, 30 wt. %, or within any range encompassed by any two of the foregoing values as endpoints, based on the total weight of the heat transfer composition.

Other optional components that may be included in the heat transfer composition include a compatibilizer, such as propane, for the purpose of aiding compatibility and/or solubility of the lubricant. When present, such compatibilizers, including propane, butanes and pentanes, are preferably present in amounts of from about 0.5 to about 5 percent by weight of the composition. Combinations of surfactants and solubilizing agents may also be added to the present compositions to aid oil solubility, as disclosed by U.S. Pat. No. 6,516,837, the disclosure of which is incorporated by reference. Commonly used refrigeration lubricants such as polyol esters (POEs), polyvinyl ethers (PVEs), and poly alkylene glycols (PAGs), silicone oil, mineral oil, alkyl benzenes (ABs) and poly(alpha-olefins) (PAOs) that are used in refrigeration machinery with hydrofluorocarbon (HFC) refrigerants may be used with the refrigerant compositions of the present disclosure. The preferred lubricants are POEs.

The table below defines a series of primary heat transfer compositions of the present disclosure with each such heat transfer composition being defined as a Heat Transfer Composition and abbreviated in the table by the HTC number in column 1 of the table below which comprise a Primary Refrigerant defined by PF number in the table above and the indicated lubricant, it being understood that all values are understood to be preceded by the word “about” unless otherwise indicated in the table.

TABLE 2
Primary Heat Transfer Compositions

| Heat Transfer Composition | Primary Refrigerant | Lubricant |
|---|---|---|
| HTC1 | PR1A | POE |
| HTC2 | PR1B | POE |
| HTC3 | PR1C | POE |
| HTC4 | PR2A | POE |
| HTC5 | PR2B | POE |
| HTC6 | PR2C | POE |
| HTC7 | PR3A | POE |
| HTC8 | PR3B | POE |
| HTC9 | PR3C | POE |
| HTC10 | PR4 (R454C) | POE |
| HTC11 | PR5 (HDR159) | POE |
| HTC12 | PR6 (R455A) | POE |
| HTC13 | PR7 (Propane) | POE |
| HTC14 | PR1A | PVE |
| HTC15 | PR1B | PVE |
| HTC16 | PR1C | PVE |
| HTC17 | PR2A | PVE |
| HTC18 | PR2B | PVE |
| HTC19 | PR2C | PVE |
| HTC20 | PR3A | PVE |
| HTC21 | PR3B | PVE |
| HTC22 | PR3C | PVE |
| HTC23 | PR4 (R454C) | PVE |
| HTC24 | PR5 (HDR159) | PVE |
| HTC25 | PR6 (R455A) | PVE |
| HTC26 | PR7 (Propane) | PVE |

### B. Secondary Refrigerant Compositions

Since the secondary refrigerant compositions according to the present systems and methods will be in heat transfer contact with indoor air, it is generally considered especially important that such fluids possess not only excellent properties relevant heat transfer performance, but also properties relevant to the safety of such fluids, such as acceptable toxicity and non-flammability. The low GWP of the secondary refrigerant is also an important feature of the secondary refrigerant. Applicants have found that the refrigerants of the present invention are unexpectedly able to provide second refrigerants that provide this desirable combinations of properties, including non-flammability. In addition, for optimal performance, secondary fluids should have positive operating pressures at various conditions of system operations. The positive pressure is required to ensure that the system has always positive pressure avoiding any contamination with humid air in case of leak. This also ensures that materials like PVC can be used for connecting lines. In order to avoid the system to go into sub-atmospheric pressure the secondary fluids should have boiling point range of 0-6° C. Secondly, to maintain a reasonable approach temperature (difference of refrigerant temperature at condenser (high pressure cycle) outlet and average evaporator (low pressure secondary cycle) temperature)), the full evaporator glide of the secondary refrigerants should be below 5.5° C. for the preferred embodiments and 3.5° C. for the most preferred embodiments.

It is desirable that a secondary fluid provides high heat transfer and low pressure drop in the system at all conditions during system operations. Applicants have defined a Merit Number which the ratio of heat transfer coefficient and frictional pressure drop. The proposed secondary fluids should have higher merit numbers than traditionally used glycol suggesting proposed secondary fluids would offer superior performance in a real system.

Those skilled in the art will appreciate in view of the disclosures contained herein that such embodiments of the present disclosure provide the advantage of utilizing only the relatively safe (low toxicity and low flammability) low GWP refrigerants, which make them highly preferred for use in a location proximate to the humans or other animals occupying a dwelling, as is commonly encountered in air conditioning applications.

The present disclosure thus provides a second refrigerant compositions, (also sometimes referred to herein as “secondary refrigerant composition”) including each of Refrigerants A, B and C, which may be used with a primary refrigerant in a multi-stage air conditioning system, such as the primary refrigerants set forth in Table 1 above and/or the primary heat transfer compositions set forth in Table 2 above. The preferred embodiments of the present invention are unexpectedly able to provide a second refrigerant or heat transfer composition that is at once non-flammable according to ASHRAE Standard 34 (which measures flammability of the initial vapor from fraction of the mixture as would occur in the event of a leak of the refrigerant) and also produces a pressure above about 1 bar in the indoor loop of the refrigeration system. In addition, the preferred embodiments have relatively higher boiling points compared to other refrigerant fluids such that they avoid over pressurizing the PVC piping used indoors in air conditioning and refrigeration systems. The evaporator glide of the secondary refrigerants in preferred embodiments is also relatively lower compared to other refrigerant fluids which prevents the deterioration of refrigeration systems.

Thus, applicants have been unexpectedly able to identify second refrigerants which have certain properties which make them highly advantageous for use inside multi-stage air conditioning and refrigeration systems. For example, the second refrigerant may have a low global warming potential, low evaporator glide, low boiling point, and/or non-flammability, and preferably all of these features.

The second refrigerant preferably has a low global warming potential (GWP) such as less than 500, less than 450, less than 400, less than 350, less than 300, less than 250, less than 200, less than 150, less than 100, or less than 50.

The second refrigerant preferably also has a low evaporator glide such as less than 6° C., less than 5.5° C., less than 5° C., less than 4.5° C., less than 4° C., less than 3.5° C., less than 3° C., less than 2.5° C., less than 2° C., less than 1.5° C., less than 1° C., or less than 0.5° C. In some embodiments, the second refrigerant comprises R1336mzz(E) and has a full evaporator glide of less than 3.5° C. In some embodiments, the second refrigerant comprises R1224yd(Z) and has a full evaporator glide of less than 5.5° C.

The second refrigerant preferably also has a low flammability and low toxicity refrigerant, preferably with a Class A toxicity according to ASHRAE Standard 34 2022 and a flammability of Class 1 or Class 2 or Class 2L. In especially preferred embodiments, the secondary refrigerant fluid has non-flammability in accordance with ASTM standard E-681-2001 at conditions described in ASHRAE Standard 34-2013 and described in Appendix B1 to ASHRAE Standard 32-2013.

The second refrigerant preferably also has a boiling point of less than 15° C., less than 14° C., less than 13° C., less than 12° C., less than 11° C., less than 10° C., less than 9° C., less than 8° C., less than 7° C., less than 6° C., less than 5° C., less than 4° C., less than 3° C., less than 2° C., less than 1° C., or less than 0.5° C.

The secondary refrigerant in preferred embodiments may comprise a blend of two or more different low GWP fluids, including cis-1,3,3,3-tetrafluoropropene (R1234ze(Z)), trans-1,3,3,3-tetrafluoropropene (R1234ze(E)), trans-1,1,1,4,4,4-hexafluoro-2-butene (R1336mzz(E)), R1233zd(E), 1,1,1,2-tetrafluoroethane (R134a) and 1,1,1,2,3,3,3-heptafluoropropane (R227ea), R134a, R245fa and R227ea, provided that 1234ze(E) is present in all blends. Any of the foregoing fluids may be mixed in different proportions to form tertiary or quaternary blends. For example, the secondary refrigerant comprises a quaternary blend of R1234ze(Z), R1234ze(E), R1233zd(E) and R245fa. IN another example, the secondary refrigerant may comprise a tertiary blend of R1234ze(Z), R1234ze(E), and R1336mzz(E). The secondary refrigerant may also comprise a quaternary blend of R1234ze(Z), R1234ze(E), R1336mzz(E) and R227ea. The ranges in the table below for each component corresponds to amounts that may be present in any fluid blend of the second refrigerant.

The table below defines a series of secondary refrigerants of the present disclosure which include the indicated components and the amounts, with each such refrigerant being defined as a Secondary Refrigerant and abbreviated in the table by the SR number in column 1 of the table below, it being understood that all values are understood to be preceded by the word “about” unless otherwise indicated in the table. In the table below it is also understood that unless a “Refrigerant Component” is specifically indicated in the table in the second column (under the heading Transition Phrase) to be “consisting essentially of” (using the abbreviation CEO) or “consisting of,” (using the abbreviation CO), then refrigerant comprises the refrigerant component as indicated. The designation “NR” is understood to mean that the component is not required (but may be present).

### Table 3

### Secondary Refrigerant Compositions

The table below defines a series of secondary refrigerants of the present disclosure which include the indicated components and the amounts, with each such refrigerant being defined as a Secondary Refrigerant and abbreviated in the table by the SR number in column 1 of the table below, it being understood that all values are understood to be preceded by the word “about” unless otherwise indicated in the table. In the table below it is also understood that unless a “Refrigerant Component” is specifically indicated in the table in the second column (under the heading Transition Phrase) to be “comprising” (using the abbreviation “COMP”), “consisting essentially of” (using the abbreviation CEO) or “consisting of,” (using the abbreviation CO), then refrigerant comprises the refrigerant component as indicated. The designation NR is understood to mean that the component is not required (but may be present within the scope of the transition phrase).

TABLE 3
Secondary Refrigerant Compositions

| | | REFRIGERANT COMPONENTS | | | | | | |
|---|---|---|---|---|---|---|---|---|
| | | R1234ze | R1234ze | 1336mzz | 1224yd | 1233zd | | |
| Second | Trans. | (Z) | (E) | (E) | (Z) | (E) | 227 | 245 |
| Fluid | Phrase | (wt. %) | (wt. %) | (wt. %) | wt. % | wt % | ea | fa |
| SR1A | COMP | 49-64 | 3-11 | 33-44 | NR | NR | NR | NR |
| SR1B | CEO | 49-64 | 3-11 | 33-44 | NR | NR | NR | NR |
| SR1C | CO | 49-64 | 3-11 | 33-44 | NR | NR | NR | NR |
| SR1D | COMP | 49-64 | 3-11 | 33-44 | NR | NR | 3-4.4 | NR |
| SR1E | CEO | 49-64 | 3-11 | 33-44 | NR | NR | 3-4.4 | NR |
| SR1F | CO | 49-64 | 3-11 | 33-44 | NR | NR | 3-4.4 | NR |
| SR2A | COMP | 49-63 | 1-9 | 32-37 | NR | NR | NR | NR |
| SR2B | CEO | 49-63 | 1-9 | 32-37 | NR | NR | NR | NR |
| SR2C | CO | 49-63 | 1-9 | 32-37 | NR | NR | NR | NR |
| SR2D | COMP | 49-63 | 1-9 | 32-37 | NR | NR | 4-5 | NR |
| SR2E | CEO | 49-63 | 1-9 | 32-37 | NR | NR | 4-5 | NR |
| SR2F | CO | 49-63 | 1-9 | 32-37 | NR | NR | 4-5 | NR |
| SR3A | COMP | 63-77 | 7-15 | NR | 16-22 | NR | NR | NR |
| SR3B | CEO | 63-77 | 7-15 | NR | 16-22 | NR | NR | NR |
| SR3C | CO | 63-77 | 7-15 | NR | 16-22 | NR | NR | NR |
| SR3D | COMP | 63-77 | 7-15 | NR | 16-22 | NR | 4-5 | NR |
| SR3E | CEO | 63-77 | 7-15 | NR | 16-22 | NR | 4-5 | NR |
| SR3F | CO | 63-77 | 7-15 | NR | 16-22 | NR | 4-5 | NR |
| SR4A | COMP | 65-80 | 4-13 | NR | 12-17 | NR | NR | NR |
| SR12G | CEO | 65-80 | 4-13 | NR | 12-17 | NR | NR | NR |
| SR4C | CO | 65-80 | 4-13 | NR | 12-17 | NR | NR | NR |
| SR4D | COMP | 65-80 | 4-13 | NR | 12-17 | NR | 4-5 | NR |
| SR4E | CEO | 65-80 | 4-13 | NR | 12-17 | NR | 4-5 | NR |
| SR4F | CO | 65-80 | 4-13 | NR | 12-17 | NR | 4-5 | NR |
| SR5A | COMP | 62 | 5 | 33 | NR | NR | NR | NR |
| | | +0.3/−0.3 | +0.3/−0.3 | +2.0/−0.5 | | | | |
| SR5B | CEO | 62 | 5 | 33 | NR | NR | NR | NR |
| | | +0.3/−0.3 | +0.3/−0.3 | +2.0/−0.5 | | | | |
| SR5C | CO | 62 | 5 | 33 | NR | NR | NR | NR |
| | | +0.3/−0.3 | +0.3/−0.3 | +2.0/−0.5 | | | | |
| SR6A | COMP | 60.6 | 3 | 32 | NR | NR | NR | NR |
| | | +0.3/−0.3 | +0.3/−0.3 | +2.0/−0.5 | | | | |
| SR6B | CEO | 60.6 | 3 | 32 | NR | NR | NR | NR |
| | | +0.3/−0.3 | +0.3/−0.3 | +2.0/−0.5 | | | | |
| SR6C | CO | 60.6 | 3 | 32 | NR | NR | NR | NR |
| | | +0.3/−0.3 | +0.3/−0.3 | +2.0/−0.5 | | | | |
| SR6D | COMP | 60.6 | 3 | 32 | NR | NR | 4.4 +/− 1.0 | NR |
| | | +0.3/−0.3 | +0.3/−0.3 | +2.0/−0.5 | | | | |
| SR6E | CEO | 60.6 | 3 | 32 | NR | NR | 4.4 +/− 1.0 | NR |
| | | +0.3/−0.3 | +0.3/−0.3 | +2.0/−0.5 | | | | |
| SR6F | CO | 60.6 | 3 | 32 | NR | NR | 4.4 +/− 1.0 | NR |
| | | +0.3/−0.3 | +0.3/−0.3 | +2.0/−0.5 | | | | |
| SR7A | COMP | 75 | 9 | NR | 16 | NR | NR | NR |
| | | +0.3/−0.3 | +0.3/−0.3 | | +2.0/−0.5 | | | |
| SR7B | CEO | 75 | 9 | NR | 16 | NR | NR | NR |
| | | +0.3/−0.3 | +0.3/−0.3 | | +2.0/−0.5 | | | |
| SR7C | CO | 75 | 9 | NR | 16 | NR | NR | NR |
| | | +0.3/−0.3 | +0.3/−0.3 | | +2.0/−0.5 | | | |
| SR8A | COMP | 77.6 | 6 | NR | 12 | NR | NR | NR |
| | | +0.3/−0.3 | +0.3/−0.3 | | +2.0/−0.5 | | | |
| SR8B | CEO | 77.6 | 6 | NR | 12 | NR | NR | NR |
| | | +0.3/−0.3 | +0.3/−0.3 | | +2.0/−0.5 | | | |
| SR8C | CO | 77.6 | 6 | NR | 12 | NR | NR | NR |
| | | +0.3/−0.3 | +0.3/−0.3 | | +2.0/−0.5 | | | |
| SR8D | COMP | 77.6 | 6 | NR | 12 | NR | 4.4 +/− 1.0 | NR |
| | | +0.3/−0.3 | +0.3/−0.3 | | +2.0/−0.5 | | | |
| SR8E | CEO | 77.6 | 6 | NR | 12 | NR | 4.4 +/− 1.0 | NR |
| | | +0.3/−0.3 | +0.3/−0.3 | | +2.0/−0.5 | | | |
| SR8F | CO | 77.6 | 6 | NR | 12 | NR | 4.4 +/− 1.0 | NR |
| | | +0.3/−0.3 | +0.3/−0.3 | | +2.0/−0.5 | | | |
| SR9A | COMP | 22.8-69 | 7.5-14.5 | NR | NR | 9-52 | NR | NR |
| SR9B | CEO | 22.8-69 | 7.5-14.5 | NR | NR | 9-52 | NR | NR |
| SR9C | CO | 22.8-69 | 7.5-14.5 | NR | NR | 9-52 | NR | NR |
| SR9D | COMP | 22.8-69 | 7.5-14.5 | NR | NR | 9-52 | NR | 5-14.5 |
| SR9E | CEO | 22.8-69 | 7.5-14.5 | NR | NR | 9-52 | NR | 5-14.5 |
| SR9F | CO | 22.8-69 | 7.5-14.5 | NR | NR | 9-52 | NR | 5-14.5 |
| SR10A | COMP | 30-40 | 10-12 | NR | NR | 48-52 | NR | NR |
| SR10B | CEO | 30-40 | 10-12 | NR | NR | 48-52 | NR | NR |
| SR10C | CO | 30-40 | 10-12 | NR | NR | 48-52 | NR | NR |
| SR10D | COMP | 30-40 | 10-12 | NR | NR | 48-52 | NR | 5-6 |
| SR10E | CEO | 30-40 | 10-12 | NR | NR | 48-52 | NR | 5-6 |
| SR10F | CO | 30-40 | 10-12 | NR | NR | 48-52 | NR | 5-6 |
| SR10G | COMP | 34 | 11 | NR | NR | 50 | NR | 5 +/− 1.0 |
| | | +0.3/−0.3 | +0.3/−0.3 | | | +1.0/−1.0 | | |
| SR10H | CEO | 34 | 11 | NR | NR | 50 | NR | 5 +/− 1.0 |
| | | +0.3/−0.3 | +0.3/−0.3 | | | +1.0/−1.0 | | |
| SR10I | CO | 34 | 11 | NR | NR | 50 | NR | 5 +/− 1.0 |
| | | +0.3/−0.3 | +0.3/−0.3 | | | +1.0/−1.0 | | |
| SR11A | COMP | 35-45 | 8-12 | NR | NR | 40-50 | NR | NR |
| SR11B | CEO | 35-45 | 8-12 | NR | NR | 40-50 | NR | NR |
| SR11C | CO | 35-45 | 8-12 | NR | NR | 40-50 | NR | NR |
| SR11D | COMP | 35-45 | 8-12 | NR | NR | 40-50 | NR | 5-6 |
| SR11E | CEO | 35-45 | 8-12 | NR | NR | 40-50 | NR | 5-6 |
| SR11F | CO | 35-45 | 8-12 | NR | NR | 40-50 | NR | 5-6 |
| SR11G | COMP | 40 | 10 | NR | NR | 45 | NR | 5 +/− 1.0 |
| | | +0.3/−0.3 | +0.3/−0.3 | | | +1.0/−1.0 | | |
| SR11H | CEO | 40 | 10 | NR | NR | 45 | NR | 5 +/− 1.0 |
| | | +0.3/−0.3 | +0.3/−0.3 | | | +1.0/−1.0 | | |
| SR11I | CO | 40 | 10 | NR | NR | 45 | NR | 5 +/− 1.0 |
| | | +0.3/−0.3 | +0.3/−0.3 | | | +1.0/−1.0 | | |
| SR12A | COMP | 40-45 | 10-15 | NR | NR | 30-40 | NR | NR |
| SR12B | CEO | 40-45 | 10-15 | NR | NR | 30-40 | NR | NR |
| SR12C | CO | 40-45 | 10-15 | NR | NR | 30-40 | NR | NR |
| SR12D | COMP | 40-45 | 10-15 | NR | NR | 30-40 | NR | 8-12 |
| SR12E | CEO | 40-45 | 10-15 | NR | NR | 30-40 | NR | 8-12 |
| SR12F | CO | 40-45 | 10-15 | NR | NR | 30-40 | NR | 8-12 |
| SR12G | COMP | 42 | 13 | NR | NR | 35 | NR | 10 +/− 1.0 |
| | | +0.3/−0.3 | +0.3/−0.3 | | | +1.0/−1.0 | | |
| SR12H | CEO | 42 | 13 | NR | NR | 35 | NR | 10 +/− 1.0 |
| | | +0.3/−0.3 | +0.3/−0.3 | | | +1.0/−1.0 | | |
| SR12I | CO | 42 | 13 | NR | NR | 35 | NR | 10 +/− 1.0 |
| | | +0.3/−0.3 | +0.3/−0.3 | | | +1.0/−1.0 | | |
| SR13A | COMP | 50-55 | 8-12 | NR | NR | 25-30 | NR | NR |
| SR13B | CEO | 50-55 | 8-12 | NR | NR | 25-30 | NR | NR |
| SR13C | CO | 50-55 | 8-12 | NR | NR | 25-30 | NR | NR |
| SR13D | COMP | 50-55 | 8-12 | NR | NR | 25-30 | NR | 8-12 |
| SR13E | CEO | 50-55 | 8-12 | NR | NR | 25-30 | NR | 8-12 |
| SR13F | CO | 50-55 | 8-12 | NR | NR | 25-30 | NR | 8-12 |
| SR13G | COMP | 53 | 10 | NR | NR | 27 | NR | 10 +/− 1.0 |
| | | +0.3/−0.3 | +0.3/−0.3 | | | +1.0/−1.0 | | |
| SR13H | CEO | 53 | 10 | NR | NR | 27 | NR | 10 +/− 1.0 |
| | | +0.3/−0.3 | +0.3/−0.3 | | | +1.0/−1.0 | | |
| SR13I | CO | 53 | 10 | NR | NR | 27 | NR | 10 +/− 1.0 |
| | | +0.3/−0.3 | +0.3/−0.3 | | | +1.0/−1.0 | | |
| SR14A | COMP | 55-65 | 8-12 | NR | NR | 10-20 | NR | NR |
| SR14B | CEO | 55-65 | 8-12 | NR | NR | 10-20 | NR | NR |
| SR14C | CO | 55-65 | 8-12 | NR | NR | 10-20 | NR | NR |
| SR14D | COMP | 55-65 | 8-12 | NR | NR | 10-20 | NR | 14-15 |
| SR14E | CEO | 55-65 | 8-12 | NR | NR | 10-20 | NR | 14-15 |
| SR14F | CO | 55-65 | 8-12 | NR | NR | 10-20 | NR | 14-15 |
| SR14G | COMP | 60 | 10.5 | NR | NR | 15 | NR | 14.5 +/− 1.0 |
| | | +0.3/−0.3 | +0.3/−0.3 | | | +1.0/−1.0 | | |
| SR14H | CEO | 60 | 10.5 | NR | NR | 15 | NR | 14.5 +/− 1.0 |
| | | +0.3/−0.3 | +0.3/−0.3 | | | +1.0/−1.0 | | |
| SR14I | CO | 60 | 10.5 | NR | NR | 15 | NR | 14.5 +/− 1.0 |
| | | +0.3/−0.3 | +0.3/−0.3 | | | +1.0/−1.0 | | |

The secondary refrigerants of the present invention, including each of Refrigerants A, B and C and refrigerants SR1 through SR14 as defined in Table 3 above, preferably have a global warming potential (GWP) of not greater than 150.

The refrigerants of the present invention, including each of Refrigerants A, B and C and refrigerants SR1 through SR14 as defined in Table 3, preferably has an evaporator glide of not greater than 5.6° C.

The refrigerants of the present invention, including each of Refrigerants A, B and C and refrigerants SR1 through SR14 as defined in Table 3, preferably is non-flammability according to ASHRAE Standard 34.

The refrigerants of the present invention, including each of Refrigerants A, B and C and refrigerants SR1 through SR14 as defined in Table 3, preferably has a normal boiling point of not greater than 6.3° C.

The refrigerants of the present invention, including each of Refrigerants A, B and C and refrigerants SR1 through SR14 as defined in Table 3, preferably has two more of the following properties: (i) a global warming potential (GWP) of not greater than 150; (ii) an evaporator glide of not greater than 5.6° C.; (iii) non-flammability according to ASHRAE Standard 34; and (iv) a normal boiling point of not greater than 6.3° C.

The refrigerants of the present invention, including each of Refrigerants A, B and C and refrigerants SR1 through SR14 as defined in Table 3, preferably has three or more of the following properties: (i) a global warming potential (GWP) of not greater than 150; (ii) an evaporator glide of not greater than 5.6° C.; (iii) non-flammability according to ASHRAE Standard 34; and (iv) a normal boiling point of not greater than 6.3° C.

The refrigerants of the present invention, including each of Refrigerants A, B and C and refrigerants SR1 through SR14 as defined in Table 3, preferably have each of the following properties: (i) a global warming potential (GWP) of not greater than 150; (ii) an evaporator glide of not greater than 5.6° C.; (iii) non-flammability according to ASHRAE Standard 34; and (iv) a normal boiling point of not greater than 6.3° C.

The refrigerants of the present invention, including each of Refrigerants A, B and C and refrigerants SR1 through SR14 as defined in Table 3, preferably have each of the following properties: (i) a global warming potential (GWP) of not greater than 150; (ii) an evaporator glide of not greater than 5.5° C.; (iii) non-flammability according to ASHRAE Standard 34; and (iv) a normal boiling point of not greater than 6° C.

The present invention also includes cascade systems and methods which utilize a first heat transfer composition comprising a first refrigerant and optionally a lubricant for the compressor in a primary refrigeration circuit, and a second heat transfer composition comprising a second refrigerant, including each of Refrigerants A, B and C and refrigerants SR1 through SR14 as defined in Table 3, in a secondary refrigeration circuit coupled for heat transfer with the first circuit.

### III. Secondary Systems

The table below defines a series of secondary systems of the present disclosure which may employ the secondary conditions and components of Table 3 above and in addition may include the elements or limitations thereof as specified in Table 4 below, with each such system being defined as a Secondary System (SS) of the present disclosure by the SS number/letter in column 1 of Table 4 below, it being understood that all values are understood to be preceded by the word “about” unless otherwise indicated in the table. The designation “NR” is understood to mean that the component or property is not required (but may be present), while the designation “NP” means the component is not present in the system. The abbreviations in the table below are as follows: “Ref.” is for refrigerant. “Lub.” is for lubricant, and “Comp.” is for compressor.

TABLE 4
Secondary Systems

| | Primary Stage | | | Secondary Stage | | | Overall Cycle | Overall Cycle |
|---|---|---|---|---|---|---|---|---|
| Secondary | Components | | | Components | | | Evaporator | Condenser |
| System | Ref. | Lub. | Comp. | Ref. | Lub. | Comp. | Temperature | Temperature |
| SS1A1 | PR1A | NR | Yes | SR1A | NP | NP | −20° C. to 15° C. | 20° C. to 65° C. |
| SS1B1 | PR1B | NR | Yes | SR9A | NP | NP | −20° C. to 15° C. | 20° C. to 65° C. |
| SS1C1 | PR1C | NR | Yes | SR9A | NP | NP | −20° C. to 15° C. | 20° C. to 65° C. |
| SS1A2 | PR2A | NR | Yes | SR9A | NP | NP | −20° C. to 15° C. | 20° C. to 65° C. |
| SS1B2 | PR2B | NR | Yes | SR9A | NP | NP | −20° C. to 15° C. | 20° C. to 65° C. |
| SS1C2 | PR2C | NR | Yes | SR9A | NP | NP | −20° C. to 15° C. | 20° C. to 65° C. |
| SS1A3 | PR3A | NR | Yes | SR9A | NP | NP | −20° C. to 15° C. | 20° C. to 65° C. |
| SS1B3 | PR3B | NR | Yes | SR9A | NP | NP | −20° C. to 15° C. | 20° C. to 65° C. |
| SS1C3 | PR3C | NR | Yes | SR9A | NP | NP | −20° C. to 15° C. | 20° C. to 65° C. |
| SS1A4 | PR4 | NR | Yes | SR9A | NP | NP | −20° C. to 15° C. | 20° C. to 65° C. |
| SS1A5 | PR5 | NR | Yes | SR9A | NP | NP | −20° C. to 15° C. | 20° C. to 65° C. |
| SS1A6 | PR6 | NR | Yes | SR9A | NP | NP | −20° C. to 15° C. | 20° C. to 65° C. |
| SS1A7 | PR7 | NR | Yes | SR9A | NP | NP | −20° C. to 15° C. | 20° C. to 65° C. |
| SS1A8 | PR1A | POE | Yes | SR9A | NP | NP | −20° C. to 15° C. | 20° C. to 65° C. |
| SS1B8 | PR1B | POE | Yes | SR9A | NP | NP | −20° C. to 15° C. | 20° C. to 65° C. |
| SS1C8 | PR1C | POE | Yes | SR9A | NP | NP | −20° C. to 15° C. | 20° C. to 65° C. |
| SS1A9 | PR2A | POE | Yes | SR9A | NP | NP | −20° C. to 15° C. | 20° C. to 65° C. |
| SS1B9 | PR2B | POE | Yes | SR9A | NP | NP | −20° C. to 15° C. | 20° C. to 65° C. |
| SS1C9 | PR2C | POE | Yes | SR9A | NP | NP | −20° C. to 15° C. | 20° C. to 65° C. |
| SS1A10 | PR3A | POE | Yes | SR9A | NP | NP | −20° C. to 15° C. | 20° C. to 65° C. |
| SS1B10 | PR3B | POE | Yes | SR9A | NP | NP | −20° C. to 15° C. | 20° C. to 65° C. |
| SS1C10 | PR3C | POE | Yes | SR9A | NP | NP | −20° C. to 15° C. | 20° C. to 65° C. |
| SS1A11 | PR4 | POE | Yes | SR9A | NP | NP | −20° C. to 15° C. | 20° C. to 65° C. |
| SS1A12 | PR5 | POE | Yes | SR9A | NP | NP | −20° C. to 15° C. | 20° C. to 65° C. |
| SS1A13 | PR6 | POE | Yes | SR9A | NP | NP | −20° C. to 15° C. | 20° C. to 65° C. |
| SS1A14 | PR7 | POE | Yes | SR9A | NP | NP | −20° C. to 15° C. | 20° C. to 65° C. |
| SS1A15 | PR1A | PVE | Yes | SR9A | NP | NP | −20° C. to 15° C. | 20° C. to 65° C. |
| SS1B15 | PR1B | PVE | Yes | SR9A | NP | NP | −20° C. to 15° C. | 20° C. to 65° C. |
| SS1C15 | PR1C | PVE | Yes | SR9A | NP | NP | −20° C. to 15° C. | 20° C. to 65° C. |
| SS1A16 | PR2A | PVE | Yes | SR9A | NP | NP | −20° C. to 15° C. | 20° C. to 65° C. |
| SS1B16 | PR2B | PVE | Yes | SR9A | NP | NP | −20° C. to 15° C. | 20° C. to 65° C. |
| SS1C16 | PR2C | PVE | Yes | SR9A | NP | NP | −20° C. to 15° C. | 20° C. to 65° C. |
| SS1A17 | PR3A | PVE | Yes | SR9A | NP | NP | −20° C. to 15° C. | 20° C. to 65° C. |
| SS1B17 | PR3B | PVE | Yes | SR9A | NP | NP | −20° C. to 15° C. | 20° C. to 65° C. |
| SS1C17 | PR3C | PVE | Yes | SR9A | NP | NP | −20° C. to 15° C. | 20° C. to 65° C. |
| SS1A19 | PR4 | PVE | Yes | SR9A | NP | NP | −20° C. to 15° C. | 20° C. to 65° C. |
| SS1A20 | PR5 | PVE | Yes | SR9A | NP | NP | −20° C. to 15° C. | 20° C. to 65° C. |
| SS1A21 | PR6 | PVE | Yes | SR9A | NP | NP | −20° C. to 15° C. | 20° C. to 65° C. |
| SS1A22 | PR7 | PVE | Yes | SR9A | NP | NP | −20° C. to 15° C. | 20° C. to 65° C. |
| SS2A1 | PR1A | NR | Yes | SR9B | NP | NP | −20° C. to 15° C. | 20° C. to 65° C. |
| SS2B1 | PR1B | NR | Yes | SR9B | NP | NP | −20° C. to 15° C. | 20° C. to 65° C. |
| SS2C1 | PR1C | NR | Yes | SR9B | NP | NP | −20° C. to 15° C. | 20° C. to 65° C. |
| SS2A2 | PR2A | NR | Yes | SR9B | NP | NP | −20° C. to 15° C. | 20° C. to 65° C. |
| SS2B2 | PR2B | NR | Yes | SR9B | NP | NP | −20° C. to 15° C. | 20° C. to 65° C. |
| SS2C2 | PR2C | NR | Yes | SR9B | NP | NP | −20° C. to 15° C. | 20° C. to 65° C. |
| SS2A3 | PR3A | NR | Yes | SR9B | NP | NP | −20° C. to 15° C. | 20° C. to 65° C. |
| SS2B3 | PR3B | NR | NR | SR9B | NP | NP | −20° C. to 15° C. | 20° C. to 65° C. |
| SS2C3 | PR3C | NR | NR | SR9B | NP | NP | −20° C. to 15° C. | 20° C. to 65° C. |
| SS2A4 | PR4 | NR | NR | SR9B | NP | NP | −20° C. to 15° C. | 20° C. to 65° C. |
| SS2A5 | PR5 | NR | NR | SR9B | NP | NP | −20° C. to 15° C. | 20° C. to 65° C. |
| SS2A6 | PR6 | NR | NR | SR9B | NP | NP | −20° C. to 15° C. | 20° C. to 65° C. |
| SS2A7 | PR7 | NR | NR | SR9B | NP | NP | −20° C. to 15° C. | 20° C. to 65° C. |
| SS2A8 | PR1A | POE | NR | SR9B | NP | NP | −20° C. to 15° C. | 20° C. to 65° C. |
| SS2B8 | PR1B | POE | NR | SR9B | NP | NP | −20° C. to 15° C. | 20° C. to 65° C. |
| SS2C8 | PR1C | POE | NR | SR9B | NP | NP | −20° C. to 15° C. | 20° C. to 65° C. |
| SS2A9 | PR2A | POE | NR | SR9B | NP | NP | −20° C. to 15° C. | 20° C. to 65° C. |
| SS2B9 | PR2B | POE | NR | SR9B | NP | NP | −20° C. to 15° C. | 20° C. to 65° C. |
| SS2C9 | PR2C | POE | NR | SR9B | NP | NP | −20° C. to 15° C. | 20° C. to 65° C. |
| SS2A10 | PR3A | POE | NR | SR9B | NP | NP | −20° C. to 15° C. | 20° C. to 65° C. |
| SS2B10 | PR3B | POE | NR | SR9B | NP | NP | −20° C. to 15° C. | 20° C. to 65° C. |
| SS2C10 | PR3C | POE | NR | SR9B | NP | NP | −20° C. to 15° C. | 20° C. to 65° C. |
| SS2A11 | PR4 | POE | NR | SR9B | NP | NP | −20° C. to 15° C. | 20° C. to 65° C. |
| SS2A12 | PR5 | POE | NR | SR9B | NP | NP | −20° C. to 15° C. | 20° C. to 65° C. |
| SS2A13 | PR6 | POE | NR | SR9B | NP | NP | −20° C. to 15° C. | 20° C. to 65° C. |
| SS2A14 | PR7 | POE | NR | SR9B | NP | NP | −20° C. to 15° C. | 20° C. to 65° C. |
| SS2A15 | PR1A | PVE | NR | SR9B | NP | NP | −20° C. to 15° C. | 20° C. to 65° C. |
| SS2B15 | PR1B | PVE | NR | SR9B | NP | NP | −20° C. to 15° C. | 20° C. to 65° C. |
| SS2C15 | PR1C | PVE | NR | SR9B | NP | NP | −20° C. to 15° C. | 20° C. to 65° C. |
| SS2A16 | PR2A | PVE | NR | SR9B | NP | NP | −20° C. to 15° C. | 20° C. to 65° C. |
| SS2B16 | PR2B | PVE | NR | SR9B | NP | NP | −20° C. to 15° C. | 20° C. to 65° C. |
| SS2C16 | PR2C | PVE | NR | SR9B | NP | NP | −20° C. to 15° C. | 20° C. to 65° C. |
| SS2A17 | PR3A | PVE | NR | SR9B | NP | NP | −20° C. to 15° C. | 20° C. to 65° C. |
| SS2B17 | PR3B | PVE | NR | SR9B | NP | NP | −20° C. to 15° C. | 20° C. to 65° C. |
| SS2C17 | PR3C | PVE | NR | SR9B | NP | NP | −20° C. to 15° C. | 20° C. to 65° C. |
| SS2A19 | PR4 | PVE | NR | SR9B | NP | NP | −20° C. to 15° C. | 20° C. to 65° C. |
| SS2A20 | PR5 | PVE | NR | SR9B | NP | NP | −20° C. to 15° C. | 20° C. to 65° C. |
| SS2A21 | PR6 | PVE | NR | SR9B | NP | NP | −20° C. to 15° C. | 20° C. to 65° C. |
| SS2A22 | PR7 | PVE | NR | SR9B | NP | NP | −20° C. to 15° C. | 20° C. to 65° C. |
| SS3A1 | PR1A | NR | NR | SR9C | NP | NP | −20° C. to 15° C. | 20° C. to 65° C. |
| SS3B1 | PR1B | NR | NR | SR9C | NP | NP | −20° C. to 15° C. | 20° C. to 65° C. |
| SS3C1 | PR1C | NR | NR | SR9C | NP | NP | −20° C. to 15° C. | 20° C. to 65° C. |
| SS3A2 | PR2A | NR | NR | SR9C | NP | NP | −20° C. to 15° C. | 20° C. to 65° C. |
| SS3B2 | PR2B | NR | NR | SR9C | NP | NP | −20° C. to 15° C. | 20° C. to 65° C. |
| SS3C2 | PR2C | NR | NR | SR9C | NP | NP | −20° C. to 15° C. | 20° C. to 65° C. |
| SS3A3 | PR3A | NR | NR | SR9C | NP | NP | −20° C. to 15° C. | 20° C. to 65° C. |
| SS3B3 | PR3B | NR | NR | SR9C | NP | NP | −20° C. to 15° C. | 20° C. to 65° C. |
| SS3C3 | PR3C | NR | NR | SR9C | NP | NP | −20° C. to 15° C. | 20° C. to 65° C. |
| SS3A4 | PR4 | NR | NR | SR9C | NP | NP | −20° C. to 15° C. | 20° C. to 65° C. |
| SS3A5 | PR5 | NR | NR | SR9C | NP | NP | −20° C. to 15° C. | 20° C. to 65° C. |
| SS3A6 | PR6 | NR | NR | SR9C | NP | NP | −20° C. to 15° C. | 20° C. to 65° C. |
| SS3A7 | PR7 | NR | NR | SR9C | NP | NP | −20° C. to 15° C. | 20° C. to 65° C. |
| SS3A8 | PR1A | POE | NR | SR9C | NP | NP | −20° C. to 15° C. | 20° C. to 65° C. |
| SS3B8 | PR1B | POE | NR | SR9C | NP | NP | −20° C. to 15° C. | 20° C. to 65° C. |
| SS3C8 | PR1C | POE | NR | SR9C | NP | NP | −20° C. to 15° C. | 20° C. to 65° C. |
| SS3A9 | PR2A | POE | NR | SR9C | NP | NP | −20° C. to 15° C. | 20° C. to 65° C. |
| SS3B9 | PR2B | POE | NR | SR9C | NP | NP | −20° C. to 15° C. | 20° C. to 65° C. |
| SS3C9 | PR2C | POE | NR | SR9C | NP | NP | −20° C. to 15° C. | 20° C. to 65° C. |
| SS3A10 | PR3A | POE | NR | SR9C | NP | NP | −20° C. to 15° C. | 20° C. to 65° C. |
| SS3B10 | PR3B | POE | NR | SR9C | NP | NP | −20° C. to 15° C. | 20° C. to 65° C. |
| SS3C10 | PR3C | POE | NR | SR9C | NP | NP | −20° C. to 15° C. | 20° C. to 65° C. |
| SS3A11 | PR4 | POE | NR | SR9C | NP | NP | −20° C. to 15° C. | 20° C. to 65° C. |
| SS3A12 | PR5 | POE | NR | SR9C | NP | NP | −20° C. to 15° C. | 20° C. to 65° C. |
| SS3A13 | PR6 | POE | NR | SR9C | NP | NP | −20° C. to 15° C. | 20° C. to 65° C. |
| SS3A14 | PR7 | POE | NR | SR9C | NP | NP | −20° C. to 15° C. | 20° C. to 65° C. |
| SS3A15 | PR1A | PVE | NR | SR9C | NP | NP | −20° C. to 15° C. | 20° C. to 65° C. |
| SS3B15 | PR1B | PVE | NR | SR9C | NP | NP | −20° C. to 15° C. | 20° C. to 65° C. |
| SS3C15 | PR1C | PVE | NR | SR9C | NP | NP | −20° C. to 15° C. | 20° C. to 65° C. |
| SS3A16 | PR2A | PVE | NR | SR9C | NP | NP | −20° C. to 15° C. | 20° C. to 65° C. |
| SS3B16 | PR2B | PVE | NR | SR9C | NP | NP | −20° C. to 15° C. | 20° C. to 65° C. |
| SS3C16 | PR2C | PVE | NR | SR9C | NP | NP | −20° C. to 15° C. | 20° C. to 65° C. |
| SS3A17 | PR3A | PVE | NR | SR9C | NP | NP | −20° C. to 15° C. | 20° C. to 65° C. |
| SS3B17 | PR3B | PVE | NR | SR9C | NP | NP | −20° C. to 15° C. | 20° C. to 65° C. |
| SS3C17 | PR3C | PVE | NR | SR9C | NP | NP | −20° C. to 15° C. | 20° C. to 65° C. |
| SS3A19 | PR4 | PVE | NR | SR9C | NP | NP | −20° C. to 15° C. | 20° C. to 65° C. |
| SS3A20 | PR5 | PVE | NR | SR9C | NP | NP | −20° C. to 15° C. | 20° C. to 65° C. |
| SS3A21 | PR6 | PVE | NR | SR9C | NP | NP | −20° C. to 15° C. | 20° C. to 65° C. |
| SS3A22 | PR7 | PVE | NR | SR9C | NP | NP | −20° C. to 15° C. | 20° C. to 65° C. |
| SS3A23 | PR1A | NR | NR | SR9D | NP | NP | −20° C. to 15° C. | 20° C. to 65° C. |
| SS3A24 | PR1B | NR | NR | SR9D | NP | NP | −20° C. to 15° C. | 20° C. to 65° C. |
| SS3A25 | PR1C | NR | NR | SR9D | NP | NP | −20° C. to 15° C. | 20° C. to 65° C. |
| SS3A26 | PR2A | NR | NR | SR9D | NP | NP | −20° C. to 15° C. | 20° C. to 65° C. |
| SS3A27 | PR2B | NR | NR | SR9D | NP | NP | −20° C. to 15° C. | 20° C. to 65° C. |
| SS3A28 | PR2C | NR | NR | SR9D | NP | NP | −20° C. to 15° C. | 20° C. to 65° C. |
| SS3A29 | PR3A | NR | NR | SR9D | NP | NP | −20° C. to 15° C. | 20° C. to 65° C. |
| SS3A30 | PR3B | NR | NR | SR9D | NP | NP | −20° C. to 15° C. | 20° C. to 65° C. |
| SS3A31 | PR3C | NR | NR | SR9D | NP | NP | −20° C. to 15° C. | 20° C. to 65° C. |
| SS3A32 | PR4 | NR | NR | SR9D | NP | NP | −20° C. to 15° C. | 20° C. to 65° C. |
| SS3A33 | PR5 | NR | NR | SR9D | NP | NP | −20° C. to 15° C. | 20° C. to 65° C. |
| SS3A34 | PR6 | NR | NR | SR9D | NP | NP | −20° C. to 15° C. | 20° C. to 65° C. |
| SS3A35 | PR7 | NR | NR | SR9D | NP | NP | −20° C. to 15° C. | 20° C. to 65° C. |
| SS3A36 | PR1A | POE | NR | SR9D | NP | NP | −20° C. to 15° C. | 20° C. to 65° C. |
| SS3A37 | PR1B | POE | NR | SR9D | NP | NP | −20° C. to 15° C. | 20° C. to 65° C. |
| SS3A38 | PR1C | POE | NR | SR9D | NP | NP | −20° C. to 15° C. | 20° C. to 65° C. |
| SS3A39 | PR2A | POE | NR | SR9D | NP | NP | −20° C. to 15° C. | 20° C. to 65° C. |
| SS3A40 | PR2B | POE | NR | SR9D | NP | NP | −20° C. to 15° C. | 20° C. to 65° C. |
| SS3A41 | PR2C | POE | NR | SR9D | NP | NP | −20° C. to 15° C. | 20° C. to 65° C. |
| SS3A41 | PR3A | POE | NR | SR9D | NP | NP | −20° C. to 15° C. | 20° C. to 65° C. |
| SS3A42 | PR3B | POE | NR | SR9D | NP | NP | −20° C. to 15° C. | 20° C. to 65° C. |
| SS3A43 | PR3C | POE | NR | SR9D | NP | NP | −20° C. to 15° C. | 20° C. to 65° C. |
| SS3A44 | PR4 | POE | NR | SR9D | NP | NP | −20° C. to 15° C. | 20° C. to 65° C. |
| SS3A45 | PR5 | POE | NR | SR9D | NP | NP | −20° C. to 15° C. | 20° C. to 65° C. |
| SS3A46 | PR6 | POE | NR | SR9D | NP | NP | −20° C. to 15° C. | 20° C. to 65° C. |
| SS3A47 | PR7 | POE | NR | SR9D | NP | NP | −20° C. to 15° C. | 20° C. to 65° C. |
| SS3A48 | PR1A | PVE | NR | SR9D | NP | NP | −20° C. to 15° C. | 20° C. to 65° C. |
| SS3A49 | PR1B | PVE | NR | SR9D | NP | NP | −20° C. to 15° C. | 20° C. to 65° C. |
| SS3A50 | PR1C | PVE | NR | SR9D | NP | NP | −20° C. to 15° C. | 20° C. to 65° C. |
| SS3A51 | PR2A | PVE | NR | SR9D | NP | NP | −20° C. to 15° C. | 20° C. to 65° C. |
| SS3A52 | PR2B | PVE | NR | SR9D | NP | NP | −20° C. to 15° C. | 20° C. to 65° C. |
| SS3A53 | PR2C | PVE | NR | SR9D | NP | NP | −20° C. to 15° C. | 20° C. to 65° C. |
| SS3A54 | PR3A | PVE | NR | SR9D | NP | NP | −20° C. to 15° C. | 20° C. to 65° C. |
| SS3A55 | PR3B | PVE | NR | SR9D | NP | NP | −20° C. to 15° C. | 20° C. to 65° C. |
| SS3A56 | PR3C | PVE | NR | SR9D | NP | NP | −20° C. to 15° C. | 20° C. to 65° C. |
| SS3A57 | PR4 | PVE | NR | SR9D | NP | NP | −20° C. to 15° C. | 20° C. to 65° C. |
| SS3A58 | PR5 | PVE | NR | SR9D | NP | NP | −20° C. to 15° C. | 20° C. to 65° C. |
| SS3A59 | PR6 | PVE | NR | SR9D | NP | NP | −20° C. to 15° C. | 20° C. to 65° C. |
| SS3A60 | PR7 | PVE | NR | SR9D | NP | NP | −20° C. to 15° C. | 20° C. to 65° C. |
| SS4A1 | PR1A | NR | Yes | SR9E | NP | NP | −20° C. to 15° C. | 20° C. to 65° C. |
| SS4B1 | PR1B | NR | Yes | SR9E | NP | NP | −20° C. to 15° C. | 20° C. to 65° C. |
| SS4C1 | PR1C | NR | Yes | SR9E | NP | NP | −20° C. to 15° C. | 20° C. to 65° C. |
| SS4A2 | PR2A | NR | Yes | SR9E | NP | NP | −20° C. to 15° C. | 20° C. to 65° C. |
| SS4B2 | PR2B | NR | Yes | SR9E | NP | NP | −20° C. to 15° C. | 20° C. to 65° C. |
| SS4C2 | PR2C | NR | Yes | SR9E | NP | NP | −20° C. to 15° C. | 20° C. to 65° C. |
| SS4A3 | PR3A | NR | Yes | SR9E | NP | NP | −20° C. to 15° C. | 20° C. to 65° C. |
| SS4B3 | PR3B | NR | Yes | SR9E | NP | NP | −20° C. to 15° C. | 20° C. to 65° C. |
| SS4C3 | PR3C | NR | Yes | SR9E | NP | NP | −20° C. to 15° C. | 20° C. to 65° C. |
| SS4A4 | PR4 | NR | Yes | SR9E | NP | NP | −20° C. to 15° C. | 20° C. to 65° C. |
| SS4A5 | PR5 | NR | Yes | SR9E | NP | NP | −20° C. to 15° C. | 20° C. to 65° C. |
| SS4A6 | PR6 | NR | Yes | SR9E | NP | NP | −20° C. to 15° C. | 20° C. to 65° C. |
| SS4A7 | PR7 | NR | Yes | SR9E | NP | NP | −20° C. to 15° C. | 20° C. to 65° C. |
| SS4A8 | PR1A | POE | Yes | SR9E | NP | NP | −20° C. to 15° C. | 20° C. to 65° C. |
| SS4B8 | PR1B | POE | Yes | SR9E | NP | NP | −20° C. to 15° C. | 20° C. to 65° C. |
| SS4C8 | PR1C | POE | Yes | SR9E | NP | NP | −20° C. to 15° C. | 20° C. to 65° C. |
| SS4A9 | PR2A | POE | Yes | SR9E | NP | NP | −20° C. to 15° C. | 20° C. to 65° C. |
| SS4B9 | PR2B | POE | Yes | SR9E | NP | NP | −20° C. to 15° C. | 20° C. to 65° C. |
| SS4C9 | PR2C | POE | Yes | SR9E | NP | NP | −20° C. to 15° C. | 20° C. to 65° C. |
| SS4A10 | PR3A | POE | Yes | SR9E | NP | NP | −20° C. to 15° C. | 20° C. to 65° C. |
| SS4B10 | PR3B | POE | Yes | SR9E | NP | NP | −20° C. to 15° C. | 20° C. to 65° C. |
| SS4C10 | PR3C | POE | Yes | SR9E | NP | NP | −20° C. to 15° C. | 20° C. to 65° C. |
| SS4A11 | PR4 | POE | Yes | SR9E | NP | NP | −20° C. to 15° C. | 20° C. to 65° C. |
| SS4A12 | PR5 | POE | Yes | SR9E | NP | NP | −20° C. to 15° C. | 20° C. to 65° C. |
| SS4A13 | PR6 | POE | Yes | SR9E | NP | NP | −20° C. to 15° C. | 20° C. to 65° C. |
| SS4A14 | PR7 | POE | Yes | SR9E | NP | NP | −20° C. to 15° C. | 20° C. to 65° C. |
| SS4A15 | PR1A | PVE | Yes | SR9E | NP | NP | −20° C. to 15° C. | 20° C. to 65° C. |
| SS4B15 | PR1B | PVE | Yes | SR9E | NP | NP | −20° C. to 15° C. | 20° C. to 65° C. |
| SS4C15 | PR1C | PVE | Yes | SR9E | NP | NP | −20° C. to 15° C. | 20° C. to 65° C. |
| SS4A16 | PR2A | PVE | Yes | SR9E | NP | NP | −20° C. to 15° C. | 20° C. to 65° C. |
| SS4B16 | PR2B | PVE | Yes | SR9E | NP | NP | −20° C. to 15° C. | 20° C. to 65° C. |
| SS4C16 | PR2C | PVE | Yes | SR9E | NP | NP | −20° C. to 15° C. | 20° C. to 65° C. |
| SS4A17 | PR3A | PVE | Yes | SR9E | NP | NP | −20° C. to 15° C. | 20° C. to 65° C. |
| SS4B17 | PR3B | PVE | Yes | SR9E | NP | NP | −20° C. to 15° C. | 20° C. to 65° C. |
| SS4C17 | PR3C | PVE | Yes | SR9E | NP | NP | −20° C. to 15° C. | 20° C. to 65° C. |
| SS4A19 | PR4 | PVE | Yes | SR9E | NP | NP | −20° C. to 15° C. | 20° C. to 65° C. |
| SS4A20 | PR5 | PVE | Yes | SR9E | NP | NP | −20° C. to 15° C. | 20° C. to 65° C. |
| SS4A21 | PR6 | PVE | Yes | SR9E | NP | NP | −20° C. to 15° C. | 20° C. to 65° C. |
| SS4A22 | PR7 | PVE | Yes | SR9E | NP | NP | −20° C. to 15° C. | 20° C. to 65° C. |
| SS5A1 | PR1A | NR | Yes | SR9F | NP | NP | −20° C. to 15° C. | 20° C. to 65° C. |
| SS5B1 | PR1B | NR | Yes | SR9F | NP | NP | −20° C. to 15° C. | 20° C. to 65° C. |
| SS5C1 | PR1C | NR | Yes | SR9F | NP | NP | −20° C. to 15° C. | 20° C. to 65° C. |
| SS5A2 | PR2A | NR | Yes | SR9F | NP | NP | −20° C. to 15° C. | 20° C. to 65° C. |
| SS5B2 | PR2B | NR | Yes | SR9F | NP | NP | −20° C. to 15° C. | 20° C. to 65° C. |
| SS5C2 | PR2C | NR | Yes | SR9F | NP | NP | −20° C. to 15° C. | 20° C. to 65° C. |
| SS5A3 | PR3A | NR | Yes | SR9F | NP | NP | −20° C. to 15° C. | 20° C. to 65° C. |
| SS5B3 | PR3B | NR | NR | SR9F | NP | NP | −20° C. to 15° C. | 20° C. to 65° C. |
| SS5C3 | PR3C | NR | NR | SR9F | NP | NP | −20° C. to 15° C. | 20° C. to 65° C. |
| SS5A4 | PR4 | NR | NR | SR9F | NP | NP | −20° C. to 15° C. | 20° C. to 65° C. |
| SS5A5 | PR5 | NR | NR | SR9F | NP | NP | −20° C. to 15° C. | 20° C. to 65° C. |
| SS5A6 | PR6 | NR | NR | SR9F | NP | NP | −20° C. to 15° C. | 20° C. to 65° C. |
| SS5A7 | PR7 | NR | NR | SR9F | NP | NP | −20° C. to 15° C. | 20° C. to 65° C. |
| SS5A8 | PR1A | POE | NR | SR9F | NP | NP | −20° C. to 15° C. | 20° C. to 65° C. |
| SS5B8 | PR1B | POE | NR | SR9F | NP | NP | −20° C. to 15° C. | 20° C. to 65° C. |
| SS5C8 | PR1C | POE | NR | SR9F | NP | NP | −20° C. to 15° C. | 20° C. to 65° C. |
| SS5A9 | PR2A | POE | NR | SR9F | NP | NP | −20° C. to 15° C. | 20° C. to 65° C. |
| SS5B9 | PR2B | POE | NR | SR9F | NP | NP | −20° C. to 15° C. | 20° C. to 65° C. |
| SS5C9 | PR2C | POE | NR | SR9F | NP | NP | −20° C. to 15° C. | 20° C. to 65° C. |
| SS5A10 | PR3A | POE | NR | SR9F | NP | NP | −20° C. to 15° C. | 20° C. to 65° C. |
| SS5B10 | PR3B | POE | NR | SR9F | NP | NP | −20° C. to 15° C. | 20° C. to 65° C. |
| SS5C10 | PR3C | POE | NR | SR9F | NP | NP | −20° C. to 15° C. | 20° C. to 65° C. |
| SS5A11 | PR4 | POE | NR | SR9F | NP | NP | −20° C. to 15° C. | 20° C. to 65° C. |
| SS5A12 | PR5 | POE | NR | SR9F | NP | NP | −20° C. to 15° C. | 20° C. to 65° C. |
| SS5A13 | PR6 | POE | NP | SR9F | NP | NP | −20° C. to 15° C. | 20° C. to 65° C. |
| SS5A14 | PR7 | POE | NR | SR9F | NP | NP | −20° C. to 15° C. | 20° C. to 65° C. |
| SS5A15 | PR1A | PVE | NR | SR9F | NP | NP | −20° C. to 15° C. | 20° C. to 65° C. |
| SS5B15 | PR1B | PVE | NR | SR9F | NP | NP | −20° C. to 15° C. | 20° C. to 65° C. |
| SS5C15 | PR1C | PVE | NR | SR9F | NP | NP | −20° C. to 15° C. | 20° C. to 65° C. |
| SS5A16 | PR2A | PVE | NR | SR9F | NP | NP | −20° C. to 15° C. | 20° C. to 65° C. |
| SS5B16 | PR2B | PVE | NR | SR9F | NP | NP | −20° C. to 15° C. | 20° C. to 65° C. |
| SS5C16 | PR2C | PVE | NR | SR9F | NP | NP | −20° C. to 15° C. | 20° C. to 65° C. |
| SS5A17 | PR3A | PVE | NR | SR9F | NP | NP | −20° C. to 15° C. | 20° C. to 65° C. |
| SS5B17 | PR3B | PVE | NR | SR9F | NP | NP | −20° C. to 15° C. | 20° C. to 65° C. |
| SS5C17 | PR3C | PVE | NR | SR9F | NP | NP | −20° C. to 15° C. | 20° C. to 65° C. |
| SS5A19 | PR4 | PVE | NR | SR9F | NP | NP | −20° C. to 15° C. | 20° C. to 65° C. |
| SS5A20 | PR5 | PVE | NR | SR9F | NP | NP | −20° C. to 15° C. | 20° C. to 65° C. |
| SS5A21 | PR6 | PVE | NR | SR9F | NP | NP | −20° C. to 15° C. | 20° C. to 65° C. |
| SS5A22 | PR7 | PVE | NR | SR9F | NP | NP | −20° C. to 15° C. | 20° C. to 65° C. |
| SS6A1 | PR1A | NR | NR | SR10G | NP | NP | −20° C. to 15° C. | 20° C. to 65° C. |
| SS6B1 | PR1B | NR | NR | SR10G | NP | NP | −20° C. to 15° C. | 20° C. to 65° C. |
| SS6C1 | PR1C | NR | NR | SR10G | NP | NP | −20° C. to 15° C. | 20° C. to 65° C. |
| SS6A2 | PR2A | NR | NR | SR10G | NP | NP | −20° C. to 15° C. | 20° C. to 65° C. |
| SS6B2 | PR2B | NR | NR | SR10G | NP | NP | −20° C. to 15° C. | 20° C. to 65° C. |
| SS36C2 | PR2C | NR | NR | SR10G | NP | NP | −20° C. to 15° C. | 20° C. to 65° C. |
| SS6A3 | PR3A | NR | NR | SR10G | NP | NP | −20° C. to 15° C. | 20° C. to 65° C. |
| SS6B3 | PR3B | NR | NR | SR10G | NP | NP | −20° C. to 15° C. | 20° C. to 65° C. |
| SS6C3 | PR3C | NR | NR | SR10G | NP | NP | −20° C. to 15° C. | 20° C. to 65° C. |
| SS6A4 | PR4 | NR | NR | SR10G | NP | NP | −20° C. to 15° C. | 20° C. to 65° C. |
| SS6A5 | PR5 | NR | NR | SR10G | NP | NP | −20° C. to 15° C. | 20° C. to 65° C. |
| SS6A6 | PR6 | NR | NR | SR10G | NP | NP | −20° C. to 15° C. | 20° C. to 65° C. |
| SS6A7 | PR7 | NR | NR | SR10G | NP | NP | −20° C. to 15° C. | 20° C. to 65° C. |
| SS6A8 | PR1A | POE | NR | SR10G | NP | NP | −20° C. to 15° C. | 20° C. to 65° C. |
| SS6B8 | PR1B | POE | NR | SR10G | NP | NP | −20° C. to 15° C. | 20° C. to 65° C. |
| SS6C8 | PR1C | POE | NR | SR10G | NP | NP | −20° C. to 15° C. | 20° C. to 65° C. |
| SS6A9 | PR2A | POE | NR | SR10G | NP | NP | −20° C. to 15° C. | 20° C. to 65° C. |
| SS6B9 | PR2B | POE | NR | SR10G | NP | NP | −20° C. to 15° C. | 20° C. to 65° C. |
| SS6C9 | PR2C | POE | NR | SR10G | NP | NP | −20° C. to 15° C. | 20° C. to 65° C. |
| SS6A10 | PR3A | POE | NR | SR10G | NP | NP | −20° C. to 15° C. | 20° C. to 65° C. |
| SS6B10 | PR3B | POE | NR | SR10G | NP | NP | −20° C. to 15° C. | 20° C. to 65° C. |
| SS6C10 | PR3C | POE | NR | SR10G | NP | NP | −20° C. to 15° C. | 20° C. to 65° C. |
| SS6A11 | PR4 | POE | NR | SR10G | NP | NP | −20° C. to 15° C. | 20° C. to 65° C. |
| SS6A12 | PR5 | POE | NR | SR10G | NP | NP | −20° C. to 15° C. | 20° C. to 65° C. |
| SS6A13 | PR6 | POE | NR | SR10G | NP | NP | −20° C. to 15° C. | 20° C. to 65° C. |
| SS6A14 | PR7 | POE | NR | SR10G | NP | NP | −20° C. to 15° C. | 20° C. to 65° C. |
| SS6A15 | PR1A | PVE | NR | SR10G | NP | NP | −20° C. to 15° C. | 20° C. to 65° C. |
| SS6B15 | PR1B | PVE | NR | SR10G | NP | NP | −20° C. to 15° C. | 20° C. to 65° C. |
| SS6C15 | PR1C | PVE | NR | SR10G | NP | NP | −20° C. to 15° C. | 20° C. to 65° C. |
| SS6A16 | PR2A | PVE | NR | SR10G | NP | NP | −20° C. to 15° C. | 20° C. to 65° C. |
| SS6B16 | PR2B | PVE | NR | SR10G | NP | NP | −20° C. to 15° C. | 20° C. to 65° C. |
| SS6C16 | PR2C | PVE | NR | SR10G | NP | NP | −20° C. to 15° C. | 20° C. to 65° C. |
| SS6A17 | PR3A | PVE | NR | SR10G | NP | NP | −20° C. to 15° C. | 20° C. to 65° C. |
| SS6B17 | PR3B | PVE | NR | SR10G | NP | NP | −20° C. to 15° C. | 20° C. to 65° C. |
| SS6C17 | PR3C | PVE | NR | SR10G | NP | NP | −20° C. to 15° C. | 20° C. to 65° C. |
| SS6A19 | PR4 | PVE | NR | SR10G | NP | NP | −20° C. to 15° C. | 20° C. to 65° C. |
| SS6A20 | PR5 | PVE | NR | SR10G | NP | NP | −20° C. to 15° C. | 20° C. to 65° C. |
| SS6A21 | PR6 | PVE | NR | SR10G | NP | NP | −20° C. to 15° C. | 20° C. to 65° C. |
| SS6A22 | PR7 | PVE | NR | SR10G | NP | NP | −20° C. to 15° C. | 20° C. to 65° C. |
| SS7A1 | PR1A | NR | Yes | SR10H | NP | NP | −20° C. to 15° C. | 20° C. to 65° C. |
| SS7B1 | PR1B | NR | Yes | SR10H | NP | NP | −20° C. to 15° C. | 20° C. to 65° C. |
| SS7C1 | PR1C | NR | Yes | SR10H | NP | NP | −20° C. to 15° C. | 20° C. to 65° C. |
| SS7A2 | PR2A | NR | Yes | SR10H | NP | NP | −20° C. to 15° C. | 20° C. to 65° C. |
| SS7B2 | PR2B | NR | Yes | SR10H | NP | NP | −20° C. to 15° C. | 20° C. to 65° C. |
| SS7C2 | PR2C | NR | Yes | SR10H | NP | NP | −20° C. to 15° C. | 20° C. to 65° C. |
| SS7A3 | PR3A | NR | Yes | SR10H | NP | NP | −20° C. to 15° C. | 20° C. to 65° C. |
| SS7B3 | PR3B | NR | Yes | SR10H | NP | NP | −20° C. to 15° C. | 20° C. to 65° C. |
| SS7C3 | PR3C | NR | Yes | SR10H | NP | NP | −20° C. to 15° C. | 20° C. to 65° C. |
| SS7A4 | PR4 | NR | Yes | SR10H | NP | NP | −20° C. to 15° C. | 20° C. to 65° C. |
| SS7A5 | PR5 | NR | Yes | SR10H | NP | NP | −20° C. to 15° C. | 20° C. to 65° C. |
| SS7A6 | PR6 | NR | Yes | SR10H | NP | NP | −20° C. to 15° C. | 20° C. to 65° C. |
| SS7A7 | PR7 | NR | Yes | SR10H | NP | NP | −20° C. to 15° C. | 20° C. to 65° C. |
| SS7A8 | PR1A | POE | Yes | SR10H | NP | NP | −20° C. to 15° C. | 20° C. to 65° C. |
| SS7B8 | PR1B | POE | Yes | SR10H | NP | NP | −20° C. to 15° C. | 20° C. to 65° C. |
| SS7C8 | PR1C | POE | Yes | SR10H | NP | NP | −20° C. to 15° C. | 20° C. to 65° C. |
| SS7A9 | PR2A | POE | Yes | SR10H | NP | NP | −20° C. to 15° C. | 20° C. to 65° C. |
| SS7B9 | PR2B | POE | Yes | SR10H | NP | NP | −20° C. to 15° C. | 20° C. to 65° C. |
| SS7C9 | PR2C | POE | Yes | SR10H | NP | NP | −20° C. to 15° C. | 20° C. to 65° C. |
| SS7A10 | PR3A | POE | Yes | SR10H | NP | NP | −20° C. to 15° C. | 20° C. to 65° C. |
| SS7B10 | PR3B | POE | Yes | SR10H | NP | NP | −20° C. to 15° C. | 20° C. to 65° C. |
| SS7C10 | PR3C | POE | Yes | SR10H | NP | NP | −20° C. to 15° C. | 20° C. to 65° C. |
| SS7A11 | PR4 | POE | Yes | SR10H | NP | NP | −20° C. to 15° C. | 20° C. to 65° C. |
| SS7A12 | PR5 | POE | Yes | SR10H | NP | NP | −20° C. to 15° C. | 20° C. to 65° C. |
| SS7A13 | PR6 | POE | Yes | SR10H | NP | NP | −20° C. to 15° C. | 20° C. to 65° C. |
| SS7A14 | PR7 | POE | Yes | SR10H | NP | NP | −20° C. to 15° C. | 20° C. to 65° C. |
| SS7A15 | PR1A | PVE | Yes | SR10H | NP | NP | −20° C. to 15° C. | 20° C. to 65° C. |
| SS7B15 | PR1B | PVE | Yes | SR10H | NP | NP | −20° C. to 15° C. | 20° C. to 65° C. |
| SS7C15 | PR1C | PVE | Yes | SR10H | NP | NP | −20° C. to 15° C. | 20° C. to 65° C. |
| SS7A16 | PR2A | PVE | Yes | SR10H | NP | NP | −20° C. to 15° C. | 20° C. to 65° C. |
| SS7B16 | PR2B | PVE | Yes | SR10H | NP | NP | −20° C. to 15° C. | 20° C. to 65° C. |
| SS7C16 | PR2C | PVE | Yes | SR10H | NP | NP | −20° C. to 15° C. | 20° C. to 65° C. |
| SS7A17 | PR3A | PVE | Yes | SR10H | NP | NP | −20° C. to 15° C. | 20° C. to 65° C. |
| SS7B17 | PR3B | PVE | Yes | SR10H | NP | NP | −20° C. to 15° C. | 20° C. to 65° C. |
| SS7C17 | PR3C | PVE | Yes | SR10H | NP | NP | −20° C. to 15° C. | 20° C. to 65° C. |
| SS7A19 | PR4 | PVE | Yes | SR10H | NP | NP | −20° C. to 15° C. | 20° C. to 65° C. |
| SS7A20 | PR5 | PVE | Yes | SR10H | NP | NP | −20° C. to 15° C. | 20° C. to 65° C. |
| SS7A21 | PR6 | PVE | Yes | SR10H | NP | NP | −20° C. to 15° C. | 20° C. to 65° C. |
| SS7A22 | PR7 | PVE | Yes | SR10H | NP | NP | −20° C. to 15° C. | 20° C. to 65° C. |
| SS8A1 | PR1A | NR | Yes | SR10I | NP | NP | −20° C. to 15° C. | 20° C. to 65° C. |
| SS8B1 | PR1B | NR | Yes | SR10I | NP | NP | −20° C. to 15° C. | 20° C. to 65° C. |
| SS8C1 | PR1C | NR | Yes | SR10I | NP | NP | −20° C. to 15° C. | 20° C. to 65° C. |
| SS8A2 | PR2A | NR | Yes | SR10I | NP | NP | −20° C. to 15° C. | 20° C. to 65° C. |
| SS8B2 | PR2B | NR | Yes | SR10I | NP | NP | −20° C. to 15° C. | 20° C. to 65° C. |
| SS8C2 | PR2C | NR | Yes | SR10I | NP | NP | −20° C. to 15° C. | 20° C. to 65° C. |
| SS8A3 | PR3A | NR | Yes | SR10I | NP | NP | −20° C. to 15° C. | 20° C. to 65° C. |
| SS8B3 | PR3B | NR | NR | SR10I | NP | NP | −20° C. to 15° C. | 20° C. to 65° C. |
| SS8C3 | PR3C | NR | NR | SR10I | NP | NP | −20° C. to 15° C. | 20° C. to 65° C. |
| SS8A4 | PR4 | NR | NR | SR10I | NP | NP | −20° C. to 15° C. | 20° C. to 65° C. |
| SS8A5 | PR5 | NR | NR | SR10I | NP | NP | −20° C. to 15° C. | 20° C. to 65° C. |
| SS8A6 | PR6 | NR | NR | SR10I | NP | NP | −20° C. to 15° C. | 20° C. to 65° C. |
| SS8A7 | PR7 | NR | NR | SR10I | NP | NP | −20° C. to 15° C. | 20° C. to 65° C. |
| SS8A8 | PR1A | POE | NR | SR10I | NP | NP | −20° C. to 15° C. | 20° C. to 65° C. |
| SS8B8 | PR1B | POE | NR | SR10I | NP | NP | −20° C. to 15° C. | 20° C. to 65° C. |
| SS8C8 | PR1C | POE | NR | SR10I | NP | NP | −20° C. to 15° C. | 20° C. to 65° C. |
| SS8A9 | PR2A | POE | NR | SR10I | NP | NP | −20° C. to 15° C. | 20° C. to 65° C. |
| SS8B9 | PR2B | POE | NR | SR10I | NP | NP | −20° C. to 15° C. | 20° C. to 65° C. |
| SS8C9 | PR2C | POE | NR | SR10I | NP | NP | −20° C. to 15° C. | 20° C. to 65° C. |
| SS8A10 | PR3A | POE | NR | SR10I | NP | NP | −20° C. to 15° C. | 20° C. to 65° C. |
| SS8B10 | PR3B | POE | NR | SR10I | NP | NP | −20° C. to 15° C. | 20° C. to 65° C. |
| SS8C10 | PR3C | POE | NR | SR10I | NP | NP | −20° C. to 15° C. | 20° C. to 65° C. |
| SS8A11 | PR4 | POE | NR | SR10I | NP | NP | −20° C. to 15° C. | 20° C. to 65° C. |
| SS8A12 | PR5 | POE | NR | SR10I | NP | NP | −20° C. to 15° C. | 20° C. to 65° C. |
| SS8A13 | PR6 | POE | NR | SR10I | NP | NP | −20° C. to 15° C. | 20° C. to 65° C. |
| SS8A14 | PR7 | POE | NR | SR10I | NP | NP | −20° C. to 15° C. | 20° C. to 65° C. |
| SS8A15 | PR1A | PVE | NR | SR10I | NP | NP | −20° C. to 15° C. | 20° C. to 65° C. |
| SS8B15 | PR1B | PVE | NR | SR10I | NP | NP | −20° C. to 15° C. | 20° C. to 65° C. |
| SS8C15 | PR1C | PVE | NR | SR10I | NP | NP | −20° C. to 15° C. | 20° C. to 65° C. |
| SS8A16 | PR2A | PVE | NR | SR10I | NP | NP | −20° C. to 15° C. | 20° C. to 65° C. |
| SS8B16 | PR2B | PVE | NR | SR10I | NP | NP | −20° C. to 15° C. | 20° C. to 65° C. |
| SS8C16 | PR2C | PVE | NR | SR10I | NP | NP | −20° C. to 15° C. | 20° C. to 65° C. |
| SS8A17 | PR3A | PVE | NR | SR10I | NP | NP | −20° C. to 15° C. | 20° C. to 65° C. |
| SS8B17 | PR3B | PVE | NR | SR10I | NP | NP | −20° C. to 15° C. | 20° C. to 65° C. |
| SS8C17 | PR3C | PVE | NR | SR10I | NP | NP | −20° C. to 15° C. | 20° C. to 65° C. |
| SS8A19 | PR4 | PVE | NR | SR10I | NP | NP | −20° C. to 15° C. | 20° C. to 65° C. |
| SS8A20 | PR5 | PVE | NR | SR10I | NP | NP | −20° C. to 15° C. | 20° C. to 65° C. |
| SS8A21 | PR6 | PVE | NR | SR10I | NP | NP | −20° C. to 15° C. | 20° C. to 65° C. |
| SS8A22 | PR7 | PVE | NR | SR10I | NP | NP | −20° C. to 15° C. | 20° C. to 65° C. |
| SS9A1 | PR1A | NR | NR | SR11G | NP | NP | −20° C. to 15° C. | 20° C. to 65° C. |
| SS9B1 | PR1B | NR | NR | SR11G | NP | NP | −20° C. to 15° C. | 20° C. to 65° C. |
| SS9C1 | PR1C | NR | NR | SR11G | NP | NP | −20° C. to 15° C. | 20° C. to 65° C. |
| SS9A2 | PR2A | NR | NR | SR11G | NP | NP | −20° C. to 15° C. | 20° C. to 65° C. |
| SS9B2 | PR2B | NR | NR | SR11G | NP | NP | −20° C. to 15° C. | 20° C. to 65° C. |
| SS9C2 | PR2C | NR | NR | SR11G | NP | NP | −20° C. to 15° C. | 20° C. to 65° C. |
| SS9A3 | PR3A | NR | NR | SR11G | NP | NP | −20° C. to 15° C. | 20° C. to 65° C. |
| SS9B3 | PR3B | NR | NR | SR11G | NP | NP | −20° C. to 15° C. | 20° C. to 65° C. |
| SS9C3 | PR3C | NR | NR | SR11G | NP | NP | −20° C. to 15° C. | 20° C. to 65° C. |
| SS9A4 | PR4 | NR | NR | SR11G | NP | NP | −20° C. to 15° C. | 20° C. to 65° C. |
| SS9A5 | PR5 | NR | NR | SR11G | NP | NP | −20° C. to 15° C. | 20° C. to 65° C. |
| SS9A6 | PR6 | NR | NR | SR11G | NP | NP | −20° C. to 15° C. | 20° C. to 65° C. |
| SS9A7 | PR7 | NR | NR | SR11G | NP | NP | −20° C. to 15° C. | 20° C. to 65° C. |
| SS9A8 | PR1A | POE | NR | SR11G | NP | NP | −20° C. to 15° C. | 20° C. to 65° C. |
| SS9B8 | PR1B | POE | NR | SR11G | NP | NP | −20° C. to 15° C. | 20° C. to 65° C. |
| SS9C8 | PR1C | POE | NR | SR11G | NP | NP | −20° C. to 15° C. | 20° C. to 65° C. |
| SS9A9 | PR2A | POE | NR | SR11G | NP | NP | −20° C. to 15° C. | 20° C. to 65° C. |
| SS9B9 | PR2B | POE | NR | SR11G | NP | NP | −20° C. to 15° C. | 20° C. to 65° C. |
| SS9C9 | PR2C | POE | NR | SR11G | NP | NP | −20° C. to 15° C. | 20° C. to 65° C. |
| SS9A10 | PR3A | POE | NR | SR11G | NP | NP | −20° C. to 15° C. | 20° C. to 65° C. |
| SS9B10 | PR3B | POE | NR | SR11G | NP | NP | −20° C. to 15° C. | 20° C. to 65° C. |
| SS9C10 | PR3C | POE | NR | SR11G | NP | NP | −20° C. to 15° C. | 20° C. to 65° C. |
| SS9A11 | PR4 | POE | NR | SR11G | NP | NP | −20° C. to 15° C. | 20° C. to 65° C. |
| SS9A12 | PR5 | POE | NR | SR11G | NP | NP | −20° C. to 15° C. | 20° C. to 65° C. |
| SS9A13 | PR6 | POE | NR | SR11G | NP | NP | −20° C. to 15° C. | 20° C. to 65° C. |
| SS9A14 | PR7 | POE | NR | SR11G | NP | NP | −20° C. to 15° C. | 20° C. to 65° C. |
| SS9A15 | PR1A | PVE | NR | SR11G | NP | NP | −20° C. to 15° C. | 20° C. to 65° C. |
| SS9B15 | PR1B | PVE | NR | SR11G | NP | NP | −20° C. to 15° C. | 20° C. to 65° C. |
| SS9C15 | PR1C | PVE | NR | SR11G | NP | NP | −20° C. to 15° C. | 20° C. to 65° C. |
| SS9A16 | PR2A | PVE | NR | SR11G | NP | NP | −20° C. to 15° C. | 20° C. to 65° C. |
| SS9B16 | PR2B | PVE | NR | SR11G | NP | NP | −20° C. to 15° C. | 20° C. to 65° C. |
| SS9C16 | PR2C | PVE | NR | SR11G | NP | NP | −20° C. to 15° C. | 20° C. to 65° C. |
| SS9A17 | PR3A | PVE | NR | SR11G | NP | NP | −20° C. to 15° C. | 20° C. to 65° C. |
| SS9B17 | PR3B | PVE | NR | SR11G | NP | NP | −20° C. to 15° C. | 20° C. to 65° C. |
| SS9C17 | PR3C | PVE | NR | SR11G | NP | NP | −20° C. to 15° C. | 20° C. to 65° C. |
| SS9A19 | PR4 | PVE | NR | SR11G | NP | NP | −20° C. to 15° C. | 20° C. to 65° C. |
| SS9A20 | PR5 | PVE | NR | SR11G | NP | NP | −20° C. to 15° C. | 20° C. to 65° C. |
| SS9A21 | PR6 | PVE | NR | SR11G | NP | NP | −20° C. to 15° C. | 20° C. to 65° C. |
| SS9A22 | PR7 | PVE | NR | SR11G | NP | NP | −20° C. to 15° C. | 20° C. to 65° C. |
| SS10A1 | PR1A | NR | Yes | SR11I | NP | NP | −20° C. to 15° C. | 20° C. to 65° C. |
| SS10B1 | PR1B | NR | Yes | SR11I | NP | NP | −20° C. to 15° C. | 20° C. to 65° C. |
| SS10C1 | PR1C | NR | Yes | SR11I | NP | NP | −20° C. to 15° C. | 20° C. to 65° C. |
| SS10A2 | PR2A | NR | Yes | SR11I | NP | NP | −20° C. to 15° C. | 20° C. to 65° C. |
| SS10B2 | PR2B | NR | Yes | SR11I | NP | NP | −20° C. to 15° C. | 20° C. to 65° C. |
| SS10C2 | PR2C | NR | Yes | SR11I | NP | NP | −20° C. to 15° C. | 20° C. to 65° C. |
| SS10A3 | PR3A | NR | Yes | SR11I | NP | NP | −20° C. to 15° C. | 20° C. to 65° C. |
| SS10B3 | PR3B | NR | Yes | SR11I | NP | NP | −20° C. to 15° C. | 20° C. to 65° C. |
| SS10C3 | PR3C | NR | Yes | SR11I | NP | NP | −20° C. to 15° C. | 20° C. to 65° C. |
| SS10A4 | PR4 | NR | Yes | SR11I | NP | NP | −20° C. to 15° C. | 20° C. to 65° C. |
| SS10A5 | PR5 | NR | Yes | SR11I | NP | NP | −20° C. to 15° C. | 20° C. to 65° C. |
| SS10A6 | PR6 | NR | Yes | SR11I | NP | NP | −20° C. to 15° C. | 20° C. to 65° C. |
| SS10A7 | PR7 | NR | Yes | SR11I | NP | NP | −20° C. to 15° C. | 20° C. to 65° C. |
| SS10A8 | PR1A | POE | Yes | SR11I | NP | NP | −20° C. to 15° C. | 20° C. to 65° C. |
| SS10B8 | PR1B | POE | Yes | SR11I | NP | NP | −20° C. to 15° C. | 20° C. to 65° C. |
| SS10C8 | PR1C | POE | Yes | SR11I | NP | NP | −20° C. to 15° C. | 20° C. to 65° C. |
| SS10A9 | PR2A | POE | Yes | SR11I | NP | NP | −20° C. to 15° C. | 20° C. to 65° C. |
| SS10B9 | PR2B | POE | Yes | SR11I | NP | NP | −20° C. to 15° C. | 20° C. to 65° C. |
| SS10C9 | PR2C | POE | Yes | SR11I | NP | NP | −20° C. to 15° C. | 20° C. to 65° C. |
| SS10A10 | PR3A | POE | Yes | SR11I | NP | NP | −20° C. to 15° C. | 20° C. to 65° C. |
| SS10B10 | PR3B | POE | Yes | SR11I | NP | NP | −20° C. to 15° C. | 20° C. to 65° C. |
| SS10C10 | PR3C | POE | Yes | SR11I | NP | NP | −20° C. to 15° C. | 20° C. to 65° C. |
| SS10A11 | PR4 | POE | Yes | SR11I | NP | NP | −20° C. to 15° C. | 20° C. to 65° C. |
| SS10A12 | PR5 | POE | Yes | SR11I | NP | NP | −20° C. to 15° C. | 20° C. to 65° C. |
| SS10A13 | PR6 | POE | Yes | SR11I | NP | NP | −20° C. to 15° C. | 20° C. to 65° C. |
| SS10A14 | PR7 | POE | Yes | SR11I | NP | NP | −20° C. to 15° C. | 20° C. to 65° C. |
| SS10A15 | PR1A | PVE | Yes | SR11I | NP | NP | −20° C. to 15° C. | 20° C. to 65° C. |
| SS10B15 | PR1B | PVE | Yes | SR11I | NP | NP | −20° C. to 15° C. | 20° C. to 65° C. |
| SS10C15 | PR1C | PVE | Yes | SR11I | NP | NP | −20° C. to 15° C. | 20° C. to 65° C. |
| SS10A16 | PR2A | PVE | Yes | SR11I | NP | NP | −20° C. to 15° C. | 20° C. to 65° C. |
| SS10B16 | PR2B | PVE | Yes | SR11I | NP | NP | −20° C. to 15° C. | 20° C. to 65° C. |
| SS10C16 | PR2C | PVE | Yes | SR11I | NP | NP | −20° C. to 15° C. | 20° C. to 65° C. |
| SS10A17 | PR3A | PVE | Yes | SR11I | NP | NP | −20° C. to 15° C. | 20° C. to 65° C. |
| SS10B17 | PR3B | PVE | Yes | SR11I | NP | NP | −20° C. to 15° C. | 20° C. to 65° C. |
| SS10C17 | PR3C | PVE | Yes | SR11I | NP | NP | −20° C. to 15° C. | 20° C. to 65° C. |
| SS10A19 | PR4 | PVE | Yes | SR11I | NP | NP | −20° C. to 15° C. | 20° C. to 65° C. |
| SS10A20 | PR5 | PVE | Yes | SR11I | NP | NP | −20° C. to 15° C. | 20° C. to 65° C. |
| SS10A21 | PR6 | PVE | Yes | SR11I | NP | NP | −20° C. to 15° C. | 20° C. to 65° C. |
| SS10A22 | PR7 | PVE | Yes | SR11I | NP | NP | −20° C. to 15° C. | 20° C. to 65° C. |
| SS11A1 | PR1A | NR | Yes | SR12G | NP | NP | −20° C. to 15° C. | 20° C. to 65° C. |
| SS11B1 | PR1B | NR | Yes | SR12G | NP | NP | −20° C. to 15° C. | 20° C. to 65° C. |
| SS11C1 | PR1C | NR | Yes | SR12G | NP | NP | −20° C. to 15° C. | 20° C. to 65° C. |
| SS11A2 | PR2A | NR | Yes | SR12G | NP | NP | −20° C. to 15° C. | 20° C. to 65° C. |
| SS11B2 | PR2B | NR | Yes | SR12G | NP | NP | −20° C. to 15° C. | 20° C. to 65° C. |
| SS11C2 | PR2C | NR | Yes | SR12G | NP | NP | −20° C. to 15° C. | 20° C. to 65° C. |
| SS11A3 | PR3A | NR | Yes | SR12G | NP | NP | −20° C. to 15° C. | 20° C. to 65° C. |
| SS11B3 | PR3B | NR | NR | SR12G | NP | NP | −20° C. to 15° C. | 20° C. to 65° C. |
| SS11C3 | PR3C | NR | NR | SR12G | NP | NP | −20° C. to 15° C. | 20° C. to 65° C. |
| SS11A4 | PR4 | NR | NR | SR12G | NP | NP | −20° C. to 15° C. | 20° C. to 65° C. |
| SS11A5 | PR5 | NR | NR | SR12G | NP | NP | −20° C. to 15° C. | 20° C. to 65° C. |
| SS11A6 | PR6 | NR | NR | SR12G | NP | NP | −20° C. to 15° C. | 20° C. to 65° C. |
| SS11A7 | PR7 | NR | NR | SR12G | NP | NP | −20° C. to 15° C. | 20° C. to 65° C. |
| SS11A8 | PR1A | POE | NR | SR12G | NP | NP | −20° C. to 15° C. | 20° C. to 65° C. |
| SS11B8 | PR1B | POE | NR | SR12G | NP | NP | −20° C. to 15° C. | 20° C. to 65° C. |
| SS11C8 | PR1C | POE | NR | SR12G | NP | NP | −20° C. to 15° C. | 20° C. to 65° C. |
| SS11A9 | PR2A | POE | NR | SR12G | NP | NP | −20° C. to 15° C. | 20° C. to 65° C. |
| SS11B9 | PR2B | POE | NR | SR12G | NP | NP | −20° C. to 15° C. | 20° C. to 65° C. |
| SS11C9 | PR2C | POE | NR | SR12G | NP | NP | −20° C. to 15° C. | 20° C. to 65° C. |
| SS11A10 | PR3A | POE | NR | SR12G | NP | NP | −20° C. to 15° C. | 20° C. to 65° C. |
| SS11B10 | PR3B | POE | NR | SR12G | NP | NP | −20° C. to 15° C. | 20° C. to 65° C. |
| SS11C10 | PR3C | POE | NR | SR12G | NP | NP | −20° C. to 15° C. | 20° C. to 65° C. |
| SS11A11 | PR4 | POE | NR | SR12G | NP | NP | −20° C. to 15° C. | 20° C. to 65° C. |
| SS11A12 | PR5 | POE | NR | SR12G | NP | NP | −20° C. to 15° C. | 20° C. to 65° C. |
| SS11A13 | PR6 | POE | NR | SR12G | NP | NP | −20° C. to 15° C. | 20° C. to 65° C. |
| SS11A14 | PR7 | POE | NR | SR12G | NP | NP | −20° C. to 15° C. | 20° C. to 65° C. |
| SS11A15 | PR1A | PVE | NR | SR12G | NP | NP | −20° C. to 15° C. | 20° C. to 65° C. |
| SS11B15 | PR1B | PVE | NR | SR12G | NP | NP | −20° C. to 15° C. | 20° C. to 65° C. |
| SS11C15 | PR1C | PVE | NR | SR12G | NP | NP | −20° C. to 15° C. | 20° C. to 65° C. |
| SS11A16 | PR2A | PVE | NR | SR12G | NP | NP | −20° C. to 15° C. | 20° C. to 65° C. |
| SS11B16 | PR2B | PVE | NR | SR12G | NP | NP | −20° C. to 15° C. | 20° C. to 65° C. |
| SS11C16 | PR2C | PVE | NR | SR12G | NP | NP | −20° C. to 15° C. | 20° C. to 65° C. |
| SS11A17 | PR3A | PVE | NR | SR12G | NP | NP | −20° C. to 15° C. | 20° C. to 65° C. |
| SS11B17 | PR3B | PVE | NR | SR12G | NP | NP | −20° C. to 15° C. | 20° C. to 65° C. |
| SS11C17 | PR3C | PVE | NR | SR12G | NP | NP | −20° C. to 15° C. | 20° C. to 65° C. |
| SS11A19 | PR4 | PVE | NR | SR12G | NP | NP | −20° C. to 15° C. | 20° C. to 65° C. |
| SS11A20 | PR5 | PVE | NR | SR12G | NP | NP | −20° C. to 15° C. | 20° C. to 65° C. |
| SS11A21 | PR6 | PVE | NR | SR12G | NP | NP | −20° C. to 15° C. | 20° C. to 65° C. |
| SS11A22 | PR7 | PVE | NR | SR12G | NP | NP | −20° C. to 15° C. | 20° C. to 65° C. |
| SS12A1 | PR1A | NR | NR | SR12H | NP | NP | −20° C. to 15° C. | 20° C. to 65° C. |
| SS12B1 | PR1B | NR | NR | SR12H | NP | NP | −20° C. to 15° C. | 20° C. to 65° C. |
| SS12C1 | PR1C | NR | NR | SR12H | NP | NP | −20° C. to 15° C. | 20° C. to 65° C. |
| SS12A2 | PR2A | NR | NR | SR12H | NP | NP | −20° C. to 15° C. | 20° C. to 65° C. |
| SS12B2 | PR2B | NR | NR | SR12H | NP | NP | −20° C. to 15° C. | 20° C. to 65° C. |
| SS12C2 | PR2C | NR | NR | SR12H | NP | NP | −20° C. to 15° C. | 20° C. to 65° C. |
| SS12A3 | PR3A | NR | NR | SR12H | NP | NP | −20° C. to 15° C. | 20° C. to 65° C. |
| SS12B3 | PR3B | NR | NR | SR12H | NP | NP | −20° C. to 15° C. | 20° C. to 65° C. |
| SS12C3 | PR3C | NR | NR | SR12H | NP | NP | −20° C. to 15° C. | 20° C. to 65° C. |
| SS12A4 | PR4 | NR | NR | SR12H | NP | NP | −20° C. to 15° C. | 20° C. to 65° C. |
| SS12A5 | PR5 | NR | NR | SR12H | NP | NP | −20° C. to 15° C. | 20° C. to 65° C. |
| SS12A6 | PR6 | NR | NR | SR12H | NP | NP | −20° C. to 15° C. | 20° C. to 65° C. |
| SS12A7 | PR7 | NR | NR | SR12H | NP | NP | −20° C. to 15° C. | 20° C. to 65° C. |
| SS12A8 | PR1A | POE | NR | SR12H | NP | NP | −20° C. to 15° C. | 20° C. to 65° C. |
| SS12B8 | PR1B | POE | NR | SR12H | NP | NP | −20° C. to 15° C. | 20° C. to 65° C. |
| SS12C8 | PR1C | POE | NR | SR12H | NP | NP | −20° C. to 15° C. | 20° C. to 65° C. |
| SS12A9 | PR2A | POE | NR | SR12H | NP | NP | −20° C. to 15° C. | 20° C. to 65° C. |
| SS12B9 | PR2B | POE | NR | SR12H | NP | NP | −20° C. to 15° C. | 20° C. to 65° C. |
| SS12C9 | PR2C | POE | NR | SR12H | NP | NP | −20° C. to 15° C. | 20° C. to 65° C. |
| SS12A10 | PR3A | POE | NR | SR12H | NP | NP | −20° C. to 15° C. | 20° C. to 65° C. |
| SS12B10 | PR3B | POE | NR | SR12H | NP | NP | −20° C. to 15° C. | 20° C. to 65° C. |
| SS12C10 | PR3C | POE | NR | SR12H | NP | NP | −20° C. to 15° C. | 20° C. to 65° C. |
| SS12A11 | PR4 | POE | NR | SR12H | NP | NP | −20° C. to 15° C. | 20° C. to 65° C. |
| SS12A12 | PR5 | POE | NR | SR12H | NP | NP | −20° C. to 15° C. | 20° C. to 65° C. |
| SS12A13 | PR6 | POE | NR | SR12H | NP | NP | −20° C. to 15° C. | 20° C. to 65° C. |
| SS12A14 | PR7 | POE | NR | SR12H | NP | NP | −20° C. to 15° C. | 20° C. to 65° C. |
| SS12A15 | PR1A | PVE | NR | SR12H | NP | NP | −20° C. to 15° C. | 20° C. to 65° C. |
| SS12B15 | PR1B | PVE | NR | SR12H | NP | NP | −20° C. to 15° C. | 20° C. to 65° C. |
| SS12C15 | PR1C | PVE | NR | SR12H | NP | NP | −20° C. to 15° C. | 20° C. to 65° C. |
| SS12A16 | PR2A | PVE | NR | SR12H | NP | NP | −20° C. to 15° C. | 20° C. to 65° C. |
| SS12B16 | PR2B | PVE | NR | SR12H | NP | NP | −20° C. to 15° C. | 20° C. to 65° C. |
| SS12C16 | PR2C | PVE | NR | SR12H | NP | NP | −20° C. to 15° C. | 20° C. to 65° C. |
| SS12A17 | PR3A | PVE | NR | SR12H | NP | NP | −20° C. to 15° C. | 20° C. to 65° C. |
| SS12B17 | PR3B | PVE | NR | SR12H | NP | NP | −20° C. to 15° C. | 20° C. to 65° C. |
| SS12C17 | PR3C | PVE | NR | SR12H | NP | NP | −20° C. to 15° C. | 20° C. to 65° C. |
| SS12A19 | PR4 | PVE | NR | SR12H | NP | NP | −20° C. to 15° C. | 20° C. to 65° C. |
| SS12A20 | PR5 | PVE | NR | SR12H | NP | NP | −20° C. to 15° C. | 20° C. to 65° C. |
| SS12A21 | PR6 | PVE | NR | SR12H | NP | NP | −20° C. to 15° C. | 20° C. to 65° C. |
| SS12A22 | PR7 | PVE | NR | SR12H | NP | NP | −20° C. to 15° C. | 20° C. to 65° C. |
| SS13A1 | PR1A | NR | Yes | SR12I | NP | NP | −20° C. to 15° C. | 20° C. to 65° C. |
| SS13B1 | PR1B | NR | Yes | SR12I | NP | NP | −20° C. to 15° C. | 20° C. to 65° C. |
| SS13C1 | PR1C | NR | Yes | SR12I | NP | NP | −20° C. to 15° C. | 20° C. to 65° C. |
| SS13A2 | PR2A | NR | Yes | SR12I | NP | NP | −20° C. to 15° C. | 20° C. to 65° C. |
| SS13B2 | PR2B | NR | Yes | SR12I | NP | NP | −20° C. to 15° C. | 20° C. to 65° C. |
| SS13C2 | PR2C | NR | Yes | SR12I | NP | NP | −20° C. to 15° C. | 20° C. to 65° C. |
| SS13A3 | PR3A | NR | Yes | SR12I | NP | NP | −20° C. to 15° C. | 20° C. to 65° C. |
| SS13B3 | PR3B | NR | Yes | SR12I | NP | NP | −20° C. to 15° C. | 20° C. to 65° C. |
| SS13C3 | PR3C | NR | Yes | SR12I | NP | NP | −20° C. to 15° C. | 20° C. to 65° C. |
| SS13A4 | PR4 | NR | Yes | SR12I | NP | NP | −20° C. to 15° C. | 20° C. to 65° C. |
| SS13A5 | PR5 | NR | Yes | SR12I | NP | NP | −20° C. to 15° C. | 20° C. to 65° C. |
| SS13A6 | PR6 | NR | Yes | SR12I | NP | NP | −20° C. to 15° C. | 20° C. to 65° C. |
| SS13A7 | PR7 | NR | Yes | SR12I | NP | NP | −20° C. to 15° C. | 20° C. to 65° C. |
| SS13A8 | PR1A | POE | Yes | SR12I | NP | NP | −20° C. to 15° C. | 20° C. to 65° C. |
| SS13B8 | PR1B | POE | Yes | SR12I | NP | NP | −20° C. to 15° C. | 20° C. to 65° C. |
| SS13C8 | PR1C | POE | Yes | SR12I | NP | NP | −20° C. to 15° C. | 20° C. to 65° C. |
| SS13A9 | PR2A | POE | Yes | SR12I | NP | NP | −20° C. to 15° C. | 20° C. to 65° C. |
| SS13B9 | PR2B | POE | Yes | SR12I | NP | NP | −20° C. to 15° C. | 20° C. to 65° C. |
| SS13C9 | PR2C | POE | Yes | SR12I | NP | NP | −20° C. to 15° C. | 20° C. to 65° C. |
| SS13A10 | PR3A | POE | Yes | SR12I | NP | NP | −20° C. to 15° C. | 20° C. to 65° C. |
| SS13B10 | PR3B | POE | Yes | SR12I | NP | NP | −20° C. to 15° C. | 20° C. to 65° C. |
| SS13C10 | PR3C | POE | Yes | SR12I | NP | NP | −20° C. to 15° C. | 20° C. to 65° C. |
| SS13A11 | PR4 | POE | Yes | SR12I | NP | NP | −20° C. to 15° C. | 20° C. to 65° C. |
| SS13A12 | PR5 | POE | Yes | SR12I | NP | NP | −20° C. to 15° C. | 20° C. to 65° C. |
| SS13A13 | PR6 | POE | Yes | SR12I | NP | NP | −20° C. to 15° C. | 20° C. to 65° C. |
| SS13A14 | PR7 | POE | Yes | SR12I | NP | NP | −20° C. to 15° C. | 20° C. to 65° C. |
| SS13A15 | PR1A | PVE | Yes | SR12I | NP | NP | −20° C. to 15° C. | 20° C. to 65° C. |
| SS13B15 | PR1B | PVE | Yes | SR12I | NP | NP | −20° C. to 15° C. | 20° C. to 65° C. |
| SS13C15 | PR1C | PVE | Yes | SR12I | NP | NP | −20° C. to 15° C. | 20° C. to 65° C. |
| SS13A16 | PR2A | PVE | Yes | SR12I | NP | NP | −20° C. to 15° C. | 20° C. to 65° C. |
| SS13B16 | PR2B | PVE | Yes | SR12I | NP | NP | −20° C. to 15° C. | 20° C. to 65° C. |
| SS13C16 | PR2C | PVE | Yes | SR12I | NP | NP | −20° C. to 15° C. | 20° C. to 65° C. |
| SS13A17 | PR3A | PVE | Yes | SR12I | NP | NP | −20° C. to 15° C. | 20° C. to 65° C. |
| SS13B17 | PR3B | PVE | Yes | SR12I | NP | NP | −20° C. to 15° C. | 20° C. to 65° C. |
| SS13C17 | PR3C | PVE | Yes | SR12I | NP | NP | −20° C. to 15° C. | 20° C. to 65° C. |
| SS13A19 | PR4 | PVE | Yes | SR12I | NP | NP | −20° C. to 15° C. | 20° C. to 65° C. |
| SS13A20 | PR5 | PVE | Yes | SR12I | NP | NP | −20° C. to 15° C. | 20° C. to 65° C. |
| SS13A21 | PR6 | PVE | Yes | SR12I | NP | NP | −20° C. to 15° C. | 20° C. to 65° C. |
| SS13A22 | PR7 | PVE | Yes | SR12I | NP | NP | −20° C. to 15° C. | 20° C. to 65° C. |
| SS14A1 | PR1A | NR | Yes | SR13G | NP | NP | −20° C. to 15° C. | 20° C. to 65° C. |
| SS14B1 | PR1B | NR | Yes | SR13G | NP | NP | −20° C. to 15° C. | 20° C. to 65° C. |
| SS14C1 | PR1C | NR | Yes | SR13G | NP | NP | −20° C. to 15° C. | 20° C. to 65° C. |
| SS14A2 | PR2A | NR | Yes | SR13G | NP | NP | −20° C. to 15° C. | 20° C. to 65° C. |
| SS14B2 | PR2B | NR | Yes | SR13G | NP | NP | −20° C. to 15° C. | 20° C. to 65° C. |
| SS14C2 | PR2C | NR | Yes | SR13G | NP | NP | −20° C. to 15° C. | 20° C. to 65° C. |
| SS14A3 | PR3A | NR | Yes | SR13G | NP | NP | −20° C. to 15° C. | 20° C. to 65° C. |
| SS14B3 | PR3B | NR | NR | SR13G | NP | NP | −20° C. to 15° C. | 20° C. to 65° C. |
| SS14C3 | PR3C | NR | NR | SR13G | NP | NP | −20° C. to 15° C. | 20° C. to 65° C. |
| SS14A4 | PR4 | NR | NR | SR13G | NP | NP | −20° C. to 15° C. | 20° C. to 65° C. |
| SS14A5 | PR5 | NR | NR | SR13G | NP | NP | −20° C. to 15° C. | 20° C. to 65° C. |
| SS14A6 | PR6 | NR | NR | SR13G | NP | NP | −20° C. to 15° C. | 20° C. to 65° C. |
| SS14A7 | PR7 | NR | NR | SR13G | NP | NP | −20° C. to 15° C. | 20° C. to 65° C. |
| SS14A8 | PR1A | POE | NR | SR13G | NP | NP | −20° C. to 15° C. | 20° C. to 65° C. |
| SS14B8 | PR1B | POE | NR | SR13G | NP | NP | −20° C. to 15° C. | 20° C. to 65° C. |
| SS14C8 | PR1C | POE | NR | SR13G | NP | NP | −20° C. to 15° C. | 20° C. to 65° C. |
| SS14A9 | PR2A | POE | NR | SR13G | NP | NP | −20° C. to 15° C. | 20° C. to 65° C. |
| SS14B9 | PR2B | POE | NR | SR13G | NP | NP | −20° C. to 15° C. | 20° C. to 65° C. |
| SS14C9 | PR2C | POE | NR | SR13G | NP | NP | −20° C. to 15° C. | 20° C. to 65° C. |
| SS14A10 | PR3A | POE | NR | SR13G | NP | NP | −20° C. to 15° C. | 20° C. to 65° C. |
| SS14B10 | PR3B | POE | NR | SR13G | NP | NP | −20° C. to 15° C. | 20° C. to 65° C. |
| SS14C10 | PR3C | POE | NR | SR13G | NP | NP | −20° C. to 15° C. | 20° C. to 65° C. |
| SS14A11 | PR4 | POE | NR | SR13G | NP | NP | −20° C. to 15° C. | 20° C. to 65° C. |
| SS14A12 | PR5 | POE | NR | SR13G | NP | NP | −20° C. to 15° C. | 20° C. to 65° C. |
| SS14A13 | PR6 | POE | NR | SR13G | NP | NP | −20° C. to 15° C. | 20° C. to 65° C. |
| SS14A14 | PR7 | POE | NR | SR13G | NP | NP | −20° C. to 15° C. | 20° C. to 65° C. |
| SS14A15 | PR1A | PVE | NR | SR13G | NP | NP | −20° C. to 15° C. | 20° C. to 65° C. |
| SS14B15 | PR1B | PVE | NR | SR13G | NP | NP | −20° C. to 15° C. | 20° C. to 65° C. |
| SS14C15 | PR1C | PVE | NR | SR13G | NP | NP | −20° C. to 15° C. | 20° C. to 65° C. |
| SS14A16 | PR2A | PVE | NR | SR13G | NP | NP | −20° C. to 15° C. | 20° C. to 65° C. |
| SS14B16 | PR2B | PVE | NR | SR13G | NP | NP | −20° C. to 15° C. | 20° C. to 65° C. |
| SS14C16 | PR2C | PVE | NR | SR13G | NP | NP | −20° C. to 15° C. | 20° C. to 65° C. |
| SS14A17 | PR3A | PVE | NR | SR13G | NP | NP | −20° C. to 15° C. | 20° C. to 65° C. |
| SS14B17 | PR3B | PVE | NR | SR13G | NP | NP | −20° C. to 15° C. | 20° C. to 65° C. |
| SS14C17 | PR3C | PVE | NR | SR13G | NP | NP | −20° C. to 15° C. | 20° C. to 65° C. |
| SS14A19 | PR4 | PVE | NR | SR13G | NP | NP | −20° C. to 15° C. | 20° C. to 65° C. |
| SS14A20 | PR5 | PVE | NR | SR13G | NP | NP | −20° C. to 15° C. | 20° C. to 65° C. |
| SS14A21 | PR6 | PVE | NR | SR13G | NP | NP | −20° C. to 15° C. | 20° C. to 65° C. |
| SS14A22 | PR7 | PVE | NR | SR13G | NP | NP | −20° C. to 15° C. | 20° C. to 65° C. |
| SS15A1 | PR1A | NR | NR | SR13I | NP | NP | −20° C. to 15° C. | 20° C. to 65° C. |
| SS15B1 | PR1B | NR | NR | SR13I | NP | NP | −20° C. to 15° C. | 20° C. to 65° C. |
| SS15C1 | PR1C | NR | NR | SR13I | NP | NP | −20° C. to 15° C. | 20° C. to 65° C. |
| SS15A2 | PR2A | NR | NR | SR13I | NP | NP | −20° C. to 15° C. | 20° C. to 65° C. |
| SS15B2 | PR2B | NR | NR | SR13I | NP | NP | −20° C. to 15° C. | 20° C. to 65° C. |
| SS15C2 | PR2C | NR | NR | SR13I | NP | NP | −20° C. to 15° C. | 20° C. to 65° C. |
| SS15A3 | PR3A | NR | NR | SR13I | NP | NP | −20° C. to 15° C. | 20° C. to 65° C. |
| SS15B3 | PR3B | NR | NR | SR13I | NP | NP | −20° C. to 15° C. | 20° C. to 65° C. |
| SS15C3 | PR3C | NR | NR | SR13I | NP | NP | −20° C. to 15° C. | 20° C. to 65° C. |
| SS15A4 | PR4 | NR | NR | SR13I | NP | NP | −20° C. to 15° C. | 20° C. to 65° C. |
| SS15A5 | PR5 | NR | NR | SR13I | NP | NP | −20° C. to 15° C. | 20° C. to 65° C. |
| SS15A6 | PR6 | NR | NR | SR13I | NP | NP | −20° C. to 15° C. | 20° C. to 65° C. |
| SS15A7 | PR7 | NR | NR | SR13I | NP | NP | −20° C. to 15° C. | 20° C. to 65° C. |
| SS15A8 | PR1A | POE | NR | SR13I | NP | NP | −20° C. to 15° C. | 20° C. to 65° C. |
| SS15B8 | PR1B | POE | NR | SR13I | NP | NP | −20° C. to 15° C. | 20° C. to 65° C. |
| SS15C8 | PR1C | POE | NR | SR13I | NP | NP | −20° C. to 15° C. | 20° C. to 65° C. |
| SS15A9 | PR2A | POE | NR | SR13I | NP | NP | −20° C. to 15° C. | 20° C. to 65° C. |
| SS15B9 | PR2B | POE | NR | SR13I | NP | NP | −20° C. to 15° C. | 20° C. to 65° C. |
| SS15C9 | PR2C | POE | NR | SR13I | NP | NP | −20° C. to 15° C. | 20° C. to 65° C. |
| SS15A10 | PR3A | POE | NR | SR13I | NP | NP | −20° C. to 15° C. | 20° C. to 65° C. |
| SS15B10 | PR3B | POE | NR | SR13I | NP | NP | −20° C. to 15° C. | 20° C. to 65° C. |
| SS15C10 | PR3C | POE | NR | SR13I | NP | NP | −20° C. to 15° C. | 20° C. to 65° C. |
| SS15A11 | PR4 | POE | NR | SR13I | NP | NP | −20° C. to 15° C. | 20° C. to 65° C. |
| SS15A12 | PR5 | POE | NR | SR13I | NP | NP | −20° C. to 15° C. | 20° C. to 65° C. |
| SS15A13 | PR6 | POE | NR | SR13I | NP | NP | −20° C. to 15° C. | 20° C. to 65° C. |
| SS15A14 | PR7 | POE | NR | SR13I | NP | NP | −20° C. to 15° C. | 20° C. to 65° C. |
| SS15A15 | PR1A | PVE | NR | SR13I | NP | NP | −20° C. to 15° C. | 20° C. to 65° C. |
| SS15B15 | PR1B | PVE | NR | SR13I | NP | NP | −20° C. to 15° C. | 20° C. to 65° C. |
| SS15C15 | PR1C | PVE | NR | SR13I | NP | NP | −20° C. to 15° C. | 20° C. to 65° C. |
| SS15A16 | PR2A | PVE | NR | SR13I | NP | NP | −20° C. to 15° C. | 20° C. to 65° C. |
| SS15B16 | PR2B | PVE | NR | SR13I | NP | NP | −20° C. to 15° C. | 20° C. to 65° C. |
| SS15C16 | PR2C | PVE | NR | SR13I | NP | NP | −20° C. to 15° C. | 20° C. to 65° C. |
| SS15A17 | PR3A | PVE | NR | SR13I | NP | NP | −20° C. to 15° C. | 20° C. to 65° C. |
| SS15B17 | PR3B | PVE | NR | SR13I | NP | NP | −20° C. to 15° C. | 20° C. to 65° C. |
| SS15C17 | PR3C | PVE | NR | SR13I | NP | NP | −20° C. to 15° C. | 20° C. to 65° C. |
| SS15A19 | PR4 | PVE | NR | SR13I | NP | NP | −20° C. to 15° C. | 20° C. to 65° C. |
| SS15A20 | PR5 | PVE | NR | SR13I | NP | NP | −20° C. to 15° C. | 20° C. to 65° C. |
| SS15A21 | PR6 | PVE | NR | SR13I | NP | NP | −20° C. to 15° C. | 20° C. to 65° C. |
| SS15A22 | PR7 | PVE | NR | SR13I | NP | NP | −20° C. to 15° C. | 20° C. to 65° C. |
| SS16A1 | PR1A | NR | Yes | SR14G | NP | NP | −20° C. to 15° C. | 20° C. to 65° C. |
| SS16B1 | PR1B | NR | Yes | SR14G | NP | NP | −20° C. to 15° C. | 20° C. to 65° C. |
| SS16C1 | PR1C | NR | Yes | SR14G | NP | NP | −20° C. to 15° C. | 20° C. to 65° C. |
| SS16A2 | PR2A | NR | Yes | SR14G | NP | NP | −20° C. to 15° C. | 20° C. to 65° C. |
| SS16B2 | PR2B | NR | Yes | SR14G | NP | NP | −20° C. to 15° C. | 20° C. to 65° C. |
| SS16C2 | PR2C | NR | Yes | SR14G | NP | NP | −20° C. to 15° C. | 20° C. to 65° C. |
| SS16A3 | PR3A | NR | Yes | SR14G | NP | NP | −20° C. to 15° C. | 20° C. to 65° C. |
| SS16B3 | PR3B | NR | Yes | SR14G | NP | NP | −20° C. to 15° C. | 20° C. to 65° C. |
| SS16C3 | PR3C | NR | Yes | SR14G | NP | NP | −20° C. to 15° C. | 20° C. to 65° C. |
| SS16A4 | PR4 | NR | Yes | SR14G | NP | NP | −20° C. to 15° C. | 20° C. to 65° C. |
| SS16A5 | PR5 | NR | Yes | SR14G | NP | NP | −20° C. to 15° C. | 20° C. to 65° C. |
| SS16A6 | PR6 | NR | Yes | SR14G | NP | NP | −20° C. to 15° C. | 20° C. to 65° C. |
| SS16A7 | PR7 | NR | Yes | SR14G | NP | NP | −20° C. to 15° C. | 20° C. to 65° C. |
| SS16A8 | PR1A | POE | Yes | SR14G | NP | NP | −20° C. to 15° C. | 20° C. to 65° C. |
| SS16B8 | PR1B | POE | Yes | SR14G | NP | NP | −20° C. to 15° C. | 20° C. to 65° C. |
| SS16C8 | PR1C | POE | Yes | SR14G | NP | NP | −20° C. to 15° C. | 20° C. to 65° C. |
| SS16A9 | PR2A | POE | Yes | SR14G | NP | NP | −20° C. to 15° C. | 20° C. to 65° C. |
| SS16B9 | PR2B | POE | Yes | SR14G | NP | NP | −20° C. to 15° C. | 20° C. to 65° C. |
| SS16C9 | PR2C | POE | Yes | SR14G | NP | NP | −20° C. to 15° C. | 20° C. to 65° C. |
| SS16A10 | PR3A | POE | Yes | SR14G | NP | NP | −20° C. to 15° C. | 20° C. to 65° C. |
| SS16B10 | PR3B | POE | Yes | SR14G | NP | NP | −20° C. to 15° C. | 20° C. to 65° C. |
| SS16C10 | PR3C | POE | Yes | SR14G | NP | NP | −20° C. to 15° C. | 20° C. to 65° C. |
| SS16A11 | PR4 | POE | Yes | SR14G | NP | NP | −20° C. to 15° C. | 20° C. to 65° C. |
| SS16A12 | PR5 | POE | Yes | SR14G | NP | NP | −20° C. to 15° C. | 20° C. to 65° C. |
| SS16A13 | PR6 | POE | Yes | SR14G | NP | NP | −20° C. to 15° C. | 20° C. to 65° C. |
| SS16A14 | PR7 | POE | Yes | SR14G | NP | NP | −20° C. to 15° C. | 20° C. to 65° C. |
| SS16A15 | PR1A | PVE | Yes | SR14G | NP | NP | −20° C. to 15° C. | 20° C. to 65° C. |
| SS16B15 | PR1B | PVE | Yes | SR14G | NP | NP | −20° C. to 15° C. | 20° C. to 65° C. |
| SS16C15 | PR1C | PVE | Yes | SR14G | NP | NP | −20° C. to 15° C. | 20° C. to 65° C. |
| SS16A16 | PR2A | PVE | Yes | SR14G | NP | NP | −20° C. to 15° C. | 20° C. to 65° C. |
| SS16B16 | PR2B | PVE | Yes | SR14G | NP | NP | −20° C. to 15° C. | 20° C. to 65° C. |
| SS16C16 | PR2C | PVE | Yes | SR14G | NP | NP | −20° C. to 15° C. | 20° C. to 65° C. |
| SS16A17 | PR3A | PVE | Yes | SR14G | NP | NP | −20° C. to 15° C. | 20° C. to 65° C. |
| SS16B17 | PR3B | PVE | Yes | SR14G | NP | NP | −20° C. to 15° C. | 20° C. to 65° C. |
| SS16C17 | PR3C | PVE | Yes | SR14G | NP | NP | −20° C. to 15° C. | 20° C. to 65° C. |
| SS16A19 | PR4 | PVE | Yes | SR14G | NP | NP | −20° C. to 15° C. | 20° C. to 65° C. |
| SS16A20 | PR5 | PVE | Yes | SR14G | NP | NP | −20° C. to 15° C. | 20° C. to 65° C. |
| SS16A21 | PR6 | PVE | Yes | SR14G | NP | NP | −20° C. to 15° C. | 20° C. to 65° C. |
| SS16A22 | PR7 | PVE | Yes | SR14G | NP | NP | −20° C. to 15° C. | 20° C. to 65° C. |
| SS17A1 | PR1A | NR | Yes | SR14H | NP | NP | −20° C. to 15° C. | 20° C. to 65° C. |
| SS17B1 | PR1B | NR | Yes | SR14H | NP | NP | −20° C. to 15° C. | 20° C. to 65° C. |
| SS17C1 | PR1C | NR | Yes | SR14H | NP | NP | −20° C. to 15° C. | 20° C. to 65° C. |
| SS17A2 | PR2A | NR | Yes | SR14H | NP | NP | −20° C. to 15° C. | 20° C. to 65° C. |
| SS17B2 | PR2B | NR | Yes | SR14H | NP | NP | −20° C. to 15° C. | 20° C. to 65° C. |
| SS17C2 | PR2C | NR | Yes | SR14H | NP | NP | −20° C. to 15° C. | 20° C. to 65° C. |
| SS17A3 | PR3A | NR | Yes | SR14H | NP | NP | −20° C. to 15° C. | 20° C. to 65° C. |
| SS17B3 | PR3B | NR | NR | SR14H | NP | NP | −20° C. to 15° C. | 20° C. to 65° C. |
| SS17C3 | PR3C | NR | NR | SR14H | NP | NP | −20° C. to 15° C. | 20° C. to 65° C. |
| SS17A4 | PR4 | NR | NR | SR14H | NP | NP | −20° C. to 15° C. | 20° C. to 65° C. |
| SS17A5 | PR5 | NR | NR | SR14H | NP | NP | −20° C. to 15° C. | 20° C. to 65° C. |
| SS17A6 | PR6 | NR | NR | SR14H | NP | NP | −20° C. to 15° C. | 20° C. to 65° C. |
| SS17A7 | PR7 | NR | NR | SR14H | NP | NP | −20° C. to 15° C. | 20° C. to 65° C. |
| SS17A8 | PR1A | POE | NR | SR14H | NP | NP | −20° C. to 15° C. | 20° C. to 65° C. |
| SS17B8 | PR1B | POE | NR | SR14H | NP | NP | −20° C. to 15° C. | 20° C. to 65° C. |
| SS17C8 | PR1C | POE | NR | SR14H | NP | NP | −20° C. to 15° C. | 20° C. to 65° C. |
| SS17A9 | PR2A | POE | NR | SR14H | NP | NP | −20° C. to 15° C. | 20° C. to 65° C. |
| SS17B9 | PR2B | POE | NR | SR14H | NP | NP | −20° C. to 15° C. | 20° C. to 65° C. |
| SS17C9 | PR2C | POE | NR | SR14H | NP | NP | −20° C. to 15° C. | 20° C. to 65° C. |
| SS17A10 | PR3A | POE | NR | SR14H | NP | NP | −20° C. to 15° C. | 20° C. to 65° C. |
| SS17B10 | PR3B | POE | NR | SR14H | NP | NP | −20° C. to 15° C. | 20° C. to 65° C. |
| SS17C10 | PR3C | POE | NR | SR14H | NP | NP | −20° C. to 15° C. | 20° C. to 65° C. |
| SS17A11 | PR4 | POE | NR | SR14H | NP | NP | −20° C. to 15° C. | 20° C. to 65° C. |
| SS17A12 | PR5 | POE | NR | SR14H | NP | NP | −20° C. to 15° C. | 20° C. to 65° C. |
| SS17A13 | PR6 | POE | NR | SR14H | NP | NP | −20° C. to 15° C. | 20° C. to 65° C. |
| SS17A14 | PR7 | POE | NR | SR14H | NP | NP | −20° C. to 15° C. | 20° C. to 65° C. |
| SS17A15 | PR1A | PVE | NR | SR14H | NP | NP | −20° C. to 15° C. | 20° C. to 65° C. |
| SS17B15 | PR1B | PVE | NR | SR14H | NP | NP | −20° C. to 15° C. | 20° C. to 65° C. |
| SS17C15 | PR1C | PVE | NR | SR14H | NP | NP | −20° C. to 15° C. | 20° C. to 65° C. |
| SS17A16 | PR2A | PVE | NR | SR14H | NP | NP | −20° C. to 15° C. | 20° C. to 65° C. |
| SS17B16 | PR2B | PVE | NR | SR14H | NP | NP | −20° C. to 15° C. | 20° C. to 65° C. |
| SS17C16 | PR2C | PVE | NR | SR14H | NP | NP | −20° C. to 15° C. | 20° C. to 65° C. |
| SS17A17 | PR3A | PVE | NR | SR14H | NP | NP | −20° C. to 15° C. | 20° C. to 65° C. |
| SS17B17 | PR3B | PVE | NR | SR14H | NP | NP | −20° C. to 15° C. | 20° C. to 65° C. |
| SS17C17 | PR3C | PVE | NR | SR14H | NP | NP | −20° C. to 15° C. | 20° C. to 65° C. |
| SS17A19 | PR4 | PVE | NR | SR14H | NP | NP | −20° C. to 15° C. | 20° C. to 65° C. |
| SS17A20 | PR5 | PVE | NR | SR14H | NP | NP | −20° C. to 15° C. | 20° C. to 65° C. |
| SS17A21 | PR6 | PVE | NR | SR14H | NP | NP | −20° C. to 15° C. | 20° C. to 65° C. |
| SS17A22 | PR7 | PVE | NR | SR14H | NP | NP | −20° C. to 15° C. | 20° C. to 65° C. |
| SS18A1 | PR1A | NR | NR | SR14I | NP | NP | −20° C. to 15° C. | 20° C. to 65° C. |
| SS18B1 | PR1B | NR | NR | SR14I | NP | NP | −20° C. to 15° C. | 20° C. to 65° C. |
| SS18C1 | PR1C | NR | NR | SR14I | NP | NP | −20° C. to 15° C. | 20° C. to 65° C. |
| SS18A2 | PR2A | NR | NR | SR14I | NP | NP | −20° C. to 15° C. | 20° C. to 65° C. |
| SS18B2 | PR2B | NR | NR | SR14I | NP | NP | −20° C. to 15° C. | 20° C. to 65° C. |
| SS18C2 | PR2C | NR | NR | SR14I | NP | NP | −20° C. to 15° C. | 20° C. to 65° C. |
| SS18A3 | PR3A | NR | NR | SR14I | NP | NP | −20° C. to 15° C. | 20° C. to 65° C. |
| SS18B3 | PR3B | NR | NR | SR14I | NP | NP | −20° C. to 15° C. | 20° C. to 65° C. |
| SS18C3 | PR3C | NR | NR | SR14I | NP | NP | −20° C. to 15° C. | 20° C. to 65° C. |
| SS18A4 | PR4 | NR | NR | SR14I | NP | NP | −20° C. to 15° C. | 20° C. to 65° C. |
| SS18A5 | PR5 | NR | NR | SR14I | NP | NP | −20° C. to 15° C. | 20° C. to 65° C. |
| SS18A6 | PR6 | NR | NR | SR14I | NP | NP | −20° C. to 15° C. | 20° C. to 65° C. |
| SS18A7 | PR7 | NR | NR | SR14I | NP | NP | −20° C. to 15° C. | 20° C. to 65° C. |
| SS18A8 | PR1A | POE | NR | SR14I | NP | NP | −20° C. to 15° C. | 20° C. to 65° C. |
| SS18B8 | PR1B | POE | NR | SR14I | NP | NP | −20° C. to 15° C. | 20° C. to 65° C. |
| SS18C8 | PR1C | POE | NR | SR14I | NP | NP | −20° C. to 15° C. | 20° C. to 65° C. |
| SS18A9 | PR2A | POE | NR | SR14I | NP | NP | −20° C. to 15° C. | 20° C. to 65° C. |
| SS18B9 | PR2B | POE | NR | SR14I | NP | NP | −20° C. to 15° C. | 20° C. to 65° C. |
| SS18C9 | PR2C | POE | NR | SR14I | NP | NP | −20° C. to 15° C. | 20° C. to 65° C. |
| SS18A10 | PR3A | POE | NR | SR14I | NP | NP | −20° C. to 15° C. | 20° C. to 65° C. |
| SS18B10 | PR3B | POE | NR | SR14I | NP | NP | −20° C. to 15° C. | 20° C. to 65° C. |
| SS18C10 | PR3C | POE | NR | SR14I | NP | NP | −20° C. to 15° C. | 20° C. to 65° C. |
| SS18A11 | PR4 | POE | NR | SR14I | NP | NP | −20° C. to 15° C. | 20° C. to 65° C. |
| SS18A12 | PR5 | POE | NR | SR14I | NP | NP | −20° C. to 15° C. | 20° C. to 65° C. |
| SS18A13 | PR6 | POE | NR | SR14I | NP | NP | −20° C. to 15° C. | 20° C. to 65° C. |
| SS18A14 | PR7 | POE | NR | SR14I | NP | NP | −20° C. to 15° C. | 20° C. to 65° C. |
| SS18A15 | PR1A | PVE | NR | SR14I | NP | NP | −20° C. to 15° C. | 20° C. to 65° C. |
| SS18B15 | PR1B | PVE | NR | SR14I | NP | NP | −20° C. to 15° C. | 20° C. to 65° C. |
| SS18C15 | PR1C | PVE | NR | SR14I | NP | NP | −20° C. to 15° C. | 20° C. to 65° C. |
| SS18A16 | PR2A | PVE | NR | SR14I | NP | NP | −20° C. to 15° C. | 20° C. to 65° C. |
| SS18B16 | PR2B | PVE | NR | SR14I | NP | NP | −20° C. to 15° C. | 20° C. to 65° C. |
| SS18C16 | PR2C | PVE | NR | SR14I | NP | NP | −20° C. to 15° C. | 20° C. to 65° C. |
| SS18A17 | PR3A | PVE | NR | SR14I | NP | NP | −20° C. to 15° C. | 20° C. to 65° C. |
| SS18B17 | PR3B | PVE | NR | SR14I | NP | NP | −20° C. to 15° C. | 20° C. to 65° C. |
| SS18C17 | PR3C | PVE | NR | SR14I | NP | NP | −20° C. to 15° C. | 20° C. to 65° C. |
| SS18A19 | PR4 | PVE | NR | SR14I | NP | NP | −20° C. to 15° C. | 20° C. to 65° C. |
| SS18A20 | PR5 | PVE | NR | SR14I | NP | NP | −20° C. to 15° C. | 20° C. to 65° C. |
| SS18A21 | PR6 | PVE | NR | SR14I | NP | NP | −20° C. to 15° C. | 20° C. to 65° C. |
| SS18A22 | PR7 | PVE | NR | SR14I | NP | NP | −20° C. to 15° C. | 20° C. to 65° C. |
| SS19A1 | PR1A | NR | Yes | SR10F | NP | NP | −20° C. to 15° C. | 20° C. to 65° C. |
| SS19B1 | PR1B | NR | Yes | SR10F | NP | NP | −20° C. to 15° C. | 20° C. to 65° C. |
| SS19C1 | PR1C | NR | Yes | SR10F | NP | NP | −20° C. to 15° C. | 20° C. to 65° C. |
| SS19A2 | PR2A | NR | Yes | SR10F | NP | NP | −20° C. to 15° C. | 20° C. to 65° C. |
| SS19B2 | PR2B | NR | Yes | SR10F | NP | NP | −20° C. to 15° C. | 20° C. to 65° C. |
| SS19C2 | PR2C | NR | Yes | SR10F | NP | NP | −20° C. to 15° C. | 20° C. to 65° C. |
| SS19A3 | PR3A | NR | Yes | SR10F | NP | NP | −20° C. to 15° C. | 20° C. to 65° C. |
| SS19B3 | PR3B | NR | Yes | SR10F | NP | NP | −20° C. to 15° C. | 20° C. to 65° C. |
| SS19C3 | PR3C | NR | Yes | SR10F | NP | NP | −20° C. to 15° C. | 20° C. to 65° C. |
| SS19A4 | PR4 | NR | Yes | SR10F | NP | NP | −20° C. to 15° C. | 20° C. to 65° C. |
| SS19A5 | PR5 | NR | Yes | SR10F | NP | NP | −20° C. to 15° C. | 20° C. to 65° C. |
| SS19A6 | PR6 | NR | Yes | SR10F | NP | NP | −20° C. to 15° C. | 20° C. to 65° C. |
| SS19A7 | PR7 | NR | Yes | SR10F | NP | NP | −20° C. to 15° C. | 20° C. to 65° C. |
| SS19A8 | PR1A | POE | Yes | SR10F | NP | NP | −20° C. to 15° C. | 20° C. to 65° C. |
| SS19B8 | PR1B | POE | Yes | SR10F | NP | NP | −20° C. to 15° C. | 20° C. to 65° C. |
| SS19C8 | PR1C | POE | Yes | SR10F | NP | NP | −20° C. to 15° C. | 20° C. to 65° C. |
| SS19A9 | PR2A | POE | Yes | SR10F | NP | NP | −20° C. to 15° C. | 20° C. to 65° C. |
| SS19B9 | PR2B | POE | Yes | SR10F | NP | NP | −20° C. to 15° C. | 20° C. to 65° C. |
| SS19C9 | PR2C | POE | Yes | SR10F | NP | NP | −20° C. to 15° C. | 20° C. to 65° C. |
| SS19A10 | PR3A | POE | Yes | SR10F | NP | NP | −20° C. to 15° C. | 20° C. to 65° C. |
| SS19B10 | PR3B | POE | Yes | SR10F | NP | NP | −20° C. to 15° C. | 20° C. to 65° C. |
| SS19C10 | PR3C | POE | Yes | SR10F | NP | NP | −20° C. to 15° C. | 20° C. to 65° C. |
| SS19A11 | PR4 | POE | Yes | SR10F | NP | NP | −20° C. to 15° C. | 20° C. to 65° C. |
| SS19A12 | PR5 | POE | Yes | SR10F | NP | NP | −20° C. to 15° C. | 20° C. to 65° C. |
| SS19A13 | PR6 | POE | Yes | SR10F | NP | NP | −20° C. to 15° C. | 20° C. to 65° C. |
| SS19A14 | PR7 | POE | Yes | SR10F | NP | NP | −20° C. to 15° C. | 20° C. to 65° C. |
| SS19A15 | PR1A | PVE | Yes | SR10F | NP | NP | −20° C. to 15° C. | 20° C. to 65° C. |
| SS19B15 | PR1B | PVE | Yes | SR10F | NP | NP | −20° C. to 15° C. | 20° C. to 65° C. |
| SS19C15 | PR1C | PVE | Yes | SR10F | NP | NP | −20° C. to 15° C. | 20° C. to 65° C. |
| SS19A16 | PR2A | PVE | Yes | SR10F | NP | NP | −20° C. to 15° C. | 20° C. to 65° C. |
| SS19B16 | PR2B | PVE | Yes | SR10F | NP | NP | −20° C. to 15° C. | 20° C. to 65° C. |
| SS19C16 | PR2C | PVE | Yes | SR10F | NP | NP | −20° C. to 15° C. | 20° C. to 65° C. |
| SS19A17 | PR3A | PVE | Yes | SR10F | NP | NP | −20° C. to 15° C. | 20° C. to 65° C. |
| SS19B17 | PR3B | PVE | Yes | SR10F | NP | NP | −20° C. to 15° C. | 20° C. to 65° C. |
| SS19C17 | PR3C | PVE | Yes | SR10F | NP | NP | −20° C. to 15° C. | 20° C. to 65° C. |
| SS19A19 | PR4 | PVE | Yes | SR10F | NP | NP | −20° C. to 15° C. | 20° C. to 65° C. |
| SS19A20 | PR5 | PVE | Yes | SR10F | NP | NP | −20° C. to 15° C. | 20° C. to 65° C. |
| SS19A21 | PR6 | PVE | Yes | SR10F | NP | NP | −20° C. to 15° C. | 20° C. to 65° C. |
| SS19A22 | PR7 | PVE | Yes | SR10F | NP | NP | −20° C. to 15° C. | 20° C. to 65° C. |
| SS20A1 | PR1A | NR | Yes | SR11F | NP | NP | −20° C. to 15° C. | 20° C. to 65° C. |
| SS20B1 | PR1B | NR | Yes | SR11F | NP | NP | −20° C. to 15° C. | 20° C. to 65° C. |
| SS20C1 | PR1C | NR | Yes | SR11F | NP | NP | −20° C. to 15° C. | 20° C. to 65° C. |
| SS20A2 | PR2A | NR | Yes | SR11F | NP | NP | −20° C. to 15° C. | 20° C. to 65° C. |
| SS20B2 | PR2B | NR | Yes | SR11F | NP | NP | −20° C. to 15° C. | 20° C. to 65° C. |
| SS20C2 | PR2C | NR | Yes | SR11F | NP | NP | −20° C. to 15° C. | 20° C. to 65° C. |
| SS20A3 | PR3A | NR | Yes | SR11F | NP | NP | −20° C. to 15° C. | 20° C. to 65° C. |
| SS20B3 | PR3B | NR | NR | SR11F | NP | NP | −20° C. to 15° C. | 20° C. to 65° C. |
| SS20C3 | PR3C | NR | NR | SR11F | NP | NP | −20° C. to 15° C. | 20° C. to 65° C. |
| SS20A4 | PR4 | NR | NR | SR11F | NP | NP | −20° C. to 15° C. | 20° C. to 65° C. |
| SS20A5 | PR5 | NR | NR | SR11F | NP | NP | −20° C. to 15° C. | 20° C. to 65° C. |
| SS20A6 | PR6 | NR | NR | SR11F | NP | NP | −20° C. to 15° C. | 20° C. to 65° C. |
| SS20A7 | PR7 | NR | NR | SR11F | NP | NP | −20° C. to 15° C. | 20° C. to 65° C. |
| SS20A8 | PR1A | POE | NR | SR11F | NP | NP | −20° C. to 15° C. | 20° C. to 65° C. |
| SS20B8 | PR1B | POE | NR | SR11F | NP | NP | −20° C. to 15° C. | 20° C. to 65° C. |
| SS20C8 | PR1C | POE | NR | SR11F | NP | NP | −20° C. to 15° C. | 20° C. to 65° C. |
| SS20A9 | PR2A | POE | NR | SR11F | NP | NP | −20° C. to 15° C. | 20° C. to 65° C. |
| SS20B9 | PR2B | POE | NR | SR11F | NP | NP | −20° C. to 15° C. | 20° C. to 65° C. |
| SS20C9 | PR2C | POE | NR | SR11F | NP | NP | −20° C. to 15° C. | 20° C. to 65° C. |
| SS20A10 | PR3A | POE | NR | SR11F | NP | NP | −20° C. to 15° C. | 20° C. to 65° C. |
| SS20B10 | PR3B | POE | NR | SR11F | NP | NP | −20° C. to 15° C. | 20° C. to 65° C. |
| SS20C10 | PR3C | POE | NR | SR11F | NP | NP | −20° C. to 15° C. | 20° C. to 65° C. |
| SS20A11 | PR4 | POE | NR | SR11F | NP | NP | −20° C. to 15° C. | 20° C. to 65° C. |
| SS20A12 | PR5 | POE | NR | SR11F | NP | NP | −20° C. to 15° C. | 20° C. to 65° C. |
| SS20A13 | PR6 | POE | NR | SR11F | NP | NP | −20° C. to 15° C. | 20° C. to 65° C. |
| SS20A14 | PR7 | POE | NR | SR11F | NP | NP | −20° C. to 15° C. | 20° C. to 65° C. |
| SS20A15 | PR1A | PVE | NR | SR11F | NP | NP | −20° C. to 15° C. | 20° C. to 65° C. |
| SS20B15 | PR1B | PVE | NR | SR11F | NP | NP | −20° C. to 15° C. | 20° C. to 65° C. |
| SS20C15 | PR1C | PVE | NR | SR11F | NP | NP | −20° C. to 15° C. | 20° C. to 65° C. |
| SS20A16 | PR2A | PVE | NR | SR11F | NP | NP | −20° C. to 15° C. | 20° C. to 65° C. |
| SS20B16 | PR2B | PVE | NR | SR11F | NP | NP | −20° C. to 15° C. | 20° C. to 65° C. |
| SS20C16 | PR2C | PVE | NR | SR11F | NP | NP | −20° C. to 15° C. | 20° C. to 65° C. |
| SS20A17 | PR3A | PVE | NR | SR11F | NP | NP | −20° C. to 15° C. | 20° C. to 65° C. |
| SS20B17 | PR3B | PVE | NR | SR11F | NP | NP | −20° C. to 15° C. | 20° C. to 65° C. |
| SS20C17 | PR3C | PVE | NR | SR11F | NP | NP | −20° C. to 15° C. | 20° C. to 65° C. |
| SS20A19 | PR4 | PVE | NR | SR11F | NP | NP | −20° C. to 15° C. | 20° C. to 65° C. |
| SS20A20 | PR5 | PVE | NR | SR11F | NP | NP | −20° C. to 15° C. | 20° C. to 65° C. |
| SS20A21 | PR6 | PVE | NR | SR11F | NP | NP | −20° C. to 15° C. | 20° C. to 65° C. |
| SS20A22 | PR7 | PVE | NR | SR11F | NP | NP | −20° C. to 15° C. | 20° C. to 65° C. |
| SS21A1 | PR1A | NR | NR | SR12F | NP | NP | −20° C. to 15° C. | 20° C. to 65° C. |
| SS21B1 | PR1B | NR | NR | SR12F | NP | NP | −20° C. to 15° C. | 20° C. to 65° C. |
| SS21C1 | PR1C | NR | NR | SR12F | NP | NP | −20° C. to 15° C. | 20° C. to 65° C. |
| SS21A2 | PR2A | NR | NR | SR12F | NP | NP | −20° C. to 15° C. | 20° C. to 65° C. |
| SS21B2 | PR2B | NR | NR | SR12F | NP | NP | −20° C. to 15° C. | 20° C. to 65° C. |
| SS21C2 | PR2C | NR | NR | SR12F | NP | NP | −20° C. to 15° C. | 20° C. to 65° C. |
| SS21A3 | PR3A | NR | NR | SR12F | NP | NP | −20° C. to 15° C. | 20° C. to 65° C. |
| SS21B3 | PR3B | NR | NR | SR12F | NP | NP | −20° C. to 15° C. | 20° C. to 65° C. |
| SS21C3 | PR3C | NR | NR | SR12F | NP | NP | −20° C. to 15° C. | 20° C. to 65° C. |
| SS21A4 | PR4 | NR | NR | SR12F | NP | NP | −20° C. to 15° C. | 20° C. to 65° C. |
| SS21A5 | PR5 | NR | NR | SR12F | NP | NP | −20° C. to 15° C. | 20° C. to 65° C. |
| SS21A6 | PR6 | NR | NR | SR12F | NP | NP | −20° C. to 15° C. | 20° C. to 65° C. |
| SS21A7 | PR7 | NR | NR | SR12F | NP | NP | −20° C. to 15° C. | 20° C. to 65° C. |
| SS21A8 | PR1A | POE | NR | SR12F | NP | NP | −20° C. to 15° C. | 20° C. to 65° C. |
| SS21B8 | PR1B | POE | NR | SR12F | NP | NP | −20° C. to 15° C. | 20° C. to 65° C. |
| SS21C8 | PR1C | POE | NR | SR12F | NP | NP | −20° C. to 15° C. | 20° C. to 65° C. |
| SS21A9 | PR2A | POE | NR | SR12F | NP | NP | −20° C. to 15° C. | 20° C. to 65° C. |
| SS21B9 | PR2B | POE | NR | SR12F | NP | NP | −20° C. to 15° C. | 20° C. to 65° C. |
| SS21C9 | PR2C | POE | NR | SR12F | NP | NP | −20° C. to 15° C. | 20° C. to 65° C. |
| SS21A10 | PR3A | POE | NR | SR12F | NP | NP | −20° C. to 15° C. | 20° C. to 65° C. |
| SS21B10 | PR3B | POE | NR | SR12F | NP | NP | −20° C. to 15° C. | 20° C. to 65° C. |
| SS21C10 | PR3C | POE | NR | SR12F | NP | NP | −20° C. to 15° C. | 20° C. to 65° C. |
| SS21A11 | PR4 | POE | NR | SR12F | NP | NP | −20° C. to 15° C. | 20° C. to 65° C. |
| SS21A12 | PR5 | POE | NR | SR12F | NP | NP | −20° C. to 15° C. | 20° C. to 65° C. |
| SS21A13 | PR6 | POE | NR | SR12F | NP | NP | −20° C. to 15° C. | 20° C. to 65° C. |
| SS21A14 | PR7 | POE | NR | SR12F | NP | NP | −20° C. to 15° C. | 20° C. to 65° C. |
| SS21A15 | PR1A | PVE | NR | SR12F | NP | NP | −20° C. to 15° C. | 20° C. to 65° C. |
| SS21B15 | PR1B | PVE | NR | SR12F | NP | NP | −20° C. to 15° C. | 20° C. to 65° C. |
| SS21C15 | PR1C | PVE | NR | SR12F | NP | NP | −20° C. to 15° C. | 20° C. to 65° C. |
| SS21A16 | PR2A | PVE | NR | SR12F | NP | NP | −20° C. to 15° C. | 20° C. to 65° C. |
| SS21B16 | PR2B | PVE | NR | SR12F | NP | NP | −20° C. to 15° C. | 20° C. to 65° C. |
| SS21C16 | PR2C | PVE | NR | SR12F | NP | NP | −20° C. to 15° C. | 20° C. to 65° C. |
| SS21A17 | PR3A | PVE | NR | SR12F | NP | NP | −20° C. to 15° C. | 20° C. to 65° C. |
| SS21B17 | PR3B | PVE | NR | SR12F | NP | NP | −20° C. to 15° C. | 20° C. to 65° C. |
| SS21C17 | PR3C | PVE | NR | SR12F | NP | NP | −20° C. to 15° C. | 20° C. to 65° C. |
| SS21A19 | PR4 | PVE | NR | SR12F | NP | NP | −20° C. to 15° C. | 20° C. to 65° C. |
| SS21A20 | PR5 | PVE | NR | SR12F | NP | NP | −20° C. to 15° C. | 20° C. to 65° C. |
| SS21A21 | PR6 | PVE | NR | SR12F | NP | NP | −20° C. to 15° C. | 20° C. to 65° C. |
| SS21A22 | PR7 | PVE | NR | SR12F | NP | NP | −20° C. to 15° C. | 20° C. to 65° C. |
| SS22A1 | PR1A | NR | Yes | SR13F | NP | NP | −20° C. to 15° C. | 20° C. to 65° C. |
| SS22B1 | PR1B | NR | Yes | SR13F | NP | NP | −20° C. to 15° C. | 20° C. to 65° C. |
| SS22C1 | PR1C | NR | Yes | SR13F | NP | NP | −20° C. to 15° C. | 20° C. to 65° C. |
| SS22A2 | PR2A | NR | Yes | SR13F | NP | NP | −20° C. to 15° C. | 20° C. to 65° C. |
| SS22B2 | PR2B | NR | Yes | SR13F | NP | NP | −20° C. to 15° C. | 20° C. to 65° C. |
| SS22C2 | PR2C | NR | Yes | SR13F | NP | NP | −20° C. to 15° C. | 20° C. to 65° C. |
| SS22A3 | PR3A | NR | Yes | SR13F | NP | NP | −20° C. to 15° C. | 20° C. to 65° C. |
| SS22B3 | PR3B | NR | Yes | SR13F | NP | NP | −20° C. to 15° C. | 20° C. to 65° C. |
| SS22C3 | PR3C | NR | Yes | SR13F | NP | NP | −20° C. to 15° C. | 20° C. to 65° C. |
| SS22A4 | PR4 | NR | Yes | SR13F | NP | NP | −20° C. to 15° C. | 20° C. to 65° C. |
| SS22A5 | PR5 | NR | Yes | SR13F | NP | NP | −20° C. to 15° C. | 20° C. to 65° C. |
| SS22A6 | PR6 | NR | Yes | SR13F | NP | NP | −20° C. to 15° C. | 20° C. to 65° C. |
| SS22A7 | PR7 | NR | Yes | SR13F | NP | NP | −20° C. to 15° C. | 20° C. to 65° C. |
| SS22A8 | PR1A | POE | Yes | SR13F | NP | NP | −20° C. to 15° C. | 20° C. to 65° C. |
| SS22B8 | PR1B | POE | Yes | SR13F | NP | NP | −20° C. to 15° C. | 20° C. to 65° C. |
| SS22C8 | PR1C | POE | Yes | SR13F | NP | NP | −20° C. to 15° C. | 20° C. to 65° C. |
| SS22A9 | PR2A | POE | Yes | SR13F | NP | NP | −20° C. to 15° C. | 20° C. to 65° C. |
| SS22B9 | PR2B | POE | Yes | SR13F | NP | NP | −20° C. to 15° C. | 20° C. to 65° C. |
| SS22C9 | PR2C | POE | Yes | SR13F | NP | NP | −20° C. to 15° C. | 20° C. to 65° C. |
| SS22A10 | PR3A | POE | Yes | SR13F | NP | NP | −20° C. to 15° C. | 20° C. to 65° C. |
| SS22B10 | PR3B | POE | Yes | SR13F | NP | NP | −20° C. to 15° C. | 20° C. to 65° C. |
| SS22C10 | PR3C | POE | Yes | SR13F | NP | NP | −20° C. to 15° C. | 20° C. to 65° C. |
| SS22A11 | PR4 | POE | Yes | SR13F | NP | NP | −20° C. to 15° C. | 20° C. to 65° C. |
| SS22A12 | PR5 | POE | Yes | SR13F | NP | NP | −20° C. to 15° C. | 20° C. to 65° C. |
| SS22A13 | PR6 | POE | Yes | SR13F | NP | NP | −20° C. to 15° C. | 20° C. to 65° C. |
| SS22A14 | PR7 | POE | Yes | SR13F | NP | NP | −20° C. to 15° C. | 20° C. to 65° C. |
| SS22A15 | PR1A | PVE | Yes | SR13F | NP | NP | −20° C. to 15° C. | 20° C. to 65° C. |
| SS22B15 | PR1B | PVE | Yes | SR13F | NP | NP | −20° C. to 15° C. | 20° C. to 65° C. |
| SS22C15 | PR1C | PVE | Yes | SR13F | NP | NP | −20° C. to 15° C. | 20° C. to 65° C. |
| SS22A16 | PR2A | PVE | Yes | SR13F | NP | NP | −20° C. to 15° C. | 20° C. to 65° C. |
| SS22B16 | PR2B | PVE | Yes | SR13F | NP | NP | −20° C. to 15° C. | 20° C. to 65° C. |
| SS22C16 | PR2C | PVE | Yes | SR13F | NP | NP | −20° C. to 15° C. | 20° C. to 65° C. |
| SS22A17 | PR3A | PVE | Yes | SR13F | NP | NP | −20° C. to 15° C. | 20° C. to 65° C. |
| SS22B17 | PR3B | PVE | Yes | SR13F | NP | NP | −20° C. to 15° C. | 20° C. to 65° C. |
| SS22C17 | PR3C | PVE | Yes | SR13F | NP | NP | −20° C. to 15° C. | 20° C. to 65° C. |
| SS22A19 | PR4 | PVE | Yes | SR13F | NP | NP | −20° C. to 15° C. | 20° C. to 65° C. |
| SS22A20 | PR5 | PVE | Yes | SR13F | NP | NP | −20° C. to 15° C. | 20° C. to 65° C. |
| SS22A21 | PR6 | PVE | Yes | SR13F | NP | NP | −20° C. to 15° C. | 20° C. to 65° C. |
| SS22A22 | PR7 | PVE | Yes | SR13F | NP | NP | −20° C. to 15° C. | 20° C. to 65° C. |
| SS23A1 | PR1A | NR | Yes | SR14F | NP | NP | −20° C. to 15° C. | 20° C. to 65° C. |
| SS23B1 | PR1B | NR | Yes | SR14F | NP | NP | −20° C. to 15° C. | 20° C. to 65° C. |
| SS23C1 | PR1C | NR | Yes | SR14F | NP | NP | −20° C. to 15° C. | 20° C. to 65° C. |
| SS23A2 | PR2A | NR | Yes | SR14F | NP | NP | −20° C. to 15° C. | 20° C. to 65° C. |
| SS23B2 | PR2B | NR | Yes | SR14F | NP | NP | −20° C. to 15° C. | 20° C. to 65° C. |
| SS23C2 | PR2C | NR | Yes | SR14F | NP | NP | −20° C. to 15° C. | 20° C. to 65° C. |
| SS23A3 | PR3A | NR | Yes | SR14F | NP | NP | −20° C. to 15° C. | 20° C. to 65° C. |
| SS23B3 | PR3B | NR | NR | SR14F | NP | NP | −20° C. to 15° C. | 20° C. to 65° C. |
| SS23C3 | PR3C | NR | NR | SR14F | NP | NP | −20° C. to 15° C. | 20° C. to 65° C. |
| SS23A4 | PR4 | NR | NR | SR14F | NP | NP | −20° C. to 15° C. | 20° C. to 65° C. |
| SS23A5 | PR5 | NR | NR | SR14F | NP | NP | −20° C. to 15° C. | 20° C. to 65° C. |
| SS23A6 | PR6 | NR | NR | SR14F | NP | NP | −20° C. to 15° C. | 20° C. to 65° C. |
| SS23A7 | PR7 | NR | NR | SR14F | NP | NP | −20° C. to 15° C. | 20° C. to 65° C. |
| SS23A8 | PR1A | POE | NR | SR14F | NP | NP | −20° C. to 15° C. | 20° C. to 65° C. |
| SS23B8 | PR1B | POE | NR | SR14F | NP | NP | −20° C. to 15° C. | 20° C. to 65° C. |
| SS23C8 | PR1C | POE | NR | SR14F | NP | NP | −20° C. to 15° C. | 20° C. to 65° C. |
| SS23A9 | PR2A | POE | NR | SR14F | NP | NP | −20° C. to 15° C. | 20° C. to 65° C. |
| SS23B9 | PR2B | POE | NR | SR14F | NP | NP | −20° C. to 15° C. | 20° C. to 65° C. |
| SS23C9 | PR2C | POE | NR | SR14F | NP | NP | −20° C. to 15° C. | 20° C. to 65° C. |
| SS23A10 | PR3A | POE | NR | SR14F | NP | NP | −20° C. to 15° C. | 20° C. to 65° C. |
| SS23B10 | PR3B | POE | NR | SR14F | NP | NP | −20° C. to 15° C. | 20° C. to 65° C. |
| SS23C10 | PR3C | POE | NR | SR14F | NP | NP | −20° C. to 15° C. | 20° C. to 65° C. |
| SS23A11 | PR4 | POE | NR | SR14F | NP | NP | −20° C. to 15° C. | 20° C. to 65° C. |
| SS23A12 | PR5 | POE | NR | SR14F | NP | NP | −20° C. to 15° C. | 20° C. to 65° C. |
| SS23A13 | PR6 | POE | NR | SR14F | NP | NP | −20° C. to 15° C. | 20° C. to 65° C. |
| SS23A14 | PR7 | POE | NR | SR14F | NP | NP | −20° C. to 15° C. | 20° C. to 65° C. |
| SS23A15 | PR1A | PVE | NR | SR14F | NP | NP | −20° C. to 15° C. | 20° C. to 65° C. |
| SS23B15 | PR1B | PVE | NR | SR14F | NP | NP | −20° C. to 15° C. | 20° C. to 65° C. |
| SS23C15 | PR1C | PVE | NR | SR14F | NP | NP | −20° C. to 15° C. | 20° C. to 65° C. |
| SS23A16 | PR2A | PVE | NR | SR14F | NP | NP | −20° C. to 15° C. | 20° C. to 65° C. |
| SS23B16 | PR2B | PVE | NR | SR14F | NP | NP | −20° C. to 15° C. | 20° C. to 65° C. |
| SS23C16 | PR2C | PVE | NR | SR14F | NP | NP | −20° C. to 15° C. | 20° C. to 65° C. |
| SS23A17 | PR3A | PVE | NR | SR14F | NP | NP | −20° C. to 15° C. | 20° C. to 65° C. |
| SS23B17 | PR3B | PVE | NR | SR14F | NP | NP | −20° C. to 15° C. | 20° C. to 65° C. |
| SS23C17 | PR3C | PVE | NR | SR14F | NP | NP | −20° C. to 15° C. | 20° C. to 65° C. |
| SS23A19 | PR4 | PVE | NR | SR14F | NP | NP | −20° C. to 15° C. | 20° C. to 65° C. |
| SS23A20 | PR5 | PVE | NR | SR14F | NP | NP | −20° C. to 15° C. | 20° C. to 65° C. |
| SS23A21 | PR6 | PVE | NR | SR14F | NP | NP | −20° C. to 15° C. | 20° C. to 65° C. |
| SS23A22 | PR7 | PVE | NR | SR14F | NP | NP | −20° C. to 15° C. | 20° C. to 65° C. |
| SS24A1 | PR1A | NR | NR | SR10E | NP | NP | −20° C. to 15° C. | 20° C. to 65° C. |
| SS24B1 | PR1B | NR | NR | SR10E | NP | NP | −20° C. to 15° C. | 20° C. to 65° C. |
| SS24C1 | PR1C | NR | NR | SR10E | NP | NP | −20° C. to 15° C. | 20° C. to 65° C. |
| SS24A2 | PR2A | NR | NR | SR10E | NP | NP | −20° C. to 15° C. | 20° C. to 65° C. |
| SS24B2 | PR2B | NR | NR | SR10E | NP | NP | −20° C. to 15° C. | 20° C. to 65° C. |
| SS24C2 | PR2C | NR | NR | SR10E | NP | NP | −20° C. to 15° C. | 20° C. to 65° C. |
| SS24A3 | PR3A | NR | NR | SR10E | NP | NP | −20° C. to 15° C. | 20° C. to 65° C. |
| SS24B3 | PR3B | NR | NR | SR10E | NP | NP | −20° C. to 15° C. | 20° C. to 65° C. |
| SS24C3 | PR3C | NR | NR | SR10E | NP | NP | −20° C. to 15° C. | 20° C. to 65° C. |
| SS24A4 | PR4 | NR | NR | SR10E | NP | NP | −20° C. to 15° C. | 20° C. to 65° C. |
| SS24A5 | PR5 | NR | NR | SR10E | NP | NP | −20° C. to 15° C. | 20° C. to 65° C. |
| SS24A6 | PR6 | NR | NR | SR10E | NP | NP | −20° C. to 15° C. | 20° C. to 65° C. |
| SS24A7 | PR7 | NR | NR | SR10E | NP | NP | −20° C. to 15° C. | 20° C. to 65° C. |
| SS24A8 | PR1A | POE | NR | SR10E | NP | NP | −20° C. to 15° C. | 20° C. to 65° C. |
| SS24B8 | PR1B | POE | NR | SR10E | NP | NP | −20° C. to 15° C. | 20° C. to 65° C. |
| SS24C8 | PR1C | POE | NR | SR10E | NP | NP | −20° C. to 15° C. | 20° C. to 65° C. |
| SS24A9 | PR2A | POE | NR | SR10E | NP | NP | −20° C. to 15° C. | 20° C. to 65° C. |
| SS24B9 | PR2B | POE | NR | SR10E | NP | NP | −20° C. to 15° C. | 20° C. to 65° C. |
| SS24C9 | PR2C | POE | NR | SR10E | NP | NP | −20° C. to 15° C. | 20° C. to 65° C. |
| SS24A10 | PR3A | POE | NR | SR10E | NP | NP | −20° C. to 15° C. | 20° C. to 65° C. |
| SS24B10 | PR3B | POE | NR | SR10E | NP | NP | −20° C. to 15° C. | 20° C. to 65° C. |
| SS24C10 | PR3C | POE | NR | SR10E | NP | NP | −20° C. to 15° C. | 20° C. to 65° C. |
| SS24A11 | PR4 | POE | NR | SR10E | NP | NP | −20° C. to 15° C. | 20° C. to 65° C. |
| SS24A12 | PR5 | POE | NR | SR10E | NP | NP | −20° C. to 15° C. | 20° C. to 65° C. |
| SS24A13 | PR6 | POE | NR | SR10E | NP | NP | −20° C. to 15° C. | 20° C. to 65° C. |
| SS24A14 | PR7 | POE | NR | SR10E | NP | NP | −20° C. to 15° C. | 20° C. to 65° C. |
| SS24A15 | PR1A | PVE | NR | SR10E | NP | NP | −20° C. to 15° C. | 20° C. to 65° C. |
| SS24B15 | PR1B | PVE | NR | SR10E | NP | NP | −20° C. to 15° C. | 20° C. to 65° C. |
| SS24C15 | PR1C | PVE | NR | SR10E | NP | NP | −20° C. to 15° C. | 20° C. to 65° C. |
| SS24A16 | PR2A | PVE | NR | SR10E | NP | NP | −20° C. to 15° C. | 20° C. to 65° C. |
| SS24B16 | PR2B | PVE | NR | SR10E | NP | NP | −20° C. to 15° C. | 20° C. to 65° C. |
| SS24C16 | PR2C | PVE | NR | SR10E | NP | NP | −20° C. to 15° C. | 20° C. to 65° C. |
| SS24A17 | PR3A | PVE | NR | SR10E | NP | NP | −20° C. to 15° C. | 20° C. to 65° C. |
| SS24B17 | PR3B | PVE | NR | SR10E | NP | NP | −20° C. to 15° C. | 20° C. to 65° C. |
| SS24C17 | PR3C | PVE | NR | SR10E | NP | NP | −20° C. to 15° C. | 20° C. to 65° C. |
| SS24A19 | PR4 | PVE | NR | SR10E | NP | NP | −20° C. to 15° C. | 20° C. to 65° C. |
| SS24A20 | PR5 | PVE | NR | SR10E | NP | NP | −20° C. to 15° C. | 20° C. to 65° C. |
| SS24A21 | PR6 | PVE | NR | SR10E | NP | NP | −20° C. to 15° C. | 20° C. to 65° C. |
| SS24A22 | PR7 | PVE | NR | SR10E | NP | NP | −20° C. to 15° C. | 20° C. to 65° C. |
| SS25A1 | PR1A | NR | Yes | SR11E | NP | NP | −20° C. to 15° C. | 20° C. to 65° C. |
| SS25B1 | PR1B | NR | Yes | SR11E | NP | NP | −20° C. to 15° C. | 20° C. to 65° C. |
| SS25C1 | PR1C | NR | Yes | SR11E | NP | NP | −20° C. to 15° C. | 20° C. to 65° C. |
| SS25A2 | PR2A | NR | Yes | SR11E | NP | NP | −20° C. to 15° C. | 20° C. to 65° C. |
| SS25B2 | PR2B | NR | Yes | SR11E | NP | NP | −20° C. to 15° C. | 20° C. to 65° C. |
| SS25C2 | PR2C | NR | Yes | SR11E | NP | NP | −20° C. to 15° C. | 20° C. to 65° C. |
| SS25A3 | PR3A | NR | Yes | SR11E | NP | NP | −20° C. to 15° C. | 20° C. to 65° C. |
| SS25B3 | PR3B | NR | Yes | SR11E | NP | NP | −20° C. to 15° C. | 20° C. to 65° C. |
| SS25C3 | PR3C | NR | Yes | SR11E | NP | NP | −20° C. to 15° C. | 20° C. to 65° C. |
| SS25A4 | PR4 | NR | Yes | SR11E | NP | NP | −20° C. to 15° C. | 20° C. to 65° C. |
| SS25A5 | PR5 | NR | Yes | SR11E | NP | NP | −20° C. to 15° C. | 20° C. to 65° C. |
| SS25A6 | PR6 | NR | Yes | SR11E | NP | NP | −20° C. to 15° C. | 20° C. to 65° C. |
| SS25A7 | PR7 | NR | Yes | SR11E | NP | NP | −20° C. to 15° C. | 20° C. to 65° C. |
| SS25A8 | PR1A | POE | Yes | SR11E | NP | NP | −20° C. to 15° C. | 20° C. to 65° C. |
| SS25B8 | PR1B | POE | Yes | SR11E | NP | NP | −20° C. to 15° C. | 20° C. to 65° C. |
| SS25C8 | PR1C | POE | Yes | SR11E | NP | NP | −20° C. to 15° C. | 20° C. to 65° C. |
| SS25A9 | PR2A | POE | Yes | SR11E | NP | NP | −20° C. to 15° C. | 20° C. to 65° C. |
| SS25B9 | PR2B | POE | Yes | SR11E | NP | NP | −20° C. to 15° C. | 20° C. to 65° C. |
| SS25C9 | PR2C | POE | Yes | SR11E | NP | NP | −20° C. to 15° C. | 20° C. to 65° C. |
| SS25A10 | PR3A | POE | Yes | SR11E | NP | NP | −20° C. to 15° C. | 20° C. to 65° C. |
| SS25B10 | PR3B | POE | Yes | SR11E | NP | NP | −20° C. to 15° C. | 20° C. to 65° C. |
| SS25C10 | PR3C | POE | Yes | SR11E | NP | NP | −20° C. to 15° C. | 20° C. to 65° C. |
| SS25A11 | PR4 | POE | Yes | SR11E | NP | NP | −20° C. to 15° C. | 20° C. to 65° C. |
| SS25A12 | PR5 | POE | Yes | SR11E | NP | NP | −20° C. to 15° C. | 20° C. to 65° C. |
| SS25A13 | PR6 | POE | Yes | SR11E | NP | NP | −20° C. to 15° C. | 20° C. to 65° C. |
| SS25A14 | PR7 | POE | Yes | SR11E | NP | NP | −20° C. to 15° C. | 20° C. to 65° C. |
| SS25A15 | PR1A | PVE | Yes | SR11E | NP | NP | −20° C. to 15° C. | 20° C. to 65° C. |
| SS25B15 | PR1B | PVE | Yes | SR11E | NP | NP | −20° C. to 15° C. | 20° C. to 65° C. |
| SS25C15 | PR1C | PVE | Yes | SR11E | NP | NP | −20° C. to 15° C. | 20° C. to 65° C. |
| SS25A16 | PR2A | PVE | Yes | SR11E | NP | NP | −20° C. to 15° C. | 20° C. to 65° C. |
| SS25B16 | PR2B | PVE | Yes | SR11E | NP | NP | −20° C. to 15° C. | 20° C. to 65° C. |
| SS25C16 | PR2C | PVE | Yes | SR11E | NP | NP | −20° C. to 15° C. | 20° C. to 65° C. |
| SS25A17 | PR3A | PVE | Yes | SR11E | NP | NP | −20° C. to 15° C. | 20° C. to 65° C. |
| SS25B17 | PR3B | PVE | Yes | SR11E | NP | NP | −20° C. to 15° C. | 20° C. to 65° C. |
| SS25C17 | PR3C | PVE | Yes | SR11E | NP | NP | −20° C. to 15° C. | 20° C. to 65° C. |
| SS25A19 | PR4 | PVE | Yes | SR11E | NP | NP | −20° C. to 15° C. | 20° C. to 65° C. |
| SS25A20 | PR5 | PVE | Yes | SR11E | NP | NP | −20° C. to 15° C. | 20° C. to 65° C. |
| SS25A21 | PR6 | PVE | Yes | SR11E | NP | NP | −20° C. to 15° C. | 20° C. to 65° C. |
| SS25A22 | PR7 | PVE | Yes | SR11E | NP | NP | −20° C. to 15° C. | 20° C. to 65° C. |
| SS26A1 | PR1A | NR | Yes | SR12E | NP | NP | −20° C. to 15° C. | 20° C. to 65° C. |
| SS26B1 | PR1B | NR | Yes | SR12E | NP | NP | −20° C. to 15° C. | 20° C. to 65° C. |
| SS26C1 | PR1C | NR | Yes | SR12E | NP | NP | −20° C. to 15° C. | 20° C. to 65° C. |
| SS26A2 | PR2A | NR | Yes | SR12E | NP | NP | −20° C. to 15° C. | 20° C. to 65° C. |
| SS26B2 | PR2B | NR | Yes | SR12E | NP | NP | −20° C. to 15° C. | 20° C. to 65° C. |
| SS26C2 | PR2C | NR | Yes | SR12E | NP | NP | −20° C. to 15° C. | 20° C. to 65° C. |
| SS26A3 | PR3A | NR | Yes | SR12E | NP | NP | −20° C. to 15° C. | 20° C. to 65° C. |
| SS26B3 | PR3B | NR | NR | SR12E | NP | NP | −20° C. to 15° C. | 20° C. to 65° C. |
| SS26C3 | PR3C | NR | NR | SR12E | NP | NP | −20° C. to 15° C. | 20° C. to 65° C. |
| SS26A4 | PR4 | NR | NR | SR12E | NP | NP | −20° C. to 15° C. | 20° C. to 65° C. |
| SS26A5 | PR5 | NR | NR | SR12E | NP | NP | −20° C. to 15° C. | 20° C. to 65° C. |
| SS26A6 | PR6 | NR | NR | SR12E | NP | NP | −20° C. to 15° C. | 20° C. to 65° C. |
| SS26A7 | PR7 | NR | NR | SR12E | NP | NP | −20° C. to 15° C. | 20° C. to 65° C. |
| SS26A8 | PR1A | POE | NR | SR12E | NP | NP | −20° C. to 15° C. | 20° C. to 65° C. |
| SS26B8 | PR1B | POE | NR | SR12E | NP | NP | −20° C. to 15° C. | 20° C. to 65° C. |
| SS26C8 | PR1C | POE | NR | SR12E | NP | NP | −20° C. to 15° C. | 20° C. to 65° C. |
| SS26A9 | PR2A | POE | NR | SR12E | NP | NP | −20° C. to 15° C. | 20° C. to 65° C. |
| SS26B9 | PR2B | POE | NR | SR12E | NP | NP | −20° C. to 15° C. | 20° C. to 65° C. |
| SS26C9 | PR2C | POE | NR | SR12E | NP | NP | −20° C. to 15° C. | 20° C. to 65° C. |
| SS26A10 | PR3A | POE | NR | SR12E | NP | NP | −20° C. to 15° C. | 20° C. to 65° C. |
| SS26B10 | PR3B | POE | NR | SR12E | NP | NP | −20° C. to 15° C. | 20° C. to 65° C. |
| SS26C10 | PR3C | POE | NR | SR12E | NP | NP | −20° C. to 15° C. | 20° C. to 65° C. |
| SS26A11 | PR4 | POE | NR | SR12E | NP | NP | −20° C. to 15° C. | 20° C. to 65° C. |
| SS26A12 | PR5 | POE | NR | SR12E | NP | NP | −20° C. to 15° C. | 20° C. to 65° C. |
| SS26A13 | PR6 | POE | NR | SR12E | NP | NP | −20° C. to 15° C. | 20° C. to 65° C. |
| SS26A14 | PR7 | POE | NR | SR12E | NP | NP | −20° C. to 15° C. | 20° C. to 65° C. |
| SS26A15 | PR1A | PVE | NR | SR12E | NE | NP | −20° C. to 15° C. | 20° C. to 65° C. |
| SS26B15 | PR1B | PVE | NR | SR12E | NP | NP | −20° C. to 15° C. | 20° C. to 65° C. |
| SS26C15 | PR1C | PVE | NR | SR12E | NP | NP | −20° C. to 15° C. | 20° C. to 65° C. |
| SS26A16 | PR2A | PVE | NR | SR12E | NP | NP | −20° C. to 15° C. | 20° C. to 65° C. |
| SS26B16 | PR2B | PVE | NR | SR12E | NP | NP | −20° C. to 15° C. | 20° C. to 65° C. |
| SS26C16 | PR2C | PVE | NR | SR12E | NP | NP | −20° C. to 15° C. | 20° C. to 65° C. |
| SS26A17 | PR3A | PVE | NR | SR12E | NP | NP | −20° C. to 15° C. | 20° C. to 65° C. |
| SS26B17 | PR3B | PVE | NR | SR12E | NP | NP | −20° C. to 15° C. | 20° C. to 65° C. |
| SS26C17 | PR3C | PVE | NR | SR12E | NP | NP | −20° C. to 15° C. | 20° C. to 65° C. |
| SS26A19 | PR4 | PVE | NR | SR12E | NP | NP | −20° C. to 15° C. | 20° C. to 65° C. |
| SS26A20 | PR5 | PVE | NR | SR12E | NP | NP | −20° C. to 15° C. | 20° C. to 65° C. |
| SS26A21 | PR6 | PVE | NR | SR12E | NP | NP | −20° C. to 15° C. | 20° C. to 65° C. |
| SS26A22 | PR7 | PVE | NR | SR12E | NP | NP | −20° C. to 15° C. | 20° C. to 65° C. |
| SS27A1 | PR1A | NR | NR | SR13E | NP | NP | −20° C. to 15° C. | 20° C. to 65° C. |
| SS27B1 | PR1B | NR | NR | SR13E | NP | NP | −20° C. to 15° C. | 20° C. to 65° C. |
| SS27C1 | PR1C | NR | NR | SR13E | NP | NP | −20° C. to 15° C. | 20° C. to 65° C. |
| SS27A2 | PR2A | NR | NR | SR13E | NP | NP | −20° C. to 15° C. | 20° C. to 65° C. |
| SS27B2 | PR2B | NR | NR | SR13E | NP | NP | −20° C. to 15° C. | 20° C. to 65° C. |
| SS27C2 | PR2C | NR | NR | SR13E | NP | NP | −20° C. to 15° C. | 20° C. to 65° C. |
| SS27A3 | PR3A | NR | NR | SR13E | NP | NP | −20° C. to 15° C. | 20° C. to 65° C. |
| SS27B3 | PR3B | NR | NR | SR13E | NP | NP | −20° C. to 15° C. | 20° C. to 65° C. |
| SS27C3 | PR3C | NR | NR | SR13E | NP | NP | −20° C. to 15° C. | 20° C. to 65° C. |
| SS27A4 | PR4 | NR | NR | SR13E | NP | NP | −20° C. to 15° C. | 20° C. to 65° C. |
| SS27A5 | PR5 | NR | NR | SR13E | NP | NP | −20° C. to 15° C. | 20° C. to 65° C. |
| SS27A6 | PR6 | NR | NR | SR13E | NP | NP | −20° C. to 15° C. | 20° C. to 65° C. |
| SS27A7 | PR7 | NR | NR | SR13E | NP | NP | −20° C. to 15° C. | 20° C. to 65° C. |
| SS27A8 | PR1A | POE | NR | SR13E | NP | NP | −20° C. to 15° C. | 20° C. to 65° C. |
| SS27B8 | PR1B | POE | NR | SR13E | NP | NP | −20° C. to 15° C. | 20° C. to 65° C. |
| SS27C8 | PR1C | POE | NR | SR13E | NP | NP | −20° C. to 15° C. | 20° C. to 65° C. |
| SS27A9 | PR2A | POE | NR | SR13E | NP | NP | −20° C. to 15° C. | 20° C. to 65° C. |
| SS27B9 | PR2B | POE | NR | SR13E | NP | NP | −20° C. to 15° C. | 20° C. to 65° C. |
| SS27C9 | PR2C | POE | NR | SR13E | NP | NP | −20° C. to 15° C. | 20° C. to 65° C. |
| SS27A10 | PR3A | POE | NR | SR13E | NP | NP | −20° C. to 15° C. | 20° C. to 65° C. |
| SS27B10 | PR3B | POE | NR | SR13E | NP | NP | −20° C. to 15° C. | 20° C. to 65° C. |
| SS27C10 | PR3C | POE | NR | SR13E | NP | NP | −20° C. to 15° C. | 20° C. to 65° C. |
| SS27A11 | PR4 | POE | NR | SR13E | NP | NP | −20° C. to 15° C. | 20° C. to 65° C. |
| SS27A12 | PR5 | POE | NR | SR13E | NP | NP | −20° C. to 15° C. | 20° C. to 65° C. |
| SS27A13 | PR6 | POE | NR | SR13E | NP | NP | −20° C. to 15° C. | 20° C. to 65° C. |
| SS27A14 | PR7 | POE | NR | SR13E | NP | NP | −20° C. to 15° C. | 20° C. to 65° C. |
| SS27A15 | PR1A | PVE | NR | SR13E | NP | NP | −20° C. to 15° C. | 20° C. to 65° C. |
| SS27B15 | PR1B | PVE | NR | SR13E | NP | NP | −20° C. to 15° C. | 20° C. to 65° C. |
| SS27C15 | PR1C | PVE | NR | SR13E | NP | NP | −20° C. to 15° C. | 20° C. to 65° C. |
| SS27A16 | PR2A | PVE | NR | SR13E | NP | NP | −20° C. to 15° C. | 20° C. to 65° C. |
| SS27B16 | PR2B | PVE | NR | SR13E | NP | NP | −20° C. to 15° C. | 20° C. to 65° C. |
| SS27C16 | PR2C | PVE | NR | SR13E | NP | NP | −20° C. to 15° C. | 20° C. to 65° C. |
| SS27A17 | PR3A | PVE | NR | SR13E | NP | NP | −20° C. to 15° C. | 20° C. to 65° C. |
| SS27B17 | PR3B | PVE | NR | SR13E | NP | NP | −20° C. to 15° C. | 20° C. to 65° C. |
| SS27C17 | PR3C | PVE | NR | SR13E | NP | NP | −20° C. to 15° C. | 20° C. to 65° C. |
| SS27A19 | PR4 | PVE | NR | SR13E | NP | NP | −20° C. to 15° C. | 20° C. to 65° C. |
| SS27A20 | PR5 | PVE | NR | SR13E | NP | NP | −20° C. to 15° C. | 20° C. to 65° C. |
| SS27A21 | PR6 | PVE | NR | SR13E | NP | NP | −20° C. to 15° C. | 20° C. to 65° C. |
| SS27A22 | PR7 | PVE | NR | SR13E | NP | NP | −20° C. to 15° C. | 20° C. to 65° C. |
| SS28A1 | PR1A | NR | NR | SR14E | NP | NP | −20° C. to 15° C. | 20° C. to 65° C. |
| SS28B1 | PR1B | NR | NR | SR14E | NP | NP | −20° C. to 15° C. | 20° C. to 65° C. |
| SS28C1 | PR1C | NR | NR | SR14E | NP | NP | −20° C. to 15° C. | 20° C. to 65° C. |
| SS28A2 | PR2A | NR | NR | SR14E | NP | NP | −20° C. to 15° C. | 20° C. to 65° C. |
| SS28B2 | PR2B | NR | NR | SR14E | NP | NP | −20° C. to 15° C. | 20° C. to 65° C. |
| SS28C2 | PR2C | NR | NR | SR14E | NP | NP | −20° C. to 15° C. | 20° C. to 65° C. |
| SS28A3 | PR3A | NR | NR | SR14E | NP | NP | −20° C. to 15° C. | 20° C. to 65° C. |
| SS28B3 | PR3B | NR | NR | SR14E | NP | NP | −20° C. to 15° C. | 20° C. to 65° C. |
| SS28C3 | PR3C | NR | NR | SR14E | NP | NP | −20° C. to 15° C. | 20° C. to 65° C. |
| SS28A4 | PR4 | NR | NR | SR14E | NP | NP | −20° C. to 15° C. | 20° C. to 65° C. |
| SS28A5 | PR5 | NR | NR | SR14E | NP | NP | −20° C. to 15° C. | 20° C. to 65° C. |
| SS28A6 | PR6 | NR | NR | SR14E | NP | NP | −20° C. to 15° C. | 20° C. to 65° C. |
| SS28A7 | PR7 | NR | NR | SR14E | NP | NP | −20° C. to 15° C. | 20° C. to 65° C. |
| SS28A8 | PR1A | POE | NR | SR14E | NP | NP | −20° C. to 15° C. | 20° C. to 65° C. |
| SS28B8 | PR1B | POE | NR | SR14E | NP | NP | −20° C. to 15° C. | 20° C. to 65° C. |
| SS28C8 | PR1C | POE | NR | SR14E | NP | NP | −20° C. to 15° C. | 20° C. to 65° C. |
| SS28A9 | PR2A | POE | NR | SR14E | NP | NP | −20° C. to 15° C. | 20° C. to 65° C. |
| SS28B9 | PR2B | POE | NR | SR14E | NP | NP | −20° C. to 15° C. | 20° C. to 65° C. |
| SS28C9 | PR2C | POE | NR | SR14E | NP | NP | −20° C. to 15° C. | 20° C. to 65° C. |
| SS28A10 | PR3A | POE | NR | SR14E | NP | NP | −20° C. to 15° C. | 20° C. to 65° C. |
| SS28B10 | PR3B | POE | NR | SR14E | NP | NP | −20° C. to 15° C. | 20° C. to 65° C. |
| SS28C10 | PR3C | POE | NR | SR14E | NP | NP | −20° C. to 15° C. | 20° C. to 65° C. |
| SS28A11 | PR4 | POE | NR | SR14E | NP | NP | −20° C. to 15° C. | 20° C. to 65° C. |
| SS28A12 | PR5 | POE | NR | SR14E | NP | NP | −20° C. to 15° C. | 20° C. to 65° C. |
| SS28A13 | PR6 | POE | NR | SR14E | NP | NP | −20° C. to 15° C. | 20° C. to 65° C. |
| SS28A14 | PR7 | POE | NR | SR14E | NP | NP | −20° C. to 15° C. | 20° C. to 65° C. |
| SS28A15 | PR1A | PVE | NR | SR14E | NP | NP | −20° C. to 15° C. | 20° C. to 65° C. |
| SS28B15 | PR1B | PVE | NR | SR14E | NP | NP | −20° C. to 15° C. | 20° C. to 65° C. |
| SS28C15 | PR1C | PVE | NR | SR14E | NP | NP | −20° C. to 15° C. | 20° C. to 65° C. |
| SS28A16 | PR2A | PVE | NR | SR14E | NP | NP | −20° C. to 15° C. | 20° C. to 65° C. |
| SS28B16 | PR2B | PVE | NR | SR14E | NP | NP | −20° C. to 15° C. | 20° C. to 65° C. |
| SS28C16 | PR2C | PVE | NR | SR14E | NP | NP | −20° C. to 15° C. | 20° C. to 65° C. |
| SS28A17 | PR3A | PVE | NR | SR14E | NP | NP | −20° C. to 15° C. | 20° C. to 65° C. |
| SS28B17 | PR3B | PVE | NR | SR14E | NP | NP | −20° C. to 15° C. | 20° C. to 65° C. |
| SS28C17 | PR3C | PVE | NR | SR14E | NP | NP | −20° C. to 15° C. | 20° C. to 65° C. |
| SS28A19 | PR4 | PVE | NR | SR14E | NP | NP | −20° C. to 15° C. | 20° C. to 65° C. |
| SS28A20 | PR5 | PVE | NR | SR14E | NP | NP | −20° C. to 15° C. | 20° C. to 65° C. |
| SS28A21 | PR6 | PVE | NR | SR14E | NP | NP | −20° C. to 15° C. | 20° C. to 65° C. |
| SS28A22 | PR7 | PVE | NR | SR14E | NP | NP | −20° C. to 15° C. | 20° C. to 65° C. |
| SS30A1 | PR1A | NR | Yes | SR11H | NP | NP | −20° C. to 15° C. | 20° C. to 65° C. |
| SS30B1 | PR1B | NR | Yes | SR11H | NP | NP | −20° C. to 15° C. | 20° C. to 65° C. |
| SS30C1 | PR1C | NR | Yes | SR11H | NP | NP | −20° C. to 15° C. | 20° C. to 65° C. |
| SS30A2 | PR2A | NR | Yes | SR11H | NP | NP | −20° C. to 15° C. | 20° C. to 65° C. |
| SS30B2 | PR2B | NR | Yes | SR11H | NP | NP | −20° C. to 15° C. | 20° C. to 65° C. |
| SS30C2 | PR2C | NR | Yes | SR11H | NP | NP | −20° C. to 15° C. | 20° C. to 65° C. |
| SS30A3 | PR3A | NR | Yes | SR11H | NP | NP | −20° C. to 15° C. | 20° C. to 65° C. |
| SS30B3 | PR3B | NR | Yes | SR11H | NP | NP | −20° C. to 15° C. | 20° C. to 65° C. |
| SS30C3 | PR3C | NR | Yes | SR11H | NP | NP | −20° C. to 15° C. | 20° C. to 65° C. |
| SS30A4 | PR4 | NR | Yes | SR11H | NP | NP | −20° C. to 15° C. | 20° C. to 65° C. |
| SS30A5 | PR5 | NR | Yes | SR11H | NP | NP | −20° C. to 15° C. | 20° C. to 65° C. |
| SS30A6 | PR6 | NR | Yes | SR11H | NP | NP | −20° C. to 15° C. | 20° C. to 65° C. |
| SS30A7 | PR7 | NR | Yes | SR11H | NP | NP | −20° C. to 15° C. | 20° C. to 65° C. |
| SS30A8 | PR1A | POE | Yes | SR11H | NP | NP | −20° C. to 15° C. | 20° C. to 65° C. |
| SS30B8 | PR1B | POE | Yes | SR11H | NP | NP | −20° C. to 15° C. | 20° C. to 65° C. |
| SS30C8 | PR1C | POE | Yes | SR11H | NP | NP | −20° C. to 15° C. | 20° C. to 65° C. |
| SS30A9 | PR2A | POE | Yes | SR11H | NP | NP | −20° C. to 15° C. | 20° C. to 65° C. |
| SS30B9 | PR2B | POE | Yes | SR11H | NP | NP | −20° C. to 15° C. | 20° C. to 65° C. |
| SS30C9 | PR2C | POE | Yes | SR11H | NP | NP | −20° C. to 15° C. | 20° C. to 65° C. |
| SS30A10 | PR3A | POE | Yes | SR11H | NP | NP | −20° C. to 15° C. | 20° C. to 65° C. |
| SS30B10 | PR3B | POE | Yes | SR11H | NP | NP | −20° C. to 15° C. | 20° C. to 65° C. |
| SS30C10 | PR3C | POE | Yes | SR11H | NP | NP | −20° C. to 15° C. | 20° C. to 65° C. |
| SS30A11 | PR4 | POE | Yes | SR11H | NP | NP | −20° C. to 15° C. | 20° C. to 65° C. |
| SS30A12 | PR5 | POE | Yes | SR11H | NP | NP | −20° C. to 15° C. | 20° C. to 65° C. |
| SS30A13 | PR6 | POE | Yes | SR11H | NP | NP | −20° C. to 15° C. | 20° C. to 65° C. |
| SS30A14 | PR7 | POE | Yes | SR11H | NP | NP | −20° C. to 15° C. | 20° C. to 65° C. |
| SS30A15 | PR1A | PVE | Yes | SR11H | NP | NP | −20° C. to 15° C. | 20° C. to 65° C. |
| SS30B15 | PR1B | PVE | Yes | SR11H | NP | NP | −20° C. to 15° C. | 20° C. to 65° C. |
| SS30C15 | PR1C | PVE | Yes | SR11H | NP | NP | −20° C. to 15° C. | 20° C. to 65° C. |
| SS30A16 | PR2A | PVE | Yes | SR11H | NP | NP | −20° C. to 15° C. | 20° C. to 65° C. |
| SS30B16 | PR2B | PVE | Yes | SR11H | NP | NP | −20° C. to 15° C. | 20° C. to 65° C. |
| SS30C16 | PR2C | PVE | Yes | SR11H | NP | NP | −20° C. to 15° C. | 20° C. to 65° C. |
| SS30A17 | PR3A | PVE | Yes | SR11H | NP | NP | −20° C. to 15° C. | 20° C. to 65° C. |
| SS30B17 | PR3B | PVE | Yes | SR11H | NP | NP | −20° C. to 15° C. | 20° C. to 65° C. |
| SS30C17 | PR3C | PVE | Yes | SR11H | NP | NP | −20° C. to 15° C. | 20° C. to 65° C. |
| SS30A19 | PR4 | PVE | Yes | SR11H | NP | NP | −20° C. to 15° C. | 20° C. to 65° C. |
| SS30A20 | PR5 | PVE | Yes | SR11H | NP | NP | −20° C. to 15° C. | 20° C. to 65° C. |
| SS30A21 | PR6 | PVE | Yes | SR11H | NP | NP | −20° C. to 15° C. | 20° C. to 65° C. |
| SS30A22 | PR7 | PVE | Yes | SR11H | NP | NP | −20° C. to 15° C. | 20° C. to 65° C. |
| SS29A1 | PR1A | NR | Yes | SR11H | NP | NP | −20° C. to 15° C. | 20° C. to 65° C. |
| SS29B1 | PR1B | NR | Yes | SR11H | NP | NP | −20° C. to 15° C. | 20° C. to 65° C. |
| SS29C1 | PR1C | NR | Yes | SR11H | NP | NP | −20° C. to 15° C. | 20° C. to 65° C. |
| SS29A2 | PR2A | NR | Yes | SR11H | NP | NP | −20° C. to 15° C. | 20° C. to 65° C. |
| SS29B2 | PR2B | NR | Yes | SR11H | NP | NP | −20° C. to 15° C. | 20° C. to 65° C. |
| SS29C2 | PR2C | NR | Yes | SR11H | NP | NP | −20° C. to 15° C. | 20° C. to 65° C. |
| SS29A3 | PR3A | NR | Yes | SR11H | NP | NP | −20° C. to 15° C. | 20° C. to 65° C. |
| SS29B3 | PR3B | NR | Yes | SR11H | NP | NP | −20° C. to 15° C. | 20° C. to 65° C. |
| SS29C3 | PR3C | NR | Yes | SR11H | NP | NP | −20° C. to 15° C. | 20° C. to 65° C. |
| SS29A4 | PR4 | NR | Yes | SR11H | NP | NP | −20° C. to 15° C. | 20° C. to 65° C. |
| SS29A5 | PR5 | NR | Yes | SR11H | NP | NP | −20° C. to 15° C. | 20° C. to 65° C. |
| SS29A6 | PR6 | NR | Yes | SR11H | NP | NP | −20° C. to 15° C. | 20° C. to 65° C. |
| SS29A7 | PR7 | NR | Yes | SR11H | NP | NP | −20° C. to 15° C. | 20° C. to 65° C. |
| SS29A8 | PR1A | POE | Yes | SR11H | NP | NP | −20° C. to 15° C. | 20° C. to 65° C. |
| SS29B8 | PR1B | POE | Yes | SR11H | NP | NP | −20° C. to 15° C. | 20° C. to 65° C. |
| SS29C8 | PR1C | POE | Yes | SR11H | NP | NP | −20° C. to 15° C. | 20° C. to 65° C. |
| SS29A9 | PR2A | POE | Yes | SR11H | NP | NP | −20° C. to 15° C. | 20° C. to 65° C. |
| SS29B9 | PR2B | POE | Yes | SR11H | NP | NP | −20° C. to 15° C. | 20° C. to 65° C. |
| SS29C9 | PR2C | POE | Yes | SR11H | NP | NP | −20° C. to 15° C. | 20° C. to 65° C. |
| SS29A10 | PR3A | POE | Yes | SR11H | NP | NP | −20° C. to 15° C. | 20° C. to 65° C. |
| SS29B10 | PR3B | POE | Yes | SR11H | NP | NP | −20° C. to 15° C. | 20° C. to 65° C. |
| SS29C10 | PR3C | POE | Yes | SR11H | NP | NP | −20° C. to 15° C. | 20° C. to 65° C. |
| SS29A11 | PR4 | POE | Yes | SR11H | NP | NP | −20° C. to 15° C. | 20° C. to 65° C. |
| SS29A12 | PR5 | POE | Yes | SR11H | NP | NP | −20° C. to 15° C. | 20° C. to 65° C. |
| SS29A13 | PR6 | POE | Yes | SR11H | NP | NP | −20° C. to 15° C. | 20° C. to 65° C. |
| SS29A14 | PR7 | POE | Yes | SR11H | NP | NP | −20° C. to 15° C. | 20° C. to 65° C. |
| SS29A15 | PR1A | PVE | Yes | SR11H | NP | NP | −20° C. to 15° C. | 20° C. to 65° C. |
| SS29B15 | PR1B | PVE | Yes | SR11H | NP | NP | −20° C. to 15° C. | 20° C. to 65° C. |
| SS29C15 | PR1C | PVE | Yes | SR11H | NP | NP | −20° C. to 15° C. | 20° C. to 65° C. |
| SS29A16 | PR2A | PVE | Yes | SR11H | NP | NP | −20° C. to 15° C. | 20° C. to 65° C. |
| SS29B16 | PR2B | PVE | Yes | SR11H | NP | NP | −20° C. to 15° C. | 20° C. to 65° C. |
| SS29C16 | PR2C | PVE | Yes | SR11H | NP | NP | −20° C. to 15° C. | 20° C. to 65° C. |
| SS29A17 | PR3A | PVE | Yes | SR11H | NP | NP | −20° C. to 15° C. | 20° C. to 65° C. |
| SS29B17 | PR3B | PVE | Yes | SR11H | NP | NP | −20° C. to 15° C. | 20° C. to 65° C. |
| SS29C17 | PR3C | PVE | Yes | SR11H | NP | NP | −20° C. to 15° C. | 20° C. to 65° C. |
| SS29A19 | PR4 | PVE | Yes | SR11H | NP | NP | −20° C. to 15° C. | 20° C. to 65° C. |
| SS29A20 | PR5 | PVE | Yes | SR11H | NP | NP | −20° C. to 15° C. | 20° C. to 65° C. |
| SS29A21 | PR6 | PVE | Yes | SR11H | NP | NP | −20° C. to 15° C. | 20° C. to 65° C. |
| SS29A22 | PR7 | PVE | Yes | SR11H | NP | NP | −20° C. to 15° C. | 20° C. to 65° C. |
| SS30A1 | PR1A | NR | Yes | SR13H | NP | NP | −20° C. to 15° C. | 20° C. to 65° C. |
| SS30B1 | PR1B | NR | Yes | SR13H | NP | NP | −20° C. to 15° C. | 20° C. to 65° C. |
| SS30C1 | PR1C | NR | Yes | SR13H | NP | NP | −20° C. to 15° C. | 20° C. to 65° C. |
| SS30A2 | PR2A | NR | Yes | SR13H | NP | NP | −20° C. to 15° C. | 20° C. to 65° C. |
| SS30B2 | PR2B | NR | Yes | SR13H | NP | NP | −20° C. to 15° C. | 20° C. to 65° C. |
| SS30C2 | PR2C | NR | Yes | SR13H | NP | NP | −20° C. to 15° C. | 20° C. to 65° C. |
| SS30A3 | PR3A | NR | Yes | SR13H | NP | NP | −20° C. to 15° C. | 20° C. to 65° C. |
| SS30B3 | PR3B | NR | Yes | SR13H | NP | NP | −20° C. to 15° C. | 20° C. to 65° C. |
| SS30C3 | PR3C | NR | Yes | SR13H | NP | NP | −20° C. to 15° C. | 20° C. to 65° C. |
| SS30A4 | PR4 | NR | Yes | SR13H | NP | NP | −20° C. to 15° C. | 20° C. to 65° C. |
| SS30A5 | PR5 | NR | Yes | SR13H | NP | NP | −20° C. to 15° C. | 20° C. to 65° C. |
| SS30A6 | PR6 | NR | Yes | SR13H | NP | NP | −20° C. to 15° C. | 20° C. to 65° C. |
| SS30A7 | PR7 | NR | Yes | SR13H | NP | NP | −20° C. to 15° C. | 20° C. to 65° C. |
| SS30A8 | PR1A | POE | Yes | SR13H | NP | NP | −20° C. to 15° C. | 20° C. to 65° C. |
| SS30B8 | PR1B | POE | Yes | SR13H | NP | NP | −20° C. to 15° C. | 20° C. to 65° C. |
| SS30C8 | PR1C | POE | Yes | SR13H | NP | NP | −20° C. to 15° C. | 20° C. to 65° C. |
| SS30A9 | PR2A | POE | Yes | SR13H | NP | NP | −20° C. to 15° C. | 20° C. to 65° C. |
| SS30B9 | PR2B | POE | Yes | SR13H | NP | NP | −20° C. to 15° C. | 20° C. to 65° C. |
| SS30C9 | PR2C | POE | Yes | SR13H | NP | NP | −20° C. to 15° C. | 20° C. to 65° C. |
| SS30A10 | PR3A | POE | Yes | SR13H | NP | NP | −20° C. to 15° C. | 20° C. to 65° C. |
| SS30B10 | PR3B | POE | Yes | SR13H | NP | NP | −20° C. to 15° C. | 20° C. to 65° C. |
| SS30C10 | PR3C | POE | Yes | SR13H | NP | NP | −20° C. to 15° C. | 20° C. to 65° C. |
| SS30A11 | PR4 | POE | Yes | SR13H | NP | NP | −20° C. to 15° C. | 20° C. to 65° C. |
| SS30A12 | PR5 | POE | Yes | SR13H | NP | NP | −20° C. to 15° C. | 20° C. to 65° C. |
| SS30A13 | PR6 | POE | Yes | SR13H | NP | NP | −20° C. to 15° C. | 20° C. to 65° C. |
| SS30A14 | PR7 | POE | Yes | SR13H | NP | NP | −20° C. to 15° C. | 20° C. to 65° C. |
| SS30A15 | PR1A | PVE | Yes | SR13H | NP | NP | −20° C. to 15° C. | 20° C. to 65° C. |
| SS30B15 | PR1B | PVE | Yes | SR13H | NP | NP | −20° C. to 15° C. | 20° C. to 65° C. |
| SS30C15 | PR1C | PVE | Yes | SR13H | NP | NP | −20° C. to 15° C. | 20° C. to 65° C. |
| SS30A16 | PR2A | PVE | Yes | SR13H | NP | NP | −20° C. to 15° C. | 20° C. to 65° C. |
| SS30B16 | PR2B | PVE | Yes | SR13H | NP | NP | −20° C. to 15° C. | 20° C. to 65° C. |
| SS30C16 | PR2C | PVE | Yes | SR13H | NP | NP | −20° C. to 15° C. | 20° C. to 65° C. |
| SS30A17 | PR3A | PVE | Yes | SR13H | NP | NP | −20° C. to 15° C. | 20° C. to 65° C. |
| SS30B17 | PR3B | PVE | Yes | SR13H | NP | NP | −20° C. to 15° C. | 20° C. to 65° C. |
| SS30C17 | PR3C | PVE | Yes | SR13H | NP | NP | −20° C. to 15° C. | 20° C. to 65° C. |
| SS30A19 | PR4 | PVE | Yes | SR13H | NP | NP | −20° C. to 15° C. | 20° C. to 65° C. |
| SS30A20 | PR5 | PVE | Yes | SR13H | NP | NP | −20° C. to 15° C. | 20° C. to 65° C. |
| SS30A21 | PR6 | PVE | Yes | SR13H | NP | NP | −20° C. to 15° C. | 20° C. to 65° C. |
| SS30A22 | PR7 | PVE | Yes | SR13H | NP | NP | −20° C. to 15° C. | 20° C. to 65° C. |
| SS30A1 | PR1A | NR | Yes | SR13H | NP | NP | −20° C. to 15° C. | 20° C. to 65° C. |
| SS30B1 | PR1B | NR | Yes | SR13H | NP | NP | −20° C. to 15° C. | 20° C. to 65° C. |
| SS30C1 | PR1C | NR | Yes | SR13H | NP | NP | −20° C. to 15° C. | 20° C. to 65° C. |
| SS30A2 | PR2A | NR | Yes | SR13H | NP | NP | −20° C. to 15° C. | 20° C. to 65° C. |
| SS30B2 | PR2B | NR | Yes | SR13H | NP | NP | −20° C. to 15° C. | 20° C. to 65° C. |
| SS30C2 | PR2C | NR | Yes | SR13H | NP | NP | −20° C. to 15° C. | 20° C. to 65° C. |
| SS30A3 | PR3A | NR | Yes | SR13H | NP | NP | −20° C. to 15° C. | 20° C. to 65° C. |
| SS30B3 | PR3B | NR | Yes | SR13H | NP | NP | −20° C. to 15° C. | 20° C. to 65° C. |
| SS30C3 | PR3C | NR | Yes | SR13H | NP | NP | −20° C. to 15° C. | 20° C. to 65° C. |
| SS30A4 | PR4 | NR | Yes | SR13H | NP | NP | −20° C. to 15° C. | 20° C. to 65° C. |
| SS30A5 | PR5 | NR | Yes | SR13H | NP | NP | −20° C. to 15° C. | 20° C. to 65° C. |
| SS30A6 | PR6 | NR | Yes | SR13H | NP | NP | −20° C. to 15° C. | 20° C. to 65° C. |
| SS30A7 | PR7 | NR | Yes | SR13H | NP | NP | −20° C. to 15° C. | 20° C. to 65° C. |
| SS30A8 | PR1A | POE | Yes | SR13H | NP | NP | −20° C. to 15° C. | 20° C. to 65° C. |
| SS30B8 | PR1B | POE | Yes | SR13H | NP | NP | −20° C. to 15° C. | 20° C. to 65° C. |
| SS30C8 | PR1C | POE | Yes | SR13H | NP | NP | −20° C. to 15° C. | 20° C. to 65° C. |
| SS30A9 | PR2A | POE | Yes | SR13H | NP | NP | −20° C. to 15° C. | 20° C. to 65° C. |
| SS30B9 | PR2B | POE | Yes | SR13H | NP | NP | −20° C. to 15° C. | 20° C. to 65° C. |
| SS30C9 | PR2C | POE | Yes | SR13H | NP | NP | −20° C. to 15° C. | 20° C. to 65° C. |
| SS30A10 | PR3A | POE | Yes | SR13H | NP | NP | −20° C. to 15° C. | 20° C. to 65° C. |
| SS30B10 | PR3B | POE | Yes | SR13H | NP | NP | −20° C. to 15° C. | 20° C. to 65° C. |
| SS30C10 | PR3C | POE | Yes | SR13H | NP | NP | −20° C. to 15° C. | 20° C. to 65° C. |
| SS30A11 | PR4 | POE | Yes | SR13H | NP | NP | −20° C. to 15° C. | 20° C. to 65° C. |
| SS30A12 | PR5 | POE | Yes | SR13H | NP | NP | −20° C. to 15° C. | 20° C. to 65° C. |
| SS30A13 | PR6 | POE | Yes | SR13H | NP | NP | −20° C. to 15° C. | 20° C. to 65° C. |
| SS30A14 | PR7 | POE | Yes | SR13H | NP | NP | −20° C. to 15° C. | 20° C. to 65° C. |
| SS30A15 | PR1A | PVE | Yes | SR13H | NP | NP | −20° C. to 15° C. | 20° C. to 65° C. |
| SS30B15 | PR1B | PVE | Yes | SR13H | NP | NP | −20° C. to 15° C. | 20° C. to 65° C. |
| SS30C15 | PR1C | PVE | Yes | SR13H | NP | NP | −20° C. to 15° C. | 20° C. to 65° C. |
| SS30A16 | PR2A | PVE | Yes | SR13H | NP | NP | −20° C. to 15° C. | 20° C. to 65° C. |
| SS30B16 | PR2B | PVE | Yes | SR13H | NP | NP | −20° C. to 15° C. | 20° C. to 65° C. |
| SS30C16 | PR2C | PVE | Yes | SR13H | NP | NP | −20° C. to 15° C. | 20° C. to 65° C. |
| SS30A17 | PR3A | PVE | Yes | SR13H | NP | NP | −20° C. to 15° C. | 20° C. to 65° C. |
| SS30B17 | PR3B | PVE | Yes | SR13H | NP | NP | −20° C. to 15° C. | 20° C. to 65° C. |
| SS30C17 | PR3C | PVE | Yes | SR13H | NP | NP | −20° C. to 15° C. | 20° C. to 65° C. |
| SS30A19 | PR4 | PVE | Yes | SR13H | NP | NP | −20° C. to 15° C. | 20° C. to 65° C. |
| SS30A20 | PR5 | PVE | Yes | SR13H | NP | NP | −20° C. to 15° C. | 20° C. to 65° C. |
| SS30A21 | PR6 | PVE | Yes | SR13H | NP | NP | −20° C. to 15° C. | 20° C. to 65° C. |
| SS30A22 | PR7 | PVE | Yes | SR13H | NP | NP | −20° C. to 15° C. | 20° C. to 65° C. |

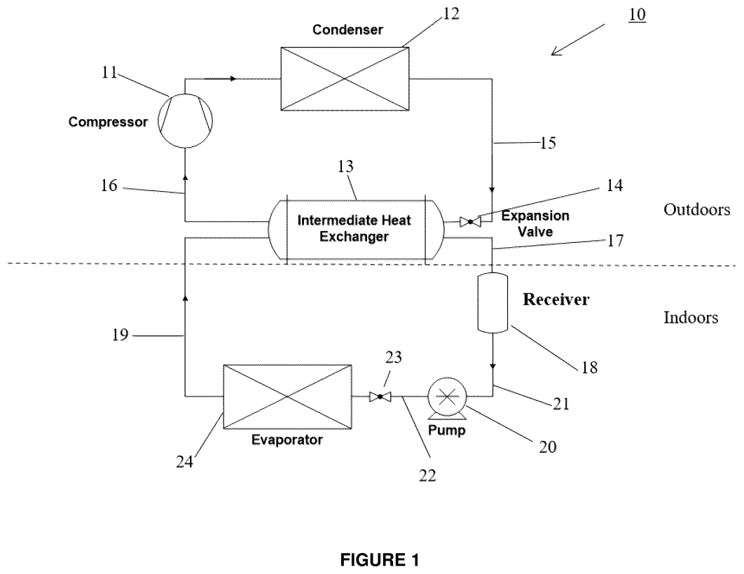

### III. Secondary Circuit Systems as Shown in FIG. 1

In the following descriptions, components or elements of the system which are or can be generally the same or similar in different embodiments are designated with the same number or symbol.

One preferred air conditioning system, designated generally at 10, is illustrated in FIG. 1, wherein the dotted line represents the approximate boundary between the indoor and the outdoor loops, with the compressor 11, condenser 12, intermediate heat exchanger 13 and expansion valve 14, together with any of the associated conduits 15 and 16 and other connecting and related equipment (not shown) being located outdoors. The outdoor loop, which is also sometimes referred to herein as the “high temperature circuit,” preferably comprises a first heat transfer composition, preferably according to one or more of the heat transfer compositions described in Table 2 above, comprising a first refrigerant and lubricant for the compressor, with at least the first refrigerant circulating in the circuit by way of a conduits 15 and 16 and other related conduits and equipment. The first refrigerant may be any of the refrigerant compositions described in Table 1 above.

The indoor loop, which is also sometimes referred to herein as the “low temperature circuit,” preferably comprises at least a second heat transfer composition comprising a second refrigerant, preferably selected from the compositions listed in Table 3 which are both described above. Preferably said second refrigerant has at least one safety property, such as flammability and toxicity, that is superior to the corresponding safety property of the first refrigerant. In highly preferred embodiments, the second refrigerant is preferably of sufficiently low toxicity to be designated as Class A according to ASHRAE Standard 34 2022, and also preferably is of sufficiently low flammability to have a Class 1 or 2L flammability rating. In preferred embodiments, the second refrigerant or heat transfer composition comprises R1234ze(E) and R1234ze(Z), and in some embodiments also comprises one or more of R227ea, R1336mzz(E), and R1224yd(Z). Those skilled in the art will appreciate in view of the disclosures contained herein that such embodiments of the present disclosure provide the advantage of utilizing only the relatively safe (low toxicity and low flammability) low GWP refrigerants, such as those described in Section II above, in a location proximate to the humans or other animals occupying the dwelling or entering the conditioned space, while separating from the humans or animals who are or might be in the dwelling or conditioned space, from the first refrigerant. Accordingly, the preferred configurations and selection of refrigerants permit the provision of systems which benefit from the use of refrigerants that have many desirable properties, such as capacity, efficiency, low GWP and low ODP, but at the same time, possess one or more properties which would otherwise make them highly disadvantageous and/or preclude their use in proximity to the humans or other animals in a confined and/or closed location. Such combinations provide exceptional advantages in terms of all of the above-noted desirable properties for such refrigerant systems.

In operation, the second refrigerant according to the present disclosure circulates through the circuit by flowing through the intermediate heat exchanger 13, wherein it transfers heat to the first refrigerant, and in so doing, condenses at least a portion, and preferably substantially all of the second refrigerant to liquid form where it exits the intermediate heat exchanger through conduit 17. In preferred embodiments, the second refrigerant exiting the intermediate heat exchanger enters a receiver 18, wherein a liquid reservoir of the second refrigerant is provided. Although receiver 18 is shown in the Figure as being located indoors, this vessel may also be located outdoors, and it may also be preferred to locate pump 20, when present, outdoors. Liquid refrigerant from the separation vessel is conducted to the evaporator via conduit 21. In the illustration shown in FIG. 1, a liquid pump 20 is shown as assisting in the transport of the liquid refrigerant through conduits 21, 22 and valve 23 to the evaporator 24. However, in other embodiments the second refrigerant liquid can be transported from the receiver using other means or techniques that can be used either alone or in combination with a liquid pump. For example, in some embodiments transport of the liquid refrigerant may be accomplished by using a gravity feed of the liquid to the evaporator, while in other embodiments, a thermal siphon arrangement can be utilized to transport the second liquid refrigerant to the evaporator 24 and from the evaporator to the intermediate heat exchanger 13.

In preferred embodiments, the operating conditions in cooling mode correspond to the values described in the tables below:

TABLE 5
High Temperature Circuit Conditions
First (High Temperature) Circuit

| | Preferred Temperature |
|---|---|
| Component | Range (° C.) |
| Compressor suction | 0-30 |
| Compressor discharge | 20-135 |
| Condenser | 10-60 |
| Intermediate heat exchanger discharge | 0-15 |

TABLE 6
Low Temperature Circuit Conditions
Second (Low Temperature) Circuit

| | Preferred Temperature |
|---|---|
| Component | Range (° C.) |
| Receiver discharge | 0-15 |
| Evaporator | 0-15 |
| Intermediate heat exchanger inlet | 0-15 |

In preferred embodiments, the operating conditions in heating mode correspond to the values described in the tables below:

TABLE 7
Preferred High Temperature Circuit Conditions
First (High Temperature) Circuit

| | Preferred Temperature |
|---|---|
| Component | Range (° C.) |
| Compressor suction | 0-15 |
| Compressor discharge | 20-120 |
| Evaporator | 0-15 |
| Intermediate heat exchanger discharge | 30-50 |

TABLE 8
Preferred Low Temperature Circuit Conditions
Second (Low Temperature) Circuit

| | Preferred Temperature |
|---|---|
| Component | Range (° C.) |
| Receiver discharge | 30-50 |
| Condenser | 30-50 |
| Intermediate heat exchanger inlet | 30-50 |

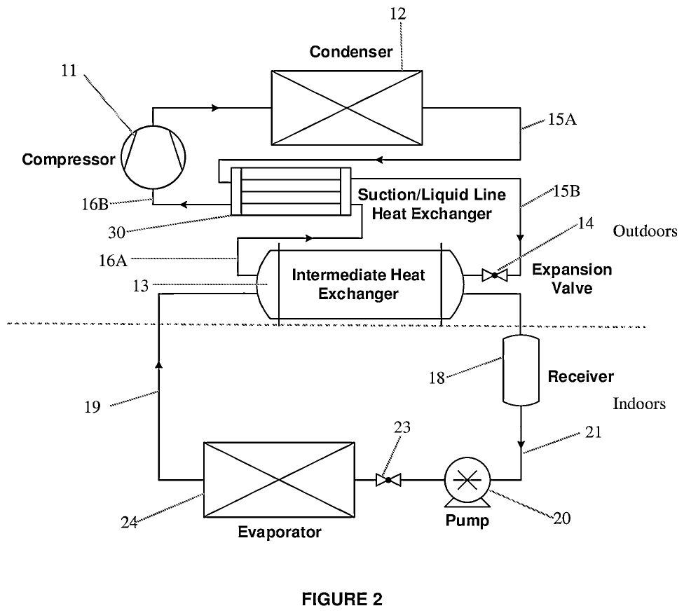

### IV. Secondary Circuit Systems with Suction/Liquid Line Heat Exchanger as Shown in FIG. 2

Another preferred embodiment of the present disclosure is illustrated in FIG. 2, with the compressor 11, condenser 12, intermediate heat exchanger 13, expansion valve 14, and suction-line heat exchanger 30, together with any of the associated conduits 15A, 15B, 16A and 16B and other connecting and related equipment (not shown) being located outdoors. The outdoor loop, which is also sometimes referred to herein as the “high temperature refrigerant circuit,” preferably comprises a first heat transfer composition comprising a first refrigerant and lubricant for the compressor, with at least the refrigerant circulating in the circuit by way of a conduits 15A, 15B 16A, and 16B and other related conduits and equipment. The first refrigerant may be any of the primary refrigerant compositions described in Table 1 above and the heat transfer composition may be any heat transfer composition described in Table 2.

The indoor loop is configured substantially the same as described above in connection with the indoor loop of FIG. 1, and the first and second heat transfer compositions are also preferably as otherwise indicated herein. Preferred secondary refrigerant compositions are provided in Table 3 above.

In operation, the first refrigerant according to the present disclosure is discharged from compressor 11 as a relatively high pressure refrigerant vapor, which may include entrained lubricant, and which then enters condenser 12 where it transfers heat, preferably to ambient air, and at least partially condenses. The refrigerant effluent from the condenser 12 is transported via conduit 15A to suction-line heat exchanger 30 where it loses additional heat to the effluent from the intermediate heat exchanger 13. The effluent from the suction/liquid line heat exchanger 30 is then transported via conduit 15B to expansion valve 14 where the pressure of the refrigerant 1s reduced, which in turn reduces the temperature of the refrigerant. The relatively cold liquid refrigerant from the expansion valve then enters the intermediate heat exchanger 13 where it gains heat from the second refrigerant vapor leaving the evaporator 24 in the indoor loop. The first refrigerant effluent vapor from the intermediate heat exchanger is then transported via conduit 16A to the suction/liquid line heat exchanger 30 where it gains heat from the condenser effluent from conduit 15A and produces second refrigerant vapor at a higher temperature, which is transported by conduit 16B to the inlet of the compressor 11.

The evaporator effluent is transported receiver conduit 19 to the intermediate heat exchanger 13 where it loses heat to the effluent from the suction line heat exchanger, which is transported to the intermediate heat exchanger via conduit 15B and produces a relatively cold stream of the second refrigerant. This cold stream of second refrigerant exiting from the intermediate heat exchanger 13 is transported to receiver tank 18 which provides a reservoir of cold liquid refrigerant which is transported from the tank via conduit 21 and is then fed by way of control valve 23 into the evaporator 24. In some embodiments a pump 20 is provided to provide a flow of liquid to the control valve 23. Ambient air to be cooled loses heat to the cold liquid refrigerant in the evaporator 24, which in turn vaporizes the liquid refrigerant and produces refrigerant vapor with little or no super heat, and this vapor then flows back to the intermediate heat exchanger 13.

In preferred embodiments, the operating conditions in cooling mode correspond to the values described in the table below:

TABLE 9
High Temperature Circuit Conditions
First (High Temperature) Circuit

| | Preferred Temperature |
|---|---|
| Component | Range (° C.) |
| Compressor suction | 0-15 |
| Compressor discharge | 20-120 |
| Condenser | 10-60 |
| Intermediate heat exchanger discharge | 0-15 |

TABLE 10
Low Temperature Circuit Conditions
Second (Low Temperature) Circuit

| | Preferred Temperature |
|---|---|
| Component | Range (° C.) |
| Receiver discharge | 0-15 |
| Evaporator | 0-15 |
| Intermediate heat exchanger inlet | 0-15 |

In preferred embodiments, the operating conditions in heating mode correspond to the values described in the tables below:

TABLE 11
Preferred High Temperature Circuit Conditions
First (High Temperature) Circuit

| | Preferred Temperature |
|---|---|
| Component | Range (° C.) |
| Compressor suction | 0-15 |
| Compressor discharge | 20-120 |
| Evaporator | 0-15 |
| Intermediate heat exchanger discharge | 30-50 |

TABLE 12
Preferred Low Temperature Circuit Conditions
Second (Low Temperature) Circuit

| | Preferred Temperature |
|---|---|
| Component | Range (° C.) |
| Receiver discharge | 30-50 |
| Condenser | 30-50 |
| Intermediate heat exchanger inlet | 30-50 |

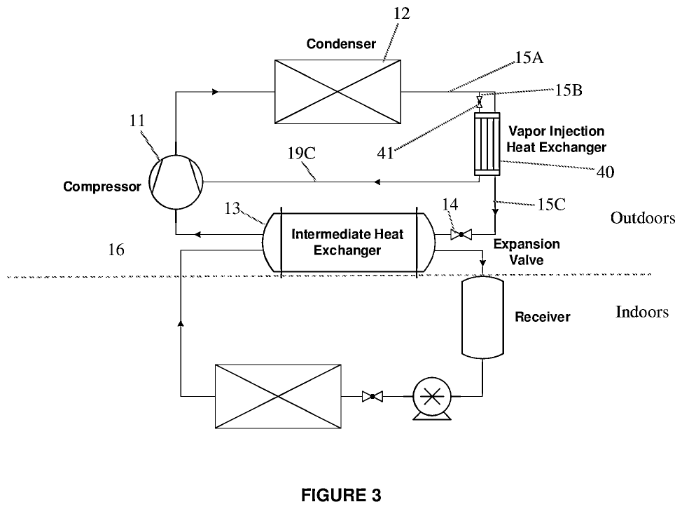

### V. Secondary Circuit Systems with Vapor Injection Heat Exchanger as Shown in FIG. 3

Another preferred embodiment of the present disclosure is illustrated in FIG. 3, with the two-stage compressor 11, condenser 12, intermediate heat exchanger 13, expansion valve 14, and vapor-injection heat exchanger 40, including associated intermediate expansion valve 41, together with any of the associated conduits 15A-15C and other connecting and related equipment (not shown and/or not labeled), being located outdoors. The outdoor loop, which is also sometimes referred to herein as the “high temperature refrigerant circuit,” preferably comprises a first heat transfer composition comprising a first refrigerant and lubricant for the compressor, with at least the refrigerant circulating in the circuit by way of a conduits 15 and 16 and other related conduits and equipment. The first refrigerant composition may be any of the refrigerant compositions described in Table 1 above. The first heat transfer composition may be any of the heat transfer compositions in Table 2.

The indoor loop is configured substantially the same as described above in connection with the indoor loop of FIG. 1, and the first and second heat transfer compositions are also preferably as otherwise indicated herein.

In operation, the first refrigerant according to the present disclosure, which may include entrained lubricant, is discharged from compressor 11 as a relatively high pressure refrigerant vapor, which may include entrained lubricant, and which then enters condenser 12 where is its transfers heat, preferably to ambient air and at least partially condenses. The effluent stream from the condenser 12 comprising at least partially, and preferably substantially fully, condensed refrigerant. The refrigerant effluent from the condenser 12 is transported via conduit 15A, and a portion of the refrigerant effluent is routed via conduit 15B to an intermediate expansion device 41 and another portion of the effluent, preferably the remainder of the effluent, is transported to the vapor injection heat exchanger 40.

The intermediate expansion device 41 lets the pressure of the effluent stream down, preferably substantially isoenthalpically, to about the pressure of the second stage suction of compressor 11 or sufficiently above such pressure to account for the pressure-drop through the heat exchanger 41 and associated conduits, fixtures and the like. As a result of the pressure drop across the expansion device 41, the pressure of the refrigerant flowing to the heat exchanger 40 is reduced relative to the temperature of the high pressure refrigerant which flows to the heat exchanger 40. Heat is transferred in the heat exchanger 40 from the high pressure stream to the stream that passed through the expansion valve 41. As a result, the temperature of the intermediate pressure stream which exits the heat exchanger 40 is higher, than the temperature of the inlet stream, thereby producing a super-heated vapor stream that is transported to the second stage of the compressor 11 via conduit I 9C.

As the higher pressure stream transported by conduit 15A travels through the heat exchanger 40 it loses heat to the lower pressure stream exiting expansion device 41 and exits the heat exchanger through conduit 15C and then flows to expansion device 14 and is heat then forwarded to the intermediate heat exchanger where it gains heat and is transported to the first stage of the compressor suction.

In preferred embodiments, the operating conditions correspond to the values described in the table below:

TABLE 13
High Temperature Circuit Conditions
First (High Temperature) Circuit

| | Preferred Temperature |
|---|---|
| Component | Range (° C.) |
| Compressor suction - 1^{st} stage | 0-15 |
| Compressor suction - 2^{nd} stage | 0-15 |
| Compressor discharge-1^{st} stage | 20-120 |
| Compressor discharge-2^{nd} stage | 20-120 |
| Condenser | 10-60 |
| Intermediate Heat Exchanger | 0-15 |

TABLE 14
Low Temperature Circuit Conditions
Second (Low Temperature) Circuit

| | Preferred Temperature |
|---|---|
| Component | Range (° C.) |
| Receiver discharge | 0-15 |
| Evaporator | 0-15 |
| Intermediate heat exchanger inlet | 0-15 |

In preferred embodiments, the operating conditions in heating mode correspond to the values described in the tables below:

TABLE 15
Preferred High Temperature Circuit Conditions
First (High Temperature) Circuit

| | Preferred Temperature |
|---|---|
| Component | Range (° C.) |
| Compressor suction - 1^{st} stage | 0-15 |
| Compressor suction - 2^{nd} stage | 0-15 |
| Compressor discharge | 20-120 |
| Evaporator | 0-15 |
| Intermediate heat exchanger discharge | 30-50 |

TABLE 16
Preferred Low Temperature Circuit Conditions
Second (Low Temperature) Circuit

| | Preferred Temperature |
|---|---|
| Component | Range (° C.) |
| Receiver discharge | 30-50 |
| Condenser | 30-50 |
| Intermediate heat exchanger inlet | 30-50 |

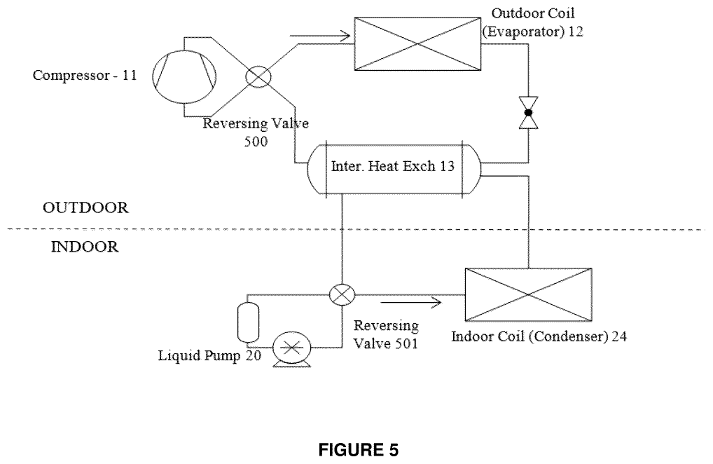

### VI. Secondary Circuit Systems with Reversible Valve as Shown in FIG. 5

In the following descriptions, components or elements of the system, which are or can be generally the same or similar in different embodiments are designated with the same number or symbol.

The embodiment disclosed in FIG. 5 is similar to the embodiment of FIG. 1 except the system is equipped with a reversible valve so that it can operate in a heating mode, as described below.

One preferred air conditioning system operable in both a cooling and heating mode is designated generally at 10, is illustrated in FIG. 1, wherein the indicated line represents the approximate boundary between the indoor and the outdoor loops, with the compressor 11, outdoor coil 12, intermediate heat exchanger 13, expansion valve 14, and reversing valve 500, together with any of the associated conduits 15 and 16 and other connecting and related equipment (not shown) being located outdoors. The outdoor loop preferably comprises a first heat transfer composition, preferably according to one or more of the preferred embodiments described above, comprising a first refrigerant and lubricant for the compressor, with at least the first refrigerant circulating in the circuit by way of a conduits 15 and 16 and other related conduits and equipment. The first refrigerant composition may be any of the refrigerant compositions described in Table 1 above. The first heat transfer composition may be any of the heat transfer compositions in Table 2.

The indoor loop preferably comprises at least a second heat transfer composition comprising a second refrigerant, wherein said second refrigerant has at least one safety property, such as flammability and toxicity, that is superior to the corresponding safety property of the first refrigerant. In highly preferred embodiments, the second refrigerant is preferably of sufficiently low toxicity to be designated as Class A according to ASHRAE Standard 34, and also preferably is of sufficiently low flammability to have a Class 1 or 2L flammability rating. The secondary refrigerant may be any of the refrigerants described in Table 3 above.

In preferred embodiments, the second refrigerant or heat transfer composition comprises R1234ze(E) and R123ze(Z), and in some embodiments also comprises R227ea, R1226mzz(E), and/or R1224yd(Z). Those skilled in the art will appreciate in view of the disclosures contained herein that such embodiments of the present disclosure provide the advantage of utilizing only the relatively safe (low toxicity and low flammability) low GWP refrigerants, such as those described in Section II above, in a location proximate to the humans or other animals occupying the dwelling or entering the conditioned space, while separating from the humans or animals who are or might be in the dwelling or conditioned space, from the first refrigerant. Accordingly, the preferred configurations and selection of refrigerants permit the provision of systems which benefit from the use of refrigerants that have many desirable properties, such as capacity, efficiency, low GWP and low ODP, but at the same time, possess one or more properties which would otherwise make them highly disadvantageous and/or preclude their use in proximity to the humans or other animals in a confined and/or closed location. Such combinations provide exceptional advantages in terms of all the desirably properties for such refrigerant systems.

The second heat transfer compositions generally comprise a second refrigerant of the present invention and a lubricant. Preferred heat transfer compositions are provided in Table 2 above. In preferred embodiments, the heat transfer composition comprises a lubricant in an amount as low as 0.1 wt. %, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, 15 wt. %, 20 wt. %, 25 wt. %, 30 wt. %, or within any range encompassed by any two of the foregoing values as endpoints, based on the total weight of the heat transfer composition.

Other optional components that may be included in the heat transfer composition include a compatibilizer, such as propane, for the purpose of aiding compatibility and/or solubility of the lubricant. When present, such compatibilizers, including propane, butanes and pentanes, are preferably present in amounts of from about 0.5 to about 5 percent by weight of the composition. Combinations of surfactants and solubilizing agents may also be added to the present compositions to aid oil solubility, as disclosed by U.S. Pat. No. 6,516,837, the disclosure of which is incorporated by reference. Commonly used refrigeration lubricants such as polyol esters (POEs), polyvinyl ethers (PVEs), and poly alkylene glycols (PAGs), silicone oil, mineral oil, alkyl benzenes (ABs) and poly(alpha-olefins) (PAOs) that are used in refrigeration machinery with hydrofluorocarbon (HFC) refrigerants may be used with the refrigerant compositions of the present disclosure. The preferred lubricants are POEs.

In operation, the second refrigerant according to the heating mode embodiment of FIG. 5 of the present disclosure circulates through the circuit by flowing through the intermediate heat exchanger 13, wherein it picks-up heat from the first refrigerant, and in so doing, vaporizes at least a portion, and preferably substantially all of the second refrigerant to vapor form where it exits the intermediate heat exchanger through conduit 17. Vaporous refrigerant is conducted to the condenser via conduit 21 where it rejects heat into the dwelling as it condenses. In the illustration shown in FIG. 1, a liquid pump 20 is shown as assisting in the transport of the liquid refrigerant through conduits 21, 22 and valve 23 to the condenser 24. In addition, this indoor loop also includes a reversible valve 501 which allows the system to operate in both the heating and the cooling mode.

### EXAMPLES

In the following Examples, a series of primary and secondary fluids were evaluated based on several criteria. The compositions of the primary fluids H1-H4 and secondary fluids L1-L5 are given in Table 9 below.

For each of the fluid blends, the following criteria were evaluated:

Boiling point: the preferred boiling point range is 0-6° C., more preferably 3.9-6° C.

Full Evaporator glide: the preferred full evaporator glide is less than 5.5° C. (to avoid performance reduction), more preferably less than 4.0° C. and most preferably less than 2.5° C.

Flammability: non-flammable fluids are preferred (low temperature stage fluid)

Figures of merit: capacity and pumping power.

TABLE 9
Compositions of Interest for Primary and Secondary Refrigerants
Primary Refrigerant

| Refrigerant ID | Ingredients | Amount (wt. %) |
|---|---|---|
| PR4 (R454C) | R32 | 21.5 |
| | R1234yf | 78.5 |
| PR5 (HDR159) | R32 | 21.5 |
| | R1234yf | 72.5 |
| | R161 | 6 |
| PR6 (Propane) | Propane | 100 |
| PR7 (R455A) | R32 | 21.5 |
| | R1234yf | 75.5 |
| | CO₂ | 3 |

Secondary Refrigerants

| Fluid ID | Ingredients | Amount (wt. %) |
|---|---|---|
| R471A | R1234ze(E) | 78.7 |
| | 1336mzz(E) | 17 |
| | R227ea | 4.3 |
| R476A | R134a | 10% |
| | R1234ze(E) | 78% |
| | 1336mzz(E) | 12% |
| R482A | R134a | 10% |
| | R1234ze(E) | 83.5% |
| | 1224yd(Z) | 6.5% |
| L1 | R1234ze(Z) | 62 |
| | 1336mzz(E) | 33 |
| | R1234ze(E) | 5 |
| L2 | R1234ze(Z) | 60.6 |
| | 1336mzz(E) | 32 |

Primary Refrigerant

| Refrigerant ID | Ingredients | Amount (wt. %) |
|---|---|---|
| | R1234ze(E) | 3 |
| | R227ea | 4.4 |
| L3 | R1234ze(Z) | 75 |
| | 1224yd(Z) | 16 |
| | R1234ze(E) | 9 |
| L4 | R1234ze(Z) | 77.6 |
| | 1224yd(Z) | 12 |
| | R1234ze(E) | 6 |
| | R227ea | 4.4 |
| L5 | R1234ze(Z) | 40 |
| | R1234ze(E) | 10 |
| | R245fa | 5 |
| | R1233zd | 45 |
| L6 | R1234ze(Z) | 34 |
| | R1234ze(E) | 11 |
| | R245fa | 5 |
| | R1233zd | 50 |
| L7 | R1234ze(Z) | 53 |
| | R1234ze(E) | 10 |
| | R245fa | 10 |
| | R1233zd | 27 |
| L8 | R1234ze(Z) | 42 |
| | R1234ze(E) | 13 |
| | R245fa | 10 |
| | R1233zd | 35 |
| L9 | R1234ze(Z) | 60 |
| | R1234ze(E) | 10.5 |
| | R245fa | 14.5 |

Primary Refrigerant

| Refrigerant ID | Ingredients | Amount (wt. %) |
|---|---|---|
| | R1233zd | 15 |
| L10 | R1234ze(Z) | 42 |
| | R1234ze(E) | 13.5 |
| | R245fa | 14.5 |
| | R1233zd | 30 |

The following table provides suitable applications for combinations of primary refrigerants and secondary refrigerants (with each column in the Table 10 below referring to such refrigerants as defined in Table 9 above).

TABLE 10
Fluid Applications

| Primary | Secondary | |
|---|---|---|
| Refrigerant | Refrigerant | Application |
| PR4 | R471A | Residential AC |
| PR4 | R471A | Residential Heat Pump |
| PR4 | R476A | Residential AC |
| PR4 | R476A | Residential Heat Pump |
| PR4 | R482A | Residential AC |
| PR4 | R482A | Residential Heat Pump |
| PR4 | L1 | Residential AC |
| PR4 | L1 | Residential Heat Pump |
| PR4 | L2 | Residential AC |
| PR4 | L2 | Residential Heat Pump |
| PR4 | L3 | Residential AC |
| PR4 | L3 | Residential Heat Pump |
| PR4 | L4 | Residential AC |
| PR4 | L4 | Residential Heat Pump |
| PR4 | L5 | Residential AC |
| PR4 | L5 | Residential Heat Pump |
| PR4 | L6 | Residential AC |
| PR4 | L6 | Residential Heat Pump |
| PR4 | L7 | Residential AC |
| PR4 | L7 | Residential Heat Pump |
| PR4 | L8 | Residential AC |
| PR4 | L8 | Residential Heat Pump |
| PR4 | L9 | Residential AC |
| PR4 | L9 | Residential Heat Pump |
| PR4 | L10 | Residential AC |
| PR4 | L10 | Residential Heat Pump |
| PR5 | R471A | Residential AC |
| PR5 | R471A | Residential Heat Pump |
| PR5 | R476A | Residential AC |
| PR5 | R476A | Residential Heat Pump |
| PR5 | R482A | Residential AC |
| PR5 | R482A | Residential Heat Pump |
| PR5 | L1 | Residential AC |
| PR5 | L1 | Residential Heat Pump |
| PR5 | L2 | Residential AC |
| PR5 | L2 | Residential Heat Pump |
| PR5 | L3 | Residential AC |
| PR5 | L3 | Residential Heat Pump |
| PR5 | L4 | Residential AC |
| PR5 | L4 | Residential Heat Pump |
| PR5 | L5 | Residential AC |
| PR5 | L5 | Residential Heat Pump |
| PR5 | L6 | Residential AC |
| PR5 | L6 | Residential Heat Pump |
| PR5 | L7 | Residential AC |
| PR5 | L7 | Residential Heat Pump |
| PR5 | L8 | Residential AC |
| PR5 | L8 | Residential Heat Pump |
| PR5 | L9 | Residential AC |
| PR5 | L9 | Residential Heat Pump |
| PR5 | L10 | Residential AC |
| PR5 | L10 | Residential Heat Pump |
| PR6 | R471A | Residential AC |
| PR6 | R471A | Residential Heat Pump |
| PR6 | R476A | Residential AC |
| PR6 | R476A | Residential Heat Pump |
| PR6 | R482A | Residential AC |
| PR6 | R482A | Residential Heat Pump |
| PR6 | L1 | Residential AC |
| PR6 | L1 | Residential Heat Pump |
| PR6 | L2 | Residential AC |
| PR6 | L2 | Residential Heat Pump |
| PR6 | L3 | Residential AC |
| PR6 | L3 | Residential Heat Pump |
| PR6 | L4 | Residential AC |
| PR6 | L4 | Residential Heat Pump |
| PR6 | L5 | Residential AC |
| PR6 | L5 | Residential Heat Pump |
| PR6 | L6 | Residential AC |
| PR6 | L6 | Residential Heat Pump |
| PR6 | L7 | Residential AC |
| PR6 | L7 | Residential Heat Pump |
| PR6 | L8 | Residential AC |
| PR6 | L8 | Residential Heat Pump |
| PR6 | L9 | Residential AC |
| PR6 | L9 | Residential Heat Pump |
| PR6 | L10 | Residential AC |
| PR6 | L10 | Residential Heat Pump |
| PR7 | R471A | Residential AC |
| PR7 | R471A | Residential Heat Pump |
| PR7 | R476A | Residential AC |
| PR7 | R476A | Residential Heat Pump |
| PR7 | R482A | Residential AC |
| PR7 | R482A | Residential Heat Pump |
| PR7 | L1 | Residential AC |
| PR7 | L1 | Residential Heat Pump |
| PR7 | L2 | Residential AC |
| PR7 | L2 | Residential Heat Pump |
| PR7 | L3 | Residential AC |
| PR7 | L3 | Residential Heat Pump |
| PR7 | L4 | Residential AC |
| PR7 | L4 | Residential Heat Pump |
| PR7 | L5 | Residential AC |
| PR7 | L5 | Residential Heat Pump |
| PR7 | L6 | Residential AC |
| PR7 | L6 | Residential Heat Pump |
| PR7 | L7 | Residential AC |
| PR7 | L7 | Residential Heat Pump |
| PR7 | L8 | Residential AC |
| PR7 | L8 | Residential Heat Pump |
| PR7 | L9 | Residential AC |
| PR7 | L9 | Residential Heat Pump |
| PR7 | L10 | Residential AC |
| PR7 | L10 | Residential Heat Pump |
| PR4 | R471A | Commercial AC |
| PR4 | R471A | Commercial Heat Pump |
| PR4 | R476A | Commercial AC |
| PR4 | R476A | Commercial Heat Pump |
| PR4 | R482A | Commercial AC |
| PR4 | R482A | Commercial Heat Pump |
| PR4 | L1 | Commercial AC |
| PR4 | L1 | Commercial Heat Pump |
| PR4 | L2 | Commercial AC |
| PR4 | L2 | Commercial Heat Pump |
| PR4 | L3 | Commercial AC |
| PR4 | L3 | Commercial Heat Pump |
| PR4 | L4 | Commercial AC |
| PR4 | L4 | Commercial Heat Pump |
| PR4 | L5 | Commercial AC |
| PR4 | L5 | Commercial Heat Pump |
| PR4 | L6 | Commercial AC |
| PR4 | L6 | Commercial Heat Pump |
| PR4 | L7 | Commercial AC |
| PR4 | L7 | Commercial Heat Pump |
| PR4 | L8 | Commercial AC |
| PR4 | L8 | Commercial Heat Pump |
| PR4 | L9 | Commercial AC |
| PR4 | L9 | Commercial Heat Pump |
| PR4 | L10 | Commercial AC |
| PR4 | L10 | Commercial Heat Pump |
| PR5 | R471A | Commercial AC |
| PR5 | R471A | Commercial Heat Pump |
| PR5 | R476A | Commercial AC |
| PR5 | R476A | Commercial Heat Pump |
| PR5 | R482A | Commercial AC |
| PR5 | R482A | Commercial Heat Pump |
| PR5 | L1 | Commercial AC |
| PR5 | L1 | Commercial Heat Pump |
| PR5 | L2 | Commercial AC |
| PR5 | L2 | Commercial Heat Pump |
| PR5 | L3 | Commercial AC |
| PR5 | L3 | Commercial Heat Pump |
| PR5 | L4 | Commercial AC |
| PR5 | L4 | Commercial Heat Pump |
| PR5 | L5 | Commercial AC |
| PR5 | L5 | Commercial Heat Pump |
| PR5 | L6 | Commercial AC |
| PR5 | L6 | Commercial Heat Pump |
| PR5 | L7 | Commercial AC |
| PR5 | L7 | Commercial Heat Pump |
| PR5 | L8 | Commercial AC |
| PR5 | L8 | Commercial Heat Pump |
| PR5 | L9 | Commercial AC |
| PR5 | L9 | Commercial Heat Pump |
| PR5 | L10 | Commercial AC |
| PR5 | L10 | Commercial Heat Pump |
| PR6 | R471A | Commercial AC |
| PR6 | R471A | Commercial Heat Pump |
| PR6 | R476A | Commercial AC |
| PR6 | R476A | Commercial Heat Pump |
| PR6 | R482A | Commercial AC |
| PR6 | R482A | Commercial Heat Pump |
| PR6 | L1 | Commercial AC |
| PR6 | L1 | Commercial Heat Pump |
| PR6 | L2 | Commercial AC |
| PR6 | L2 | Commercial Heat Pump |
| PR6 | L3 | Commercial AC |
| PR6 | L3 | Commercial Heat Pump |
| PR6 | L4 | Commercial AC |
| PR6 | L4 | Commercial Heat Pump |
| PR6 | L5 | Commercial AC |
| PR6 | L5 | Commercial Heat Pump |
| PR6 | L6 | Commercial AC |
| PR6 | L6 | Commercial Heat Pump |
| PR6 | L7 | Commercial AC |
| PR6 | L7 | Commercial Heat Pump |
| PR6 | L8 | Commercial AC |
| PR6 | L8 | Commercial Heat Pump |
| PR6 | L9 | Commercial AC |
| PR6 | L9 | Commercial Heat Pump |
| PR6 | L10 | Commercial AC |
| PR6 | L10 | Commercial Heat Pump |
| PR7 | R471A | Commercial AC |
| PR7 | R471A | Commercial Heat Pump |
| PR7 | R476A | Commercial AC |
| PR7 | R476A | Commercial Heat Pump |
| PR7 | R482A | Commercial AC |
| PR7 | R482A | Commercial Heat Pump |
| PR7 | L1 | Commercial AC |
| PR7 | L1 | Commercial Heat Pump |
| PR7 | L2 | Commercial AC |
| PR7 | L2 | Commercial Heat Pump |
| PR7 | L3 | Commercial AC |
| PR7 | L3 | Commercial Heat Pump |
| PR7 | L4 | Commercial AC |
| PR7 | L4 | Commercial Heat Pump |
| PR7 | L5 | Commercial AC |
| PR7 | L5 | Commercial Heat Pump |
| PR7 | L6 | Commercial AC |
| PR7 | L6 | Commercial Heat Pump |
| PR7 | L7 | Commercial AC |
| PR7 | L7 | Commercial Heat Pump |
| PR7 | L8 | Commercial AC |
| PR7 | L8 | Commercial Heat Pump |
| PR7 | L9 | Commercial AC |
| PR7 | L9 | Commercial Heat Pump |
| PR7 | L10 | Commercial AC |
| PR7 | L10 | Commercial Heat Pump |

### Example 1A: Thermodynamic Performance of a Mini-Secondary Cycle—Basic Cycle

The following examples highlight the unique benefits and characteristics of the mini-secondary systems in accordance with the present disclosure.

A mini-secondary system can match the efficiency of R410A with system design changes while using an ultra-low GWP, non-flammable refrigerant inside the home. Mini-secondary system shows higher efficiency than a R410A at high ambient conditions.

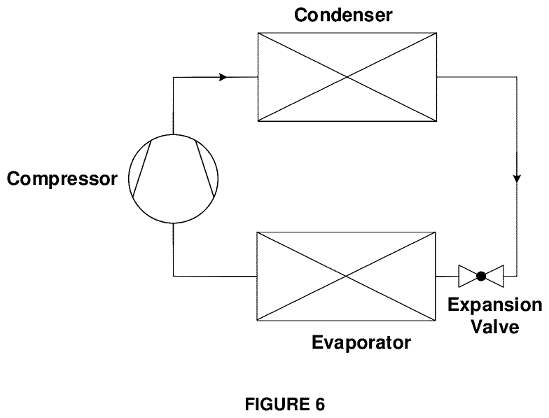

Operating conditions for a R410A basic cycle, shown by the schematic in FIG. 6, are provided below:
1. Condensing temperature=45° C., corresponding outdoor ambient temperature=35° C.
2. Condensing Temperature—Ambient Temperature=10° C.
3. Expansion device sub-cooling=5.0° C.
4. Evaporating temperature=7° C., corresponding indoor room temperature=27° C.
5. Evaporator Superheat=5.0° C.
6. Isentropic Efficiency=72%
7. Volumetric Efficiency=98%

Operating conditions for a mini-secondary cycle, shown by the schematic in FIG. 1, are provided below:
1. Condensing temperature=45° C., corresponding outdoor ambient temperature=35° C.
2. Condensing Temperature—Ambient Temperature=10° C.
3. Expansion device sub-cooling=5.0° C.
4. Evaporating temperature=7° C., corresponding indoor room temperature=27° C.
5. Evaporator Superheat=0.0° C. (flooded)
6. Intermediate Heat Exchanger Superheat=5.000
7. Isentropic Efficiency=72%
8. Volumetric Efficiency=98%
9. Difference of saturation temperatures intermediate heat exchanger=5° C.

The operating conditions for each of the air-conditioning systems produced the performance data in the table below.

TABLE 11
Performance of Mini-Secondary Basic Cycle

| Primary | Secondary | GWP | GWP | | |
|---|---|---|---|---|---|
| Refrigerant | Refrigerant | Primary | Secondary | Capacity | Efficiency |
| R410A | — | 1924 | — | 100% | 100% |
| R454C (PR4) | R471A | 146 | <150 | 100% | 87.6% |
| | R476A | 146 | <150 | 100% | 87.6% |
| | R482A | 146 | <150 | 100% | 87.6% |
| | L1 | 146 | <1 | 100% | 87.6% |
| | L2 | 146 | <150 | 100% | 87.6% |
| | L3 | 146 | <150 | 100% | 87.6% |
| | L4 | 146 | <150 | 100% | 87.6% |
| | L5 | 146 | <150 | 100% | 87.6% |
| | L6 | 146 | <150 | 100% | 87.6% |
| | L7 | 146 | <150 | 100% | 87.6% |
| | L8 | 146 | <150 | 100% | 87.6% |
| | L9 | 146 | <150 | 100% | 87.6% |
| | L10 | 146 | <150 | 100% | 87.6% |
| HDR159 | R471A | 150 | <150 | 100% | 88.2% |
| (PR5) | | | | | |
| | R476A | 150 | <150 | 100% | 88.2% |
| | R482A | 150 | <150 | 100% | 88.2% |
| | L1 | 150 | <1 | 100% | 88.2% |
| | L2 | 150 | <150 | 100% | 88.2% |
| | L3 | 150 | <150 | 100% | 88.2% |
| | L4 | 150 | <150 | 100% | 88.2% |
| | L5 | 150 | <150 | 100% | 88.2% |
| | L6 | 150 | <150 | 100% | 88.2% |
| | L7 | 150 | <150 | 100% | 88.2% |
| | L8 | 150 | <150 | 100% | 88.2% |
| | L9 | 150 | <150 | 100% | 88.2% |
| | L10 | 150 | <150 | 100% | 88.2% |
| Propane (PR6) | R471A | 3 | <150 | 100% | 90.2% |
| | R476A | 3 | <150 | 100% | 90.2% |
| | R482A | 3 | <150 | 100% | 90.2% |
| | L1 | 3 | <1 | 100% | 90.2% |
| | L2 | 3 | <150 | 100% | 90.2% |
| | L3 | 3 | <150 | 100% | 90.2% |
| | L4 | 3 | <150 | 100% | 90.2% |
| | L5 | 3 | <150 | 100% | 90.2% |
| | L6 | 3 | <150 | 100% | 90.2% |
| | L7 | 3 | <150 | 100% | 90.2% |
| | L8 | 3 | <150 | 100% | 90.2% |
| | L9 | 3 | <150 | 100% | 90.2% |
| | L10 | 3 | <150 | 100% | 90.2% |
| R455A (PR7) | R471A | 146 | <150 | 100% | 86.7% |
| | R476A | 146 | <150 | 100% | 86.7% |
| | R482A | 146 | <150 | 100% | 86.7% |
| | L1 | 146 | <1 | 100% | 86.7% |
| | L2 | 146 | <150 | 100% | 86.7% |
| | L3 | 146 | <150 | 100% | 86.7% |
| | L4 | 146 | <150 | 100% | 86.7% |
| | L5 | 146 | <150 | 100% | 86.7% |
| | L6 | 146 | <150 | 100% | 86.7% |
| | L7 | 146 | <150 | 100% | 86.7% |
| | L8 | 146 | <150 | 100% | 86.7% |
| | L9 | 146 | <150 | 100% | 86.7% |
| | L10 | 146 | <150 | 100% | 86.7% |

Table 11 shows the thermodynamic performance of mini-secondary system with different primary refrigerants and using 5 secondary refrigerants R471A, R476A, R482A, L1, L2, L3, and L4. The capacity of mini-secondary system was matched to R410A system in all the cases.

Table 12 shows the condensing temperatures required to match efficiency with different refrigerants.

TABLE 12
Condensing Temperatures Required to Match Efficiency of R410A

| Primary | Secondary | GWP | GWP | T_{cond} | |
|---|---|---|---|---|---|
| Refrigerant | Refrigerant | Primary | Secondary | (° C). | Efficiency |
| R410A | | 1924 | | 45.0 | 100% |
| R454C (PR4) | R471A | 146 | <150 | 40.96 | 100% |
| | R476A | 146 | <150 | 40.96 | 100% |
| | R482A | 146 | <150 | 40.96 | 100% |
| | L1 | 146 | <1 | 40.96 | 100% |
| | L2 | 146 | <150 | 40.96 | 100% |
| | L3 | 146 | <150 | 40.96 | 100% |
| | L4 | 146 | <150 | 40.96 | 100% |
| | L5 | 146 | <150 | 40.96 | 100% |
| | L6 | 146 | <150 | 40.96 | 100% |
| | L7 | 146 | <150 | 40.96 | 100% |
| | L8 | 146 | <150 | 40.96 | 100% |
| | L9 | 146 | <150 | 40.96 | 100% |
| | L10 | 146 | <150 | 40.96 | 100% |
| HDR159 | R471A | 150 | <150 | 41.11 | 100% |
| (PR5) | | | | | |
| | R476A | 150 | <150 | 41.11 | 100% |
| | R482A | 150 | <150 | 41.11 | 100% |
| | L1 | 150 | <1 | 41.11 | 100% |
| | L2 | 150 | <150 | 41.11 | 100% |
| | L3 | 150 | <150 | 41.11 | 100% |
| | L4 | 150 | <150 | 41.11 | 100% |
| | L5 | 150 | <150 | 41.11 | 100% |
| | L6 | 150 | <150 | 41.11 | 100% |
| | L7 | 150 | <150 | 41.11 | 100% |
| | L8 | 150 | <150 | 41.11 | 100% |
| | L9 | 150 | <150 | 41.11 | 100% |
| | L10 | 150 | <150 | 41.11 | 100% |
| Propane | R471A | 3 | <150 | 41.68 | 100% |
| (PR6) | | | | | |
| | R476A | 3 | <150 | 41.68 | 100% |
| | R482A | 3 | <150 | 41.68 | 100% |
| | L1 | 3 | <1 | 41.68 | 100% |
| | L2 | 3 | <150 | 41.68 | 100% |
| | L3 | 3 | <150 | 41.68 | 100% |
| | L4 | 3 | <150 | 41.68 | 100% |
| | L5 | 3 | <150 | 41.68 | 100% |
| | L6 | 3 | <150 | 41.68 | 100% |
| | L7 | 3 | <150 | 41.68 | 100% |
| | L8 | 3 | <150 | 41.68 | 100% |
| | L9 | 3 | <150 | 41.68 | 100% |
| | L10 | 3 | <150 | 41.68 | 100% |
| R455A (PR7) | R471A | 146 | <150 | 40.67 | 100% |
| | R476A | 146 | <150 | 40.67 | 100% |
| | R482A | 146 | <150 | 40.67 | 100% |
| | L1 | 146 | <1 | 40.67 | 100% |
| | L2 | 146 | <150 | 40.67 | 100% |
| | L3 | 146 | <150 | 40.67 | 100% |
| | L4 | 146 | <150 | 40.67 | 100% |
| | L5 | 146 | <150 | 40.67 | 100% |
| | L6 | 146 | <150 | 40.67 | 100% |
| | L7 | 146 | <150 | 40.67 | 100% |
| | L8 | 146 | <150 | 40.67 | 100% |
| | L9 | 146 | <150 | 40.67 | 100% |
| | L10 | 146 | <150 | 40.67 | 100% |

In order to match the efficiency a heat transfer area can be added to the condenser which will reduce the condensing temperature and thereby improving efficiency. The size of the condenser is inversely proportional to the condensing temperature required to match efficiency; hence higher condensing temperature is desirable.

Table 13 shows the performance of the mini-secondary system with different refrigerants at high ambient conditions.

TABLE 13
Efficiency at Different Ambient Conditions

| Primary | Secondary | GWP | GWP | Efficiency | Efficiency | Efficiency |
|---|---|---|---|---|---|---|
| Refrigerant | Refrigerant | Primary | Secondary | @35° C. | @45° C. | @55° C. |
| R410A | | 1924 | | 100% | 100.00% | 100% |
| R454C (PR4) | R471A | 146 | <150 | 100% | 101.63% | 104.02% |
| | R476A | 146 | <150 | 100% | 101.63% | 104.02% |
| | R482A | 146 | <150 | 100% | 101.63% | 104.02% |
| | L1 | 146 | <1 | 100% | 101.63% | 104.02% |
| | L2 | 146 | <150 | 100% | 101.63% | 104.02% |
| | L3 | 146 | <150 | 100% | 101.63% | 104.02% |
| | L4 | 146 | <150 | 100% | 101.63% | 104.02% |
| | L5 | 146 | <150 | 100% | 101.63% | 104.02% |
| | L6 | 146 | <150 | 100% | 101.63% | 104.02% |
| | L7 | 146 | <150 | 100% | 101.63% | 104.02% |
| | L8 | 146 | <150 | 100% | 101.63% | 104.02% |
| | L9 | 146 | <150 | 100% | 101.63% | 104.02% |
| | L10 | 146 | <150 | 100% | 101.63% | 104.02% |
| HDR159 (PR5) | R471A | 150 | <150 | 100% | 102.17% | 105.34% |
| | R476A | 150 | <150 | 100% | 102.17% | 105.34% |
| | R482A | 150 | <150 | 100% | 102.17% | 105.34% |
| | L1 | 150 | <1 | 100% | 102.17% | 105.34% |
| | L2 | 150 | <150 | 100% | 102.17% | 105.34% |
| | L3 | 150 | <150 | 100% | 102.17% | 105.34% |
| | L4 | 150 | <150 | 100% | 102.17% | 105.34% |
| | L5 | 150 | <150 | 100% | 102.17% | 105.34% |
| | L6 | 150 | <150 | 100% | 102.17% | 105.34% |
| | L7 | 150 | <150 | 100% | 102.17% | 105.34% |
| | L8 | 150 | <150 | 100% | 102.17% | 105.34% |
| | L9 | 150 | <150 | 100% | 102.17% | 105.34% |
| | L10 | 150 | <150 | 100% | 102.17% | 105.34% |
| Propane (PR6) | R471A | 3 | <150 | 100% | 103.54% | 108.60% |
| | R476A | 3 | <150 | 100% | 103.54% | 108.60% |
| | R482A | 3 | <150 | 100% | 103.54% | 108.60% |
| | L1 | 3 | <1 | 100% | 103.54% | 108.60% |
| | L2 | 3 | <150 | 100% | 103.54% | 108.60% |
| | L3 | 3 | <150 | 100% | 103.54% | 108.60% |
| | L4 | 3 | <150 | 100% | 103.54% | 108.60% |
| | L5 | 3 | <150 | 100% | 103.54% | 108.60% |
| | L6 | 3 | <150 | 100% | 103.54% | 108.60% |
| | L7 | 3 | <150 | 100% | 103.54% | 108.60% |
| | L8 | 3 | <150 | 100% | 103.54% | 108.60% |
| | L9 | 3 | <150 | 100% | 103.54% | 108.60% |
| | L10 | 3 | <150 | 100% | 103.54% | 108.60% |
| R455A (PR7) | R471A | 146 | <150 | 100% | 101.50% | 103.80% |
| | R476A | 146 | <150 | 100% | 101.50% | 103.80% |
| | R482A | 146 | <150 | 100% | 101.50% | 103.80% |
| | L1 | 146 | <1 | 100% | 101.50% | 103.80% |
| | L2 | 146 | <150 | 100% | 101.50% | 103.80% |
| | L3 | 146 | <150 | 100% | 101.50% | 103.80% |
| | L4 | 146 | <150 | 100% | 101.50% | 103.80% |
| | L5 | 146 | <150 | 100% | 101.50% | 103.80% |
| | L6 | 146 | <150 | 100% | 101.50% | 103.80% |
| | L7 | 146 | <150 | 100% | 101.50% | 103.80% |
| | L8 | 146 | <150 | 100% | 101.50% | 103.80% |
| | L9 | 146 | <150 | 100% | 101.50% | 103.80% |
| | L10 | 146 | <150 | 100% | 101.50% | 103.80% |

All the refrigerants showed superior efficiency compared to R410A as the ambient temperature is increased from 35° C. to 55° C.

### Example 1B: Thermodynamic Performance of a Mini-Secondary Cycle—Basic Cycle

In Example 1B, the performance of mini-secondary cycles with each of the primary fluids in Table 1 of the specification and each of the secondary fluids in Table 3 is evaluated.

The same system and operating conditions from Example 1A are kept. All the refrigerants show superior efficiency compared to R410A as the ambient temperature is increased from 35° C. to 55° C.

### Example 2A: Thermodynamic Performance of a Mini-Secondary Cycle with Suction Line/Liquid Line Heat Exchanger

A mini-secondary system with suction line/liquid line heat exchanger shows improved efficiency. Further, this shows superior efficiency compared to R410A at high ambient conditions.

Operating conditions for a R410A basic cycle, shown by the schematic in FIG. 6, are provided below:
1. Condensing temperature=45° C., corresponding outdoor ambient temperature=350C
2. Condensing Temperature—Ambient Temperature=10° C.
3. Expansion device sub-cooling=5.0° C.
4. Evaporating temperature=7° C., corresponding indoor room temperature=27° C.
5. Evaporator Superheat=5.0° C.
6. Isentropic Efficiency=72%
7. Volumetric Efficiency=98%

Operating conditions for a mini-secondary cycle with suction line/liquid heat line (SL/LL) exchanger, shown by the schematic in FIG. 2, are provided below:
1. Condensing temperature=45° C., corresponding outdoor ambient temperature=350C
2. Condensing Temperature—Ambient Temperature=10° C.
3. Expansion device sub-cooling=5.0° C.
4. Evaporating temperature=7° C., corresponding indoor room temperature=27° C.
5. Evaporator Superheat=0.0° C. (flooded)
6. Intermediate Heat Exchanger Superheat=5.0° C.
7. Isentropic Efficiency=72%
8. Volumetric Efficiency=98%
9. Difference of saturation temperatures intermediate heat exchanger=5° C.
10. Suction Line/Liquid Line Effectiveness=35%, 55%, 75%, 85%

Table 14 shows the thermodynamic performance of mini-secondary system with suction line liquid line heat exchanger.

TABLE 14
Performance of Mini-Secondary in Cycle with Suction Line/Liquid Line Heat Exchanger

| Primary | Secondary | GWP | GWP | Efficiency@ | Efficiency@ | Efficiency@ | Efficiency@ | Efficiency@ |
|---|---|---|---|---|---|---|---|---|
| Refrigerant | Refrigerant | Primary | Secondary | 0% effect. | 35% effect. | 55% effect. | 75% effect. | 85% effect. |
| R410A | — | 1924 | — | 100% | 100% | 100% | 100% | 100% |
| R454C (PR4) | R471A | 146 | <150 | 87.6% | 88.8% | 89.6% | 90.3% | 90.7% |
| | R476A | 146 | <150 | 87.6% | 88.8% | 89.6% | 90.3% | 90.7% |
| | R482A | 146 | <150 | 87.6% | 88.8% | 89.6% | 90.3% | 90.7% |
| | L1 | 146 | <1 | 87.6% | 88.8% | 89.6% | 90.3% | 90.7% |
| | L2 | 146 | <150 | 87.6% | 88.8% | 89.6% | 90.3% | 90.7% |
| | L3 | 146 | <150 | 87.6% | 88.8% | 89.6% | 90.3% | 90.7% |
| | L4 | 146 | <150 | 87.6% | 88.8% | 89.6% | 90.3% | 90.7% |
| | L5 | 146 | <150 | 87.6% | 88.8% | 89.6% | 90.3% | 90.7% |
| | L6 | 146 | <150 | 87.6% | 88.8% | 89.6% | 90.3% | 90.7% |
| | L7 | 146 | <150 | 87.6% | 88.8% | 89.6% | 90.3% | 90.7% |
| | L8 | 146 | <150 | 87.6% | 88.8% | 89.6% | 90.3% | 90.7% |
| | L9 | 146 | <150 | 87.6% | 88.8% | 89.6% | 90.3% | 90.7% |
| | L10 | 146 | <150 | 87.6% | 88.8% | 89.6% | 90.3% | 90.7% |
| HDR159 (PR5) | R471A | 150 | <150 | 88.2% | 89.2% | 89.8% | 90.5% | 90.8% |
| | R476A | 150 | <150 | 88.2% | 89.2% | 89.8% | 90.5% | 90.8% |
| | R482A | 150 | <150 | 88.2% | 89.2% | 89.8% | 90.5% | 90.8% |
| | L1 | 150 | <1 | 88.2% | 89.2% | 89.8% | 90.5% | 90.8% |
| | L2 | 150 | <150 | 88.2% | 89.2% | 89.8% | 90.5% | 90.8% |
| | L3 | 150 | <150 | 88.2% | 89.2% | 89.8% | 90.5% | 90.8% |
| | L4 | 150 | <150 | 88.2% | 89.2% | 89.8% | 90.5% | 90.8% |
| | L5 | 150 | <150 | 88.2% | 89.2% | 89.8% | 90.5% | 90.8% |
| | L6 | 150 | <150 | 88.2% | 89.2% | 89.8% | 90.5% | 90.8% |
| | L7 | 150 | <150 | 88.2% | 89.2% | 89.8% | 90.5% | 90.8% |
| | L8 | 150 | <150 | 88.2% | 89.2% | 89.8% | 90.5% | 90.8% |
| | L9 | 150 | <150 | 88.2% | 89.2% | 89.8% | 90.5% | 90.8% |
| | L10 | 150 | <150 | 88.2% | 89.2% | 89.8% | 90.5% | 90.8% |
| Propane (PR6) | R471A | 3 | <150 | 90.2% | 91.1% | 91.7% | 92.4% | 92.8% |
| | R476A | 3 | <150 | 90.2% | 91.1% | 91.7% | 92.4% | 92.8% |
| | R482A | 3 | <150 | 90.2% | 91.1% | 91.7% | 92.4% | 92.8% |
| | L1 | 3 | <1 | 90.2% | 91.1% | 91.7% | 92.4% | 92.8% |
| | L2 | 3 | <150 | 90.2% | 91.1% | 91.7% | 92.4% | 92.8% |
| | L3 | 3 | <150 | 90.2% | 91.1% | 91.7% | 92.4% | 92.8% |
| | L4 | 3 | <150 | 90.2% | 91.1% | 91.7% | 92.4% | 92.8% |
| | L5 | 3 | <150 | 90.2% | 91.1% | 91.7% | 92.4% | 92.8% |
| | L6 | 3 | <150 | 90.2% | 91.1% | 91.7% | 92.4% | 92.8% |
| | L7 | 3 | <150 | 90.2% | 91.1% | 91.7% | 92.4% | 92.8% |
| | L8 | 3 | <150 | 90.2% | 91.1% | 91.7% | 92.4% | 92.8% |
| | L9 | 3 | <150 | 90.2% | 91.1% | 91.7% | 92.4% | 92.8% |
| | L10 | 3 | <150 | 90.2% | 91.1% | 91.7% | 92.4% | 92.8% |
| R455A (PR7) | R471A | 146 | <150 | 86.7% | 88.0% | 88.7% | 89.5% | 89.9% |
| | R476A | 146 | <150 | 86.7% | 88.0% | 88.7% | 89.5% | 89.9% |
| | R482A | 146 | <150 | 86.7% | 88.0% | 88.7% | 89.5% | 89.9% |
| | L1 | 146 | <1 | 86.7% | 88.0% | 88.7% | 89.5% | 89.9% |
| | L2 | 146 | <150 | 86.7% | 88.0% | 88.7% | 89.5% | 89.9% |
| | L3 | 146 | <150 | 86.7% | 88.0% | 88.7% | 89.5% | 89.9% |
| | L4 | 146 | <150 | 86.7% | 88.0% | 88.7% | 89.5% | 89.9% |
| | L5 | 146 | <150 | 86.7% | 88.0% | 88.7% | 89.5% | 89.9% |
| | L6 | 146 | <150 | 86.7% | 88.0% | 88.7% | 89.5% | 89.9% |
| | L7 | 146 | <150 | 86.7% | 88.0% | 88.7% | 89.5% | 89.9% |
| | L8 | 146 | <150 | 86.7% | 88.0% | 88.7% | 89.5% | 89.9% |
| | L9 | 146 | <150 | 86.7% | 88.0% | 88.7% | 89.5% | 89.9% |
| | L10 | 146 | <150 | 86.7% | 88.0% | 88.7% | 89.5% | 89.9% |

Table 14 shows that capacity was matched with R410A for all the refrigerants. The improvement in performance was observed by using suction line/liquid line heat exchanger

Table 15 shows the condensing temperatures required to match efficiency with different refrigerants.

TABLE 15
Condensing Temperatures Required to Match Efficiency of R410A

| | | | | Tcond | Tcond | Tcond | Tcond | Tcond |
|---|---|---|---|---|---|---|---|---|
| | | | | (° C.) @ | (° C.) @ | (° C.) @ | (° C.) @ | (° C.) @ |
| Primary | Secondary | GWP | GWP | 0% | 35% | 55% | 75% | 85% |
| Refrigerant | Refrigerant | Primary | Secondary | effect. | effect. | effect. | effect. | effect. |
| R410A | — | 1924 | — | 45.0 | 45.0 | 45.0 | 45.0 | 45.0 |
| R454C (PR4) | R471A | 146 | <150 | 40.96 | 41.26 | 41.46 | 41.67 | 41.78 |
| | R476A | 146 | <150 | 40.96 | 41.26 | 41.46 | 41.67 | 41.78 |
| | R482A | 146 | <150 | 40.96 | 41.26 | 41.46 | 41.67 | 41.78 |
| | L1 | 146 | <1 | 40.96 | 41.26 | 41.46 | 41.67 | 41.78 |
| | L2 | 146 | <150 | 40.96 | 41.26 | 41.46 | 41.67 | 41.78 |
| | L3 | 146 | <150 | 40.96 | 41.26 | 41.46 | 41.67 | 41.78 |
| | L4 | 146 | <150 | 40.96 | 41.26 | 41.46 | 41.67 | 41.78 |
| | L5 | 146 | <150 | 40.96 | 41.26 | 41.46 | 41.67 | 41.78 |
| | L6 | 146 | <150 | 40.96 | 41.26 | 41.46 | 41.67 | 41.78 |
| | L7 | 146 | <150 | 40.96 | 41.26 | 41.46 | 41.67 | 41.78 |
| | L8 | 146 | <150 | 40.96 | 41.26 | 41.46 | 41.67 | 41.78 |
| | L9 | 146 | <150 | 40.96 | 41.26 | 41.46 | 41.67 | 41.78 |
| | L10 | 146 | <150 | 40.96 | 41.26 | 41.46 | 41.67 | 41.78 |
| HDR159 (PR5) | R471A | 150 | <150 | 41.11 | 41.36 | 41.53 | 41.71 | 41.8 |
| | R476A | 150 | <150 | 41.11 | 41.36 | 41.53 | 41.71 | 41.8 |
| | R482A | 150 | <150 | 41.11 | 41.36 | 41.53 | 41.71 | 41.8 |
| | L1 | 150 | <1 | 41.11 | 41.36 | 41.53 | 41.71 | 41.8 |
| | L2 | 150 | <150 | 41.11 | 41.36 | 41.53 | 41.71 | 41.8 |
| | L3 | 150 | <150 | 41.11 | 41.36 | 41.53 | 41.71 | 41.8 |
| | L4 | 150 | <150 | 41.11 | 41.36 | 41.53 | 41.71 | 41.8 |
| | L5 | 150 | <150 | 41.11 | 41.36 | 41.53 | 41.71 | 41.8 |
| | L6 | 150 | <150 | 41.11 | 41.36 | 41.53 | 41.71 | 41.8 |
| | L7 | 150 | <150 | 41.11 | 41.36 | 41.53 | 41.71 | 41.8 |
| | L8 | 150 | <150 | 41.11 | 41.36 | 41.53 | 41.71 | 41.8 |
| | L9 | 150 | <150 | 41.11 | 41.36 | 41.53 | 41.71 | 41.8 |
| | L10 | 150 | <150 | 41.11 | 41.36 | 41.53 | 41.71 | 41.8 |
| Propane (PR6) | R471A | 3 | <150 | 41.68 | 41.92 | 42.1 | 42.29 | 42.39 |
| | R476A | 3 | <150 | 41.68 | 41.92 | 42.1 | 42.29 | 42.39 |
| | R482A | 3 | <150 | 41.68 | 41.92 | 42.1 | 42.29 | 42.39 |
| | L1 | 3 | <1 | 41.68 | 41.92 | 42.1 | 42.29 | 42.39 |
| | L2 | 3 | <150 | 41.68 | 41.92 | 42.1 | 42.29 | 42.39 |
| | L3 | 3 | <150 | 41.68 | 41.92 | 42.1 | 42.29 | 42.39 |
| | L4 | 3 | <150 | 41.68 | 41.92 | 42.1 | 42.29 | 42.39 |
| | L5 | 3 | <150 | 41.68 | 41.92 | 42.1 | 42.29 | 42.39 |
| | L6 | 3 | <150 | 41.68 | 41.92 | 42.1 | 42.29 | 42.39 |
| | L7 | 3 | <150 | 41.68 | 41.92 | 42.1 | 42.29 | 42.39 |
| | L8 | 3 | <150 | 41.68 | 41.92 | 42.1 | 42.29 | 42.39 |
| | L9 | 3 | <150 | 41.68 | 41.92 | 42.1 | 42.29 | 42.39 |
| | L10 | 3 | <150 | 41.68 | 41.92 | 42.1 | 42.29 | 42.39 |
| R455A (PR7) | R471A | 146 | <150 | 40.67 | 40.98 | 41.18 | 41.39 | 41.5 |
| | R476A | 146 | <150 | 40.67 | 40.98 | 41.18 | 41.39 | 41.5 |
| | R482A | 146 | <150 | 40.67 | 40.98 | 41.18 | 41.39 | 41.5 |
| | L1 | 146 | <1 | 40.67 | 40.98 | 41.18 | 41.39 | 41.5 |
| | L2 | 146 | <150 | 40.67 | 40.98 | 41.18 | 41.39 | 41.5 |
| | L3 | 146 | <150 | 40.67 | 40.98 | 41.18 | 41.39 | 41.5 |
| | L4 | 146 | <150 | 40.67 | 40.98 | 41.18 | 41.39 | 41.5 |
| | L5 | 146 | <150 | 40.67 | 40.98 | 41.18 | 41.39 | 41.5 |
| | L6 | 146 | <150 | 40.67 | 40.98 | 41.18 | 41.39 | 41.5 |
| | L7 | 146 | <150 | 40.67 | 40.98 | 41.18 | 41.39 | 41.5 |
| | L8 | 146 | <150 | 40.67 | 40.98 | 41.18 | 41.39 | 41.5 |
| | L9 | 146 | <150 | 40.67 | 40.98 | 41.18 | 41.39 | 41.5 |
| | L10 | 146 | <150 | 40.67 | 40.98 | 41.18 | 41.39 | 41.5 |

In order to match the efficiency a heat transfer area can be added to the condenser which will reduce the condensing temperature and thereby improving efficiency.

The size of the condenser is inversely proportional to the condensing temperature required to match efficiency; hence higher condensing temperature is desirable.

Table 16 shows the performance of mini-secondary system with different refrigerants at high ambient conditions.

TABLE 16
Efficiency at High Ambient Conditions

| Primary | Secondary | GWP | GWP | Efficiency | Efficiency | Efficiency |
|---|---|---|---|---|---|---|
| Refrigerant | Refrigerant | Primary | Secondary | @35° C. | @45° C. | @55° C. |
| R410A | — | 1924 | — | R410A | 100% | 100% |
| R454C (PR4) | R471A | 146 | <150 | 100% | 105.6% | 112.5% |
| | R476A | 146 | <150 | 100% | 105.6% | 112.5% |
| | R482A | 146 | <150 | 100% | 105.6% | 112.5% |
| | L1 | 146 | <1 | 100% | 105.6% | 112.5% |
| | L2 | 146 | <150 | 100% | 105.6% | 112.5% |
| | L3 | 146 | <150 | 100% | 105.6% | 112.5% |
| | L4 | 146 | <150 | 100% | 105.6% | 112.5% |
| | L5 | 146 | <150 | 100% | 105.6% | 112.5% |
| | L6 | 146 | <150 | 100% | 105.6% | 112.5% |
| | L7 | 146 | <150 | 100% | 105.6% | 112.5% |
| | L8 | 146 | <150 | 100% | 105.6% | 112.5% |
| | L9 | 146 | <150 | 100% | 105.6% | 112.5% |
| | L10 | 146 | <150 | 100% | 105.6% | 112.5% |
| HDR159 (PR5) | R471A | 150 | <150 | 100% | 105.6% | 112.9% |
| | R476A | 150 | <150 | 100% | 105.6% | 112.9% |
| | R482A | 150 | <150 | 100% | 105.6% | 112.9% |
| | L1 | 150 | <1 | 100% | 105.6% | 112.9% |
| | L2 | 150 | <150 | 100% | 105.6% | 112.9% |
| | L3 | 150 | <150 | 100% | 105.6% | 112.9% |
| | L4 | 150 | <150 | 100% | 105.6% | 112.9% |
| | L5 | 150 | <150 | 100% | 105.6% | 112.9% |
| | L6 | 150 | <150 | 100% | 105.6% | 112.9% |
| | L7 | 150 | <150 | 100% | 105.6% | 112.9% |
| | L8 | 150 | <150 | 100% | 105.6% | 112.9% |
| | L9 | 150 | <150 | 100% | 105.6% | 112.9% |
| | L10 | 150 | <150 | 100% | 105.6% | 112.9% |
| Propane (PR6) | R471A | 3 | <150 | 100% | 107.1% | 116.5% |
| | R476A | 3 | <150 | 100% | 107.1% | 116.5% |
| | R482A | 3 | <150 | 100% | 107.1% | 116.5% |
| | L1 | 3 | <1 | 100% | 107.1% | 116.5% |
| | L2 | 3 | <150 | 100% | 107.1% | 116.5% |
| | L3 | 3 | <1 | 100% | 107.1% | 116.5% |
| | L4 | 3 | <150 | 100% | 107.1% | 116.5% |
| | L5 | 3 | <150 | 100% | 107.1% | 116.5% |
| | L6 | 3 | <150 | 100% | 107.1% | 116.5% |
| | L7 | 3 | <150 | 100% | 107.1% | 116.5% |
| | L8 | 3 | <150 | 100% | 107.1% | 116.5% |
| | L9 | 3 | <150 | 100% | 107.1% | 116.5% |
| | L10 | 3 | <150 | 100% | 107.1% | 116.5% |
| R455A (PR7) | R471A | 146 | <150 | 100% | 105.3% | 111.8% |
| | R476A | 146 | <150 | 100% | 105.3% | 111.8% |
| | R482A | 146 | <150 | 100% | 105.3% | 111.8% |
| | L1 | 146 | <1 | 100% | 105.3% | 111.8% |
| | L2 | 146 | <150 | 100% | 105.3% | 111.8% |
| | L3 | 146 | <1 | 100% | 105.3% | 111.8% |
| | L4 | 146 | <150 | 100% | 105.3% | 111.8% |
| | L5 | 146 | <150 | 100% | 105.3% | 111.8% |
| | L6 | 146 | <150 | 100% | 105.3% | 111.8% |
| | L7 | 146 | <150 | 100% | 105.3% | 111.8% |
| | L8 | 146 | <150 | 100% | 105.3% | 111.8% |
| | L9 | 146 | <150 | 100% | 105.3% | 111.8% |
| | L10 | 146 | <150 | 100% | 105.3% | 111.8% |

The effectiveness of SU/LL HX is assumed to be 75% for this Example but the results are similar for any value of effectiveness.

All the refrigerants offer show superior efficiency compared to R410A as the ambient temperature is increased from 35° C. to 550° C.

### Example 2B: Thermodynamic Performance of a Mini-Secondary Cycle—Suction Line/Liquid Line Heat Exchanger Cycle

In Example 2B, the performance of mini-secondary cycles with each of the primary fluids in Table 1 of the specification and each of the secondary fluids in Table 3 is evaluated.

The same system and operating conditions from Example 2A are kept. All the refrigerants show superior efficiency compared to R410A as the ambient temperature is increased from 35° C. to 55° C.

### Example 3A: Thermodynamic Performance of a Mini-Secondary Cycle with Vapor Injection

A mini-secondary system with vapor injection shows improved efficiency. Further, this shows superior efficiency compared to R410A at high ambient conditions.

Operating conditions for a R410A basic cycle, shown by the schematic in FIG. 6, are provided below:
1. Condensing temperature=45° C., corresponding outdoor ambient temperature=350C
2. Condensing Temperature—Ambient Temperature=10° C.
3. Expansion device sub-cooling=5.0° C.
4. Evaporating temperature=7° C., corresponding indoor room temperature=27° C.
5. Evaporator Superheat=5.0° C.
6. Isentropic Efficiency=72%
7. Volumetric Efficiency=98%

Operating conditions for a mini-secondary cycle with two stage compression, shown by the schematic in FIG. 3, is provided below.
1. Condensing temperature=45° C., corresponding outdoor ambient temperature=350C
2. Condensing Temperature—Ambient Temperature=10° C.
3. Expansion device sub-cooling=5.0° C.
4. Evaporating temperature=7° C., corresponding indoor room temperature=27° C.
5. Evaporator Superheat=0.0° C. (flooded)
6. Intermediate Heat Exchanger Superheat=5.000
7. Isentropic Efficiency for both stages=72%
8. Volumetric Efficiency=98%
9. Difference of saturation temperatures in intermediate heat exchanger=5° C.
10. Vapor Injection Heat Exchanger Effectiveness=35%, 55%, 75%, 85%

FIG. 3 shows the schematic of R410A air conditioning system and Mini-secondary system with two-stage compression.

Table 17 shows the thermodynamic performance of two-stage vapor injected mini-secondary system with different primary refrigerants and using R471A, R476A, R482A, L1, L2, L3, and L4 as secondary refrigerants.

TABLE 17
Performance of Mini-Secondary in Cycle with Two Stage Vapor Injection

| Primary | Secondary | GWP | GWP | Efficiency@ | Efficiency@ | Efficiency@ | Efficiency@ |
|---|---|---|---|---|---|---|---|
| Refrigerant | Refrigerant | Primary | Secondary | 35% effect. | 55% effect. | 75% effect. | 85% effect. |
| R410A | — | 1924 | — | 100% | 100% | 100% | 100% |
| R454C (PR4) | R471A | 146 | <150 | 89.66% | 91.51% | 93.34% | 94.21% |
| | R476A | 146 | <150 | 89.66% | 91.51% | 93.34% | 94.21% |
| | R482A | 146 | <150 | 89.66% | 91.51% | 93.34% | 94.21% |
| | L1 | 146 | <1 | 89.66% | 91.51% | 93.34% | 94.21% |
| | L2 | 146 | <150 | 89.66% | 91.51% | 93.34% | 94.21% |
| | L3 | 146 | <150 | 89.66% | 91.51% | 93.34% | 94.21% |
| | L4 | 146 | <150 | 89.66% | 91.51% | 93.34% | 94.21% |
| | L5 | 146 | <150 | 89.66% | 91.51% | 93.34% | 94.21% |
| | L6 | 146 | <150 | 89.66% | 91.51% | 93.34% | 94.21% |
| | L7 | 146 | <150 | 89.66% | 91.51% | 93.34% | 94.21% |
| | L8 | 146 | <150 | 89.66% | 91.51% | 93.34% | 94.21% |
| | L9 | 146 | <150 | 89.66% | 91.51% | 93.34% | 94.21% |
| | L10 | 146 | <150 | 89.66% | 91.51% | 93.34% | 94.21% |
| HDR159 (PR5) | R471A | 150 | <150 | 90.09% | 91.92% | 93.68% | 94.52% |
| | R476A | 150 | <150 | 90.09% | 91.92% | 93.68% | 94.52% |
| | R482A | 150 | <150 | 90.09% | 91.92% | 93.68% | 94.52% |
| | L1 | 150 | <1 | 90.09% | 91.92% | 93.68% | 94.52% |
| | L2 | 150 | <150 | 90.09% | 91.92% | 93.68% | 94.52% |
| | L3 | 150 | <150 | 90.09% | 91.92% | 93.68% | 94.52% |
| | L4 | 150 | <150 | 90.09% | 91.92% | 93.68% | 94.52% |
| | L5 | 150 | <150 | 90.09% | 91.92% | 93.68% | 94.52% |
| | L6 | 150 | <150 | 90.09% | 91.92% | 93.68% | 94.52% |
| | L7 | 150 | <150 | 90.09% | 91.92% | 93.68% | 94.52% |
| | L8 | 150 | <150 | 90.09% | 91.92% | 93.68% | 94.52% |
| | L9 | 150 | <150 | 90.09% | 91.92% | 93.68% | 94.52% |
| | L10 | 150 | <150 | 90.09% | 91.92% | 93.68% | 94.52% |
| Propane (PR6) | R471A | 3 | <150 | 91.85% | 93.46% | 95.02% | 95.77% |
| | R476A | 3 | <150 | 91.85% | 93.46% | 95.02% | 95.77% |
| | R482A | 3 | <150 | 91.85% | 93.46% | 95.02% | 95.77% |
| | L1 | 3 | <1 | 91.85% | 93.46% | 95.02% | 95.77% |
| | L2 | 3 | <150 | 91.85% | 93.46% | 95.02% | 95.77% |
| | L3 | 3 | <150 | 91.85% | 93.46% | 95.02% | 95.77% |
| | L4 | 3 | <150 | 91.85% | 93.46% | 95.02% | 95.77% |
| | L5 | 3 | <150 | 91.85% | 93.46% | 95.02% | 95.77% |
| | L6 | 3 | <150 | 91.85% | 93.46% | 95.02% | 95.77% |
| | L7 | 3 | <150 | 91.85% | 93.46% | 95.02% | 95.77% |
| | L8 | 3 | <150 | 91.85% | 93.46% | 95.02% | 95.77% |
| | L9 | 3 | <150 | 91.85% | 93.46% | 95.02% | 95.77% |
| | L10 | 3 | <150 | 91.85% | 93.46% | 95.02% | 95.77% |
| R455A (PR7) | R471A | 146 | <150 | 88.60% | 90.38% | 92.11%% | 92.98% |
| | R476A | 146 | <150 | 88.60% | 90.38% | 92.11%% | 92.98% |
| | R482A | 146 | <150 | 88.60% | 90.38% | 92.11%% | 92.98% |
| | L1 | 146 | <1 | 88.60% | 90.38% | 92.11%% | 92.98% |
| | L2 | 146 | <150 | 88.60% | 90.38% | 92.11%% | 92.98% |
| | L3 | 146 | <1 | 88.60% | 90.38% | 92.11%% | 92.98% |
| | L4 | 146 | <150 | 88.60% | 90.38% | 92.11%% | 92.98% |
| | L5 | 146 | <150 | 88.60% | 90.38% | 92.11%% | 92.98% |
| | L6 | 146 | <150 | 88.60% | 90.38% | 92.11%% | 92.98% |
| | L7 | 146 | <150 | 88.60% | 90.38% | 92.11%% | 92.98% |
| | L8 | 146 | <150 | 88.60% | 90.38% | 92.11%% | 92.98% |
| | L9 | 146 | <150 | 88.60% | 90.38% | 92.11%% | 92.98% |
| | L10 | 146 | <150 | 88.60% | 90.38% | 92.11%% | 92.98% |

The capacity of mini-secondary system was matched to R41A system in all the cases.

Table 18 shows the condensing temperatures required to match efficiency with different refrigerants.

TABLE 18
Condensing Temperatures Required to Match Efficiency of R410A

| | | | | Tcond | Tcond | Tcond | Tcond |
|---|---|---|---|---|---|---|---|
| | | | | (° C.) @ | (° C.) @ | (° C.) @ | (° C.) @ |
| Primary | Secondary | GWP | GWP | 35% | 55% | 75% | 85% |
| Refrigerant | Refrigerant | Primary | Secondary | effect. | effect. | effect. | effect. |
| R410A | — | 1924 | — | 45 | 45 | 45 | 45 |
| R454C (H1) | R471A | 146 | <150 | 41.45 | 41.98 | 42.54 | 42.83 |
| | R476A | 146 | <150 | 41.45 | 41.98 | 42.54 | 42.83 |
| | R482A | 146 | <150 | 41.45 | 41.98 | 42.54 | 42.83 |
| | L1 | 146 | <1 | 41.45 | 41.98 | 42.54 | 42.83 |
| | L2 | 146 | <150 | 41.45 | 41.98 | 42.54 | 42.83 |
| | L3 | 146 | <150 | 41.45 | 41.98 | 42.54 | 42.83 |
| | L4 | 146 | <150 | 41.45 | 41.98 | 42.54 | 42.83 |
| | L5 | 146 | <150 | 41.45 | 41.98 | 42.54 | 42.83 |
| | L6 | 146 | <150 | 41.45 | 41.98 | 42.54 | 42.83 |
| | L7 | 146 | <150 | 41.45 | 41.98 | 42.54 | 42.83 |
| | L8 | 146 | <150 | 41.45 | 41.98 | 42.54 | 42.83 |
| | L9 | 146 | <150 | 41.45 | 41.98 | 42.54 | 42.83 |
| | L10 | 146 | <150 | 41.45 | 41.98 | 42.54 | 42.83 |
| HDR159 (H2) | R471A | 150 | <150 | 41.57 | 42.11 | 42.67 | 42.95 |
| | R476A | 150 | <150 | 41.57 | 42.11 | 42.67 | 42.95 |
| | R482A | 150 | <150 | 41.57 | 42.11 | 42.67 | 42.95 |
| | L1 | 150 | <1 | 41.57 | 42.11 | 42.67 | 42.95 |
| | L2 | 150 | <150 | 41.57 | 42.11 | 42.67 | 42.95 |
| | L3 | 150 | <150 | 41.57 | 42.11 | 42.67 | 42.95 |
| | L4 | 150 | <150 | 41.57 | 42.11 | 42.67 | 42.95 |
| | L5 | 150 | <150 | 41.57 | 42.11 | 42.67 | 42.95 |
| | L6 | 150 | <150 | 41.57 | 42.11 | 42.67 | 42.95 |
| | L7 | 150 | <150 | 41.57 | 42.11 | 42.67 | 42.95 |
| | L8 | 150 | <150 | 41.57 | 42.11 | 42.67 | 42.95 |
| | L9 | 150 | <150 | 41.57 | 42.11 | 42.67 | 42.95 |
| | L10 | 150 | <150 | 41.57 | 42.11 | 42.67 | 42.95 |
| Propane (H3) | R471A | 3 | <150 | 42.14 | 42.66 | 43.18 | 43.44 |
| | R476A | 3 | <150 | 42.14 | 42.66 | 43.18 | 43.44 |
| | R482A | 3 | <150 | 42.14 | 42.66 | 43.18 | 43.44 |
| | L1 | 3 | <1 | 42.14 | 42.66 | 43.18 | 43.44 |
| | L2 | 3 | <150 | 42.14 | 42.66 | 43.18 | 43.44 |
| | L3 | 3 | <150 | 42.14 | 42.66 | 43.18 | 43.44 |
| | L4 | 3 | <150 | 42.14 | 42.66 | 43.18 | 43.44 |
| | L5 | 3 | <150 | 42.14 | 42.66 | 43.18 | 43.44 |
| | L6 | 3 | <150 | 42.14 | 42.66 | 43.18 | 43.44 |
| | L7 | 3 | <150 | 42.14 | 42.66 | 43.18 | 43.44 |
| | L8 | 3 | <150 | 42.14 | 42.66 | 43.18 | 43.44 |
| | L9 | 3 | <150 | 42.14 | 42.66 | 43.18 | 43.44 |
| | L10 | 3 | <150 | 42.14 | 42.66 | 43.18 | 43.44 |
| R455A (H4) | R471A | 146 | <150 | 41.06 | 41.54 | 42.05 | 42.33 |
| | R476A | 146 | <150 | 41.06 | 41.54 | 42.05 | 42.33 |
| | R482A | 146 | <150 | 41.06 | 41.54 | 42.05 | 42.33 |
| | L1 | 146 | <1 | 41.06 | 41.54 | 42.05 | 42.33 |
| | L2 | 146 | <150 | 41.06 | 41.54 | 42.05 | 42.33 |
| | L3 | 146 | <150 | 41.06 | 41.54 | 42.05 | 42.33 |
| | L4 | 146 | <150 | 41.06 | 41.54 | 42.05 | 42.33 |
| | L5 | 146 | <150 | 41.06 | 41.54 | 42.05 | 42.33 |
| | L6 | 146 | <150 | 41.06 | 41.54 | 42.05 | 42.33 |
| | L7 | 146 | <150 | 41.06 | 41.54 | 42.05 | 42.33 |
| | L8 | 146 | <150 | 41.06 | 41.54 | 42.05 | 42.33 |
| | L9 | 146 | <150 | 41.06 | 41.54 | 42.05 | 42.33 |
| | L10 | 146 | <150 | 41.06 | 41.54 | 42.05 | 42.33 |

In order to match the efficiency a heat transfer area can be added to the condenser which will reduce the condensing temperature and thereby improving efficiency. For refrigerants with same or higher efficiency than R410A, the condensing temperature is kept same as R410A.

TABLE 19
Performance at High Ambient Conditions

| Primary | Secondary | GWP | GWP | Efficiency | Efficiency | Efficiency |
|---|---|---|---|---|---|---|
| Refrigerant | Refrigerant | Primary | Secondary | @35° C. | @45° C. | @55° C. |
| R410A | — | 1924 | — | 100% | 100% | 100% |
| R454C (H1) | R471A | 146 | <150 | 100% | 106.65% | 114.46% |
| | R476A | 146 | <150 | 100% | 106.65% | 114.46% |
| | R482A | 146 | <150 | 100% | 106.65% | 114.46% |
| | L1 | 146 | <1 | 100% | 106.65% | 114.46% |
| | L2 | 146 | <150 | 100% | 106.65% | 114.46% |
| | L3 | 146 | <150 | 100% | 106.65% | 114.46% |
| | L4 | 146 | <150 | 100% | 106.65% | 114.46% |
| | L5 | 146 | <150 | 100% | 106.65% | 114.46% |
| | L6 | 146 | <150 | 100% | 106.65% | 114.46% |
| | L7 | 146 | <150 | 100% | 106.65% | 114.46% |
| | L8 | 146 | <150 | 100% | 106.65% | 114.46% |
| | L9 | 146 | <150 | 100% | 106.65% | 114.46% |
| | L10 | 146 | <150 | 100% | 106.65% | 114.46% |
| HDR159 (H2) | R471A | 150 | <150 | 100% | 106.79% | 114.97% |
| | R476A | 150 | <150 | 100% | 106.79% | 114.97% |
| | R482A | 150 | <150 | 100% | 106.79% | 114.97% |
| | L1 | 150 | <1 | 100% | 106.79% | 114.97% |
| | L2 | 150 | <150 | 100% | 106.79% | 114.97% |
| | L3 | 150 | <150 | 100% | 106.79% | 114.97% |
| | L4 | 150 | <150 | 100% | 106.79% | 114.97% |
| | L5 | 150 | <150 | 100% | 106.79% | 114.97% |
| | L6 | 150 | <150 | 100% | 106.79% | 114.97% |
| | L7 | 150 | <150 | 100% | 106.79% | 114.97% |
| | L8 | 150 | <150 | 100% | 106.79% | 114.97% |
| | L9 | 150 | <150 | 100% | 106.79% | 114.97% |
| | L10 | 150 | <150 | 100% | 106.79% | 114.97% |
| Propane (H3) | R471A | 3 | <150 | 100% | 106.92% | 115.62% |
| | R476A | 3 | <150 | 100% | 106.92% | 115.62% |
| | R482A | 3 | <150 | 100% | 106.92% | 115.62% |
| | L1 | 3 | <1 | 100% | 106.92% | 115.62% |
| | L2 | 3 | <150 | 100% | 106.92% | 115.62% |
| | L3 | 3 | <150 | 100% | 106.92% | 115.62% |
| | L4 | 3 | <150 | 100% | 106.92% | 115.62% |
| | L5 | 3 | <150 | 100% | 106.92% | 115.62% |
| | L6 | 3 | <150 | 100% | 106.92% | 115.62% |
| | L7 | 3 | <150 | 100% | 106.92% | 115.62% |
| | L8 | 3 | <150 | 100% | 106.92% | 115.62% |
| | L9 | 3 | <150 | 100% | 106.92% | 115.62% |
| | L10 | 3 | <150 | 100% | 106.92% | 115.62% |
| R455A (H4) | R471A | 146 | <150 | 100% | 106.89% | 115.11% |
| | R476A | 146 | <150 | 100% | 106.89% | 115.11% |
| | R482A | 146 | <150 | 100% | 106.89% | 115.11% |
| | L1 | 146 | <1 | 100% | 106.89% | 115.11% |
| | L2 | 146 | <150 | 100% | 106.89% | 115.11% |
| | L3 | 146 | <150 | 100% | 106.89% | 115.11% |
| | L4 | 146 | <150 | 100% | 106.89% | 115.11% |
| | L5 | 146 | <150 | 100% | 106.89% | 115.11% |
| | L6 | 146 | <150 | 100% | 106.89% | 115.11% |
| | L7 | 146 | <150 | 100% | 106.89% | 115.11% |
| | L8 | 146 | <150 | 100% | 106.89% | 115.11% |
| | L9 | 146 | <150 | 100% | 106.89% | 115.11% |
| | L10 | 146 | <150 | 100% | 106.89% | 115.11% |

Table 19 shows the performance of mini-secondary system with different refrigerants at high ambient conditions.

Heat exchanger of 75% effectiveness is assumed for this Example, but the results are similar for any value of effectiveness.

All the refrigerants show superior efficiency compared to R410A as the ambient temperature is increased from 35° C. to 55° C.

### Example 3B: Thermodynamic Performance of a Mini-Secondary Cycle—with Vapor Injection Cycle

In Example 3B, the performance of mini-secondary cycles with each of the primary fluids in Table 1 of the specification and each of the secondary fluids in Table 3 is evaluated.

The same system and operating conditions from Example 3A are kept. All the refrigerants show superior efficiency compared to R410A as the ambient temperature is increased from 35° C. to 55° C.

### Example 4: System with Aluminum Heat Exchangers and Flooded Evaporator

Due to the low pressure of secondary fluids R471A, R476A, R482A, L1, L2, L3 and L4 the evaporator can be made of aluminum which is lower cost and makes the overall system lighter. Further, the evaporator could be used in flooded configuration to improve heat transfer and make the heat exchanger more compact.

A representative schematic is provided in FIG. 1. The intermediate heat exchanger (tube-in-tube) could be made of PVC (outside tube) and metal (inside tube) to lower the cost and reduce the system weight.

The evaporator is operated in flooded configuration to minimize the pressure drop with secondary fluids (R471A, R476A, R482A, L1-L4). This configuration offers superior heat transfer performance and leads to a more compact heat exchanger.

The round tube-fin heat evaporator could be made of aluminum instead of copper as the pressure of R471A, R476A, R482A, L1-L4 are very low.

Similarly, for the intermediate heat exchanger which is tube-in-tube, the outside tube where secondary fluid (R471A, R476A, R482A, L1-L5) flows can be made of plastic and inside tube with the primary refrigerant is made of metal (aluminum, copper).

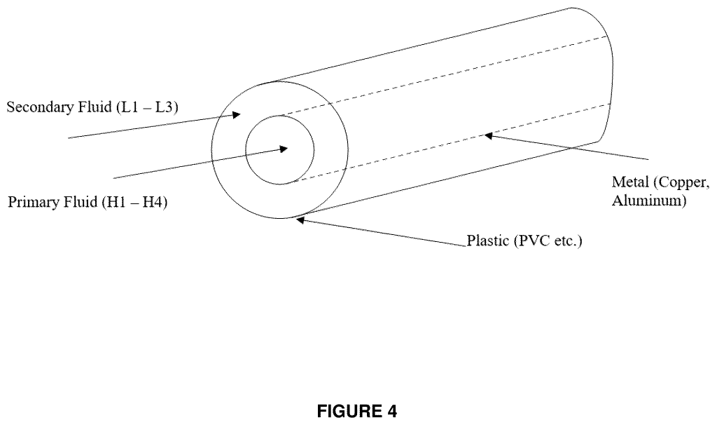

FIG. 4 provides an intermediate heat exchanger construction showing the tube-in-tube format.

### Example 5: Glide and Normal Boiling Point Performance

Due to certain characteristics of air-conditioning systems, it is important in certain embodiments that such systems are capable of exhibiting reliable system operating parameters with secondary refrigerants. Such operating parameters include:

Low-Side Pressure: Lower pressures are acceptable in the secondary loop if they do not cause the system to go into sub-atmospheric pressure over the range of expected evaporator temperatures. This is required to ensure that the system has always positive pressure, avoiding any ingress of outside air in the system in case of a leak. To evaluate this requirement, one would employ a property called “Normal Boiling Temperature” (NBT: boiling temperature at atmospheric pressure) of the fluid in question. This NBT should be in the range of 0° C. to 6° C. and at least lower than the lowest evaporation temperature found in typical air conditioning systems. Within this range of NBP the pressure of secondary fluids will also allow use of alternate low-cost materials for connecting lines such as PVC.

Glide of the secondary fluids: The full evaporator glide of the secondary refrigerants should be below 5.5° C. for the preferred embodiments and 3.5° C. for the most preferred embodiments. This is required to maintain a reasonable approach temperature in the intermediate heat exchanger which is the difference of refrigerant temperature at evaporator outlet of high-pressure cycle and average condensing temperature of the low-pressure cycle in cooling mode.

The above-noted and other operating parameters are determined for the compositions L1-L4 identified in the table above in accordance with the present invention, and these operating parameters is reported in the table below.

TABLE 20
Operating Parameters for L1-L11

| | | Normal | Average |
|---|---|---|---|
| | Full Evaporator | Boiling | Evaporator |
| Name | Glide (° C.) | Temp. (° C.) | Pressure (kPa) |
| L1 | 1.9 | 4.9 | 108.3 |
| L2 | 2.1 | 4.6 | 108.9 |
| L3 | 3.7 | 4.9 | 105.5 |
| L4 | 3.5 | 5.0 | 105.5 |
| L5 | 4.9 | 6.0 | 97.6 |
| L6 | 5.5 | 5.8 | 97.3 |
| L7 | 4.3 | 5.2 | 102.2 |
| L8 | 5.5 | 4.0 | 104.0 |
| L9 | 4.3 | 4.5 | 105.1 |
| L10 | 5.5 | 3.6 | 105.7 |

### Example 6: Figure of Merit-Heat Transfer Coefficient/Frictional Pressure Drop

In the following example, various secondary fluids are evaluated to estimate their performance in a real system. The heat transfer and pressure drop characteristics of different fluids are evaluated for flow through a fixed diameter tube of 8.8 mm and results are compared with glycol based on example in Appendix D in AHRI Standard 441 (SI)-2019. The mass flux of glycol and various secondary fluids were maintained similar to what would be expected in a real application. The thermodynamic and transport properties of secondary fluids are determined at typical evaporator temperature of 45 F. To determine the properties, the mixture parameters for each binary pair were regressed to the experimentally obtained data and the parameters were also incorporated into the National Institute of Science and Technology (NIST) Reference Fluid Thermodynamic and Transport Properties Database (Refprop 9.1 NIST Std Database, 2013). The standard mixing parameters are already available in Refprop 9.1 were used for other binary pairs. The heat transfer coefficient of glycol was estimated using Dittus-Boelter correlation for turbulent one phase flow (as seen on Page 491 of “Heat and Mass Transfer” by Frank P. Incropera and David P. DeWitt, fifth edition). The heat transfer coefficient for secondary fluids were estimated by Shah (1982) correlation (ASHRAE Fundamentals 2021—Chapter 5 “Two Phase Flow”). The frictional pressure gradient for two phase fluids is calculated based on Friedel correlation (Friedel, L., “Improved friction pressure drop correlation for horizontal and vertical two-phase pipe flow”, European Two-phase Flow Group Meeting Paper E2, Ispra, Italy, (1979)).

It is desirable that a secondary fluid provides high heat transfer rate and has a low pressure drop in the system. Therefore, a merit number is defined as the ratio of heat transfer coefficient and frictional pressure drop. A secondary fluid with higher merit number is expected to offer superior performance in a real system. The merit number for various secondary fluids evaluated were 200% to 350% higher than glycol (30% propylene glycol+50% water) suggesting the secondary fluids (L1, L1, L2 and L3) would offer superior performance in a real system.

TABLE 21
Compositions of Interest with Acceptable Heat Transfer/Frictional
Pressure Drop

| | | ΔP_{fric} | | | |
|---|---|---|---|---|---|
| | | Frictional | Inside | | |
| | Mass | Pressure | H | | % |
| Secondary | Flux | Drop/length | Btu/hr- | Merit | Change |
| Fluids | lb/ft²/s | psi/L | ft²-F | Number | (increase) |
| Glycol | 840.0 | 3.24 | 2361 | 732.0 | |
| (30% | | | | | |
| propylene | | | | | |
| glycol + | | | | | |
| 50% water | | | | | |
| R471A | 164.9 | 0.94 | 2271.0 | 2413.8 | 329.% |
| R476A | 160.6 | 0.89 | 2238 | 2508 | 342.6% |
| R482A | 158.3 | 0.86 | 2238 | 2591 | 353.9% |
| L1 | 149.5 | 1.76 | 2768.92 | 1577.8 | 215.54% |
| L2 | 151.5 | 1.76 | 2759.31 | 1568.0 | 214.20% |
| L3 | 137.9 | 1.68 | 2814.18 | 1669.4 | 228.06% |
| L4 | 138.9 | 1.70 | 2820.06 | 1665.3 | 227.50% |
| L5 | 137.63 | 1.82 | 2567 | 1407.4 | 192.27% |
| L6 | 138.08 | 1.83 | 2523 | 1380.7 | 188.61% |
| L7 | 136.62 | 1.74 | 2660 | 1528.0 | 208.74% |
| L8 | 137.36 | 1.72 | 2573 | 1497.7 | 204.60% |
| L9 | 136.16 | 1.68 | 2711 | 1613.3 | 220.40% |
| L10 | 137.42 | 1.69 | 2587 | 1527.5 | 208.67% |

Although the invention has been described with reference to preferred embodiments, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiments disclosed, but that the invention will include all embodiments falling within the scope of the appended claims or any claims later added.

What is claimed is:

1. A refrigeration system comprising
a first refrigerant circuit comprising a first refrigerant; and
a second refrigerant circuit comprising a second refrigerant which exchanges heat with said first refrigerant in said first refrigeration circuit, wherein the second refrigerant comprises cis-1,3,3,3-tetrafluoropropene (R1234ze(Z)), trans-1,3,3,3-tetrafluoropropene (R1234ze(E)), and 1233ZD(e) and has:
(i) a global warming potential (GWP) of not greater than 150;
(ii) full evaporator glide of less than 5.6° C.;
(iii) non-flammability according to ASHRAE Standard 34 2022; and
(iv) a normal boiling point of not greater than 6.3° C.

2. The refrigeration system of claim 1 wherein: (i) the first refrigerant circuit further comprises a condenser, an expansion device, a compressor, and an intermediate heat exchanger; and (ii) the second refrigerant circuit further comprises a receiver, an evaporator, and said intermediate heat exchanger.

3. The refrigeration system of claim 2 wherein the higher temperature refrigerant circuit and lower temperature refrigerant circuit further comprise connecting lines comprising polyvinyl chloride (PVC) and wherein the connecting lines are operated under positive pressure and wherein the first refrigerant and second refrigerant are “A1” according to ASHRAE Standard 34-2022 Designation and Safety Classification of Refrigerants and described in Appendix B1 to ASHRAE Standard 34-2022.21.

4. The refrigeration system of claim 1 wherein said first refrigerant comprises from 10 wt. % to 30 wt. % difluoromethane (R32) and from 70 wt. % to 90 wt. % 2,3,3,3-tetrafluoropropene (R-1234yf).

5. The refrigeration system of claim 1 wherein said second refrigerant further comprises R245fa.

6. The refrigeration system of claim 5 wherein said second refrigerant consists essentially of said cis-1,3,3,3-tetrafluoropropene (R1234ze(Z)), trans-1,3,3,3-tetrafluoropropene (R1234ze(E)), 1233ZD(e) and R245fa.

7. A refrigerant comprising: (a) a first component comprising one or more of cis-1,3,3,3-tetrafluoropropene (R1234ze(Z)) and trans-1,3,3,3-tetrafluoropropene (R1234ze(E)); (b) a second component comprising one or more of trans-1,1,1,4,4,4-hexafluoro-2-butene (R1336mzz(E)), R1224yd(Z), and R1233zd(E); and (c) optionally a third component comprising at least one of R134a, R245fa and R227ea, wherein said secondary refrigerant has: (i) a global warming potential (GWP) of not greater than 150; (ii) full evaporator glide of not greater than about 5.5° C.; (iii) non-flammability according to ASHRAE Standard 34 2022; and (iv) a normal boiling point of not greater than about 6° C.

8. The refrigerant of claim 7 wherein: (a) said first component comprises cis-1,3,3,3-tetrafluoropropene (R1234ze(Z)) and trans-1,3,3,3-tetrafluoropropene (R1234ze(E)); (b) said second component comprises R1233zd(E); and (c) said third component is present and comprises R245fa.

9. The refrigerant of claim 8 comprising:
(a) from about 20% to about 70% by weight of R1234ze(Z);
(b) from about 7% to about 15% by weight of R1234ze(E));
(c) from about 9% to about 52% by weight of R1233zd(E); and
(d) from about 3% to about 5% by weight of R245fa,
wherein said components (a) through (d) together comprise at least about 95% by weight of the composition.

10. The refrigerant of claim 9 consisting essentially of:
(a) from about 20% to about 70% by weight of R1234ze(Z);
(b) from about 7% to about 15% by weight of R1234ze(E));
(c) from about 9% to about 52% by weight of R1233zd(E); and
(d) from about 3% to about 5% by weight of R245fa.
